(19) United States
(12) Patent Application Publication
(10) Pub. No.: US 2026/0267467 A1
(43) Pub. Date: Sep. 10, 2026

(54) LOCATION-AGNOSTIC CONTENT ACCESS MECHANISMS FOR MAP-BASED INTERFACES

(71) Applicant: Snap Inc., Santa Monica, CA (US)

(72) Inventors: Daniel Amitay, Fairfield, CT (US); Jonathan Dale Brody, Venice, CA (US); Timothy Jordan Garcia, Toronto (CA); Leonid Gorkin, Chappaqua, NY (US); Andrew Lin, Short Hills, NJ (US); Walton Lin, Chatham, NJ (US); Evan Spiegel, Los Angeles, CA (US)

(21) Appl. No.: 19/662,469

(22) Filed: Apr. 29, 2026

Related U.S. Application Data
(63) Continuation of application No. 16/232,824, filed on Dec. 26, 2018.
Application No. 16/232,824 is a continuation of application No. 15/965,744, filed on Apr. 27, 2018, now abandoned.
(60) Provisional application No. 62/556,134, filed on Sep. 8, 2017.
(60) Provisional application No. 62/552,958, filed on Aug. 31, 2017.
(60) Provisional application No. 62/491,115, filed on Apr. 27, 2017.

(51) Int. Cl. G06F 3/04817; G06F 16/9535; G06F 16/9537; H04L 67/306; H04W 4/02

(52) U.S. Cl. CPC G06F 3/04817; G06F 16/9535; G06F 16/9537; H04L 67/306; H04W 4/02

(57) ABSTRACT

A map-based graphical user interface (GUI) for a social media application displays an interactive map on which friend icons represent respective geographic locations of friend users. The map-based GUI provides location-based access mechanisms, each enabling access to social media content based on associated location information, and additionally provides a friend-level access mechanism enabling location-agnostic access to friend user content. Accessibility of friend content via the friend-level access mechanism is agnostic to the identity of or variation in the geographic area displayed on the interactive map. Responsive to user input selecting a target friend user via the friend-level access mechanism, a location-agnostic collection of social media items is displayed — the composition of that collection being likewise agnostic to the geographic area displayed. The friend-level access mechanism is operable via friend icons on the map, a friend panel, or a search interface provided as part of the map-based GUI.

### PRIORITY APPLICATIONS

This application is a continuation of and claims the benefit of U.S. Patent Application Serial No. 16/232,824, filed Dec. 26, 2018, which is a continuation of and claims the benefit of U.S. Patent Application Serial No. 15/965,744, filed Apr. 27, 2018, which claims the benefit of priority to U.S. Provisional Application Serial No. 62/556,134, filed Sep. 8, 2017; U.S. Provisional Application Serial No. 62/552,958, filed Aug. 31, 2017; and U.S. Provisional Application Serial No. 62/491,115, filed Apr. 27, 2017, the contents of which are incorporated herein by reference in their entireties.

### BACKGROUND

Social media applications implement computer-mediated technologies allowing for the creating and sharing of content that communicates information, ideas, career interests, and other forms of expression via virtual communities and networks. Social media platforms use web-based technologies, desktop computers, and mobile technologies (e.g., smart phones and tablet computers) to create highly interactive platforms through which individuals, communities, and organizations can share, co-create, discuss, and modify user-generated content or pre-made content posted online.

Mobile electronic devices on which end-user social media applications can be executed typically provide geolocation services that determine the geographic location of the mobile electronic device, by extension indicating the geographic location of the associated user. Social media content posted by users is often geo-tagged based on the geolocation of a mobile electronic device (such as a mobile phone) by use of which the social media content is captured and/or posted to the social media platform. In other embodiments, social media content may explicitly be geo-tagged by a user using a computer device that does not have activated geolocation services and/or that is not a mobile device (such as a desktop PC).

In many social media platforms, the total number of individual social media items that are available for viewing by any particular user can be very large. Search mechanisms that enable users to locate social media content that may be of interest to them can consume significant server-side resources and often provide less than satisfactory search results.

### BRIEF DESCRIPTION OF THE DRAWINGS

Some aspects of the disclosure are illustrated in the appended drawings. Note that the appended drawings illustrate example embodiments of the present disclosure and cannot be considered as limiting the scope of the disclosure.

FIG. 1 is a block diagram showing an example social media platform system for exchanging, posting, and consuming social media data (e.g., messages and associated content) over a network.

FIG. 2 is a block diagram illustrating further details regarding a social media platform system, according to example embodiments.

FIG. 3 is a schematic diagram illustrating data which may be stored in a database of the social media platform system, according to certain example embodiments.

FIG. 4 is a schematic diagram illustrating a structure of a message, according to some embodiments, generated by a social media client application according to example embodiments.

FIG. 5 is a schematic diagram illustrating an example access-limiting process, in terms of which access to content (e.g., an ephemeral message, and associated multimedia payload of data) or a content collection (e.g., an ephemeral message gallery or story) may be time-limited (e.g., made ephemeral).

FIGS. 6A and 6B are respective schematic views of a client device providing a map-based graphical user interface for a social media application, according to different respective example embodiments.

FIGS. 7A-7C are respective schematic views of a client device providing a destination selection interface forming part of a map-based graphical user interface for a social media application, according to some example embodiments.

FIGS. 8A-8C are respective screenshots of a map-based graphical user interface, providing features relating to display of user icons in a map forming part of the interface, according to an example embodiment.

FIGS. 9A and 9B are respective screenshots of the functionalities of a map-based graphical user interface that provides access to a chat interface and to friend content via a friend icon displayed as part of the map, according to an example embodiment.

FIGS. 11A-11B is a series of schematic screenshots illustrating a location-based search mechanism provided by a map-based graphical user interface, according to one example embodiment.

FIGS. 10A-10D are respective schematic screenshots of a search interface forming part of a map-based graphical user interface, according to one example embodiment.

FIG. 12 is a schematic view of a social media platform system for providing a map-based graphical user interface for a social media application, according to one example embodiment.

FIGS. 13A-13D is a series of schematic flow charts illustrating an example embodiment of a method of providing a map-based graphical user interface for a social media application that includes location-based search functionality, according to an example embodiment.

FIG. 14 is a schematic flowchart showing a method of providing a map-based graphical user interface that includes display of user location at a regional granularity level, according to an example embodiment.

FIGS. 15A and 15B is a pair of schematic flowcharts illustrating a method of providing a social media platform GUI that provides one or more friend-level access mechanisms for location-agnostic friend content, according to an example embodiment.

FIG. 16 is a schematic flowchart illustrating a method of providing a social media platform GUI that includes one or more mechanisms which enable searching for social media content based on a location and/or attribute(s) of a selected friend user, according to an example embodiment.

FIGS. 17A and 17B or screenshots of a map-based graphical user interface, according to an example embodiment.

FIG. 18 is a flowchart illustrating a method of providing for friend icon clustering, according to example embodiments.

FIG. 19 is a screenshot of a map-based graphical user interface, according to an example embodiment.

FIG. 20 is a block diagram illustrating a representative software architecture, which may be used in conjunction with various hardware architectures herein described.

FIG. 21 is a block diagram illustrating components of a machine, according to some example embodiments, able to read instructions from a machine-readable medium (e.g., a machine-readable storage medium) and perform any one or more of the methodologies discussed herein.

The headings provided herein are merely for convenience and do not necessarily affect the scope or meaning of the terms used.

### DESCRIPTION

One aspect of the disclosure provides a geographical map-based graphical user interface (GUI) for a social media platform or application, to allow user access via the map-based GUI to ephemeral social media content. Such an interface is also referred to herein as a “map GUI.”

As will be described in greater detail below, ephemeral social media content comprises social media items that are available for viewing via the social media application for only a limited period. For example, an ephemeral social media item or message (also referred to herein as a “snap”) submitted by a user to the social media application may be available for viewing by other users via the map GUI of the social media application for only a predefined period subsequent to submission. In one example embodiment, each ephemeral item or snap has an availability lifetime (also referred to herein as a “gallery participation timer”) of 24 hours after submission, after which the ephemeral item “disappears” and is no longer available for viewing by other users via the map GUI. Such ephemeral social media items (also referred to herein as ephemeral messages) typically comprise photographic or video content, which may be submitted with or without augmentations made by the user to the underlying photographic or video content.

Ephemeral messages submitted by multiple different users may be available on a map forming part of the map GUI based at least in part on respective location information (e.g., geotag information) of the ephemeral messages. In some embodiments, the map GUI may provide location-based access to one or more collections of ephemeral social media items (also known as and referred to herein as galleries or “stories”). In some example embodiments, a plurality of ephemeral messages submitted by different users are included in a common geo-anchored gallery or story based at least in part on respective geotagging information of the plurality of ephemeral messages. Such a location-based gallery or story is in some embodiments represented on the map GUI by a respective gallery icon displayed at a corresponding map location, the gallery icon being selectable by the user to trigger automated sequential display of the plurality of ephemeral messages in the gallery on the user device on which the map GUI is rendered.

In some embodiments, such a map GUI includes representations (e.g. by means of friend icons or bitmojis) of at least approximate respective positions of a user’s friends in a social network graph accessed by the social media application, with the social media application enabling the user to explore the world around friends’ locations by use of the GUI. Thus, the map GUI can in some embodiments enable the user to explore uploaded social media content (e.g., individual photos or video clips/snaps, or social media galleries such as stories comprising respective collections of photos, messages, or snaps).

One aspect of the disclosure provides for display of user locations in the map GUI at a regional level of granularity, such that the user location is displayed at an intentionally inaccurate location within a defined geographical region in which the user is actually located. Some embodiments enable a user to selectively vary the level of display granularity applying to their user icon when the map GUI is rendered on the user devices of other users, for example enabling the user to switch between a precise and a regional level of granularity. In one example embodiment, the regional level of granularity displays the user location accurately at a city or town level.

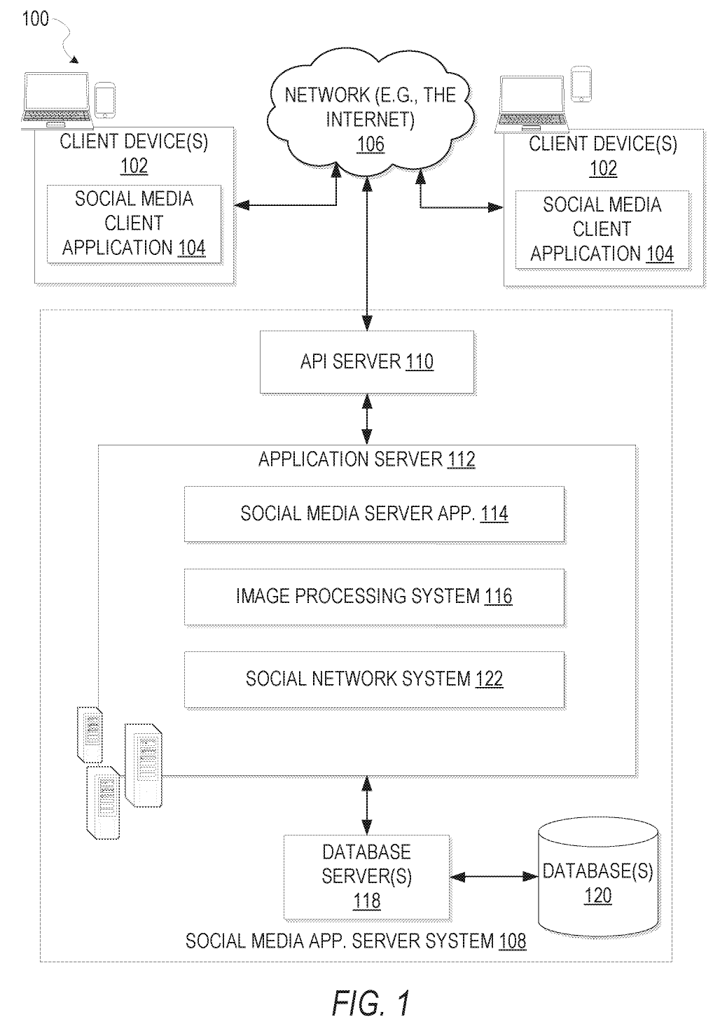

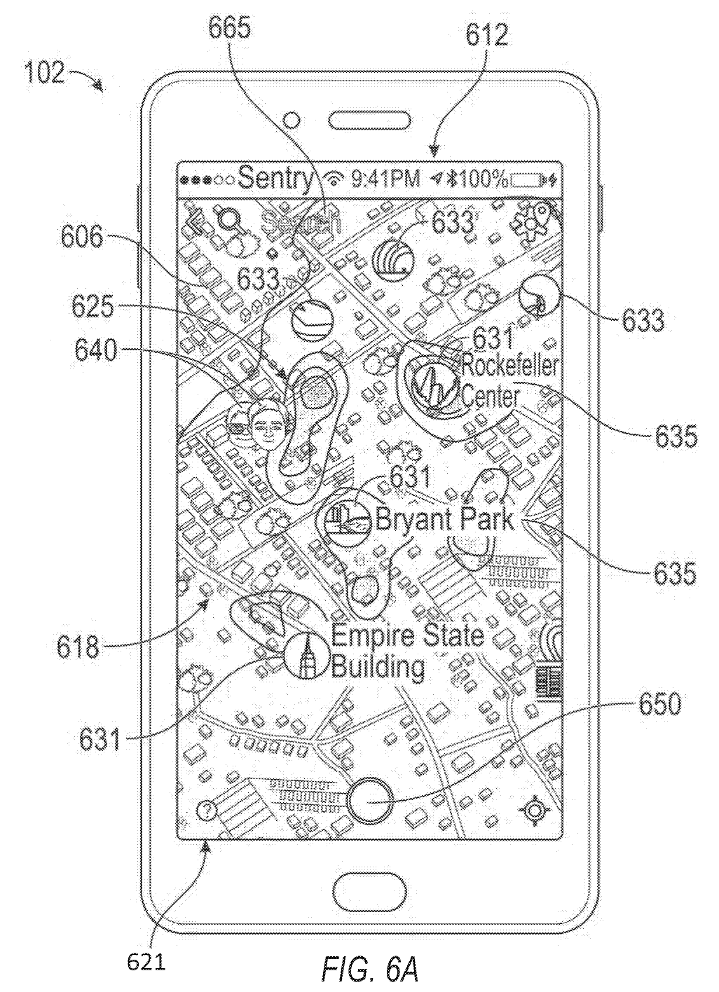

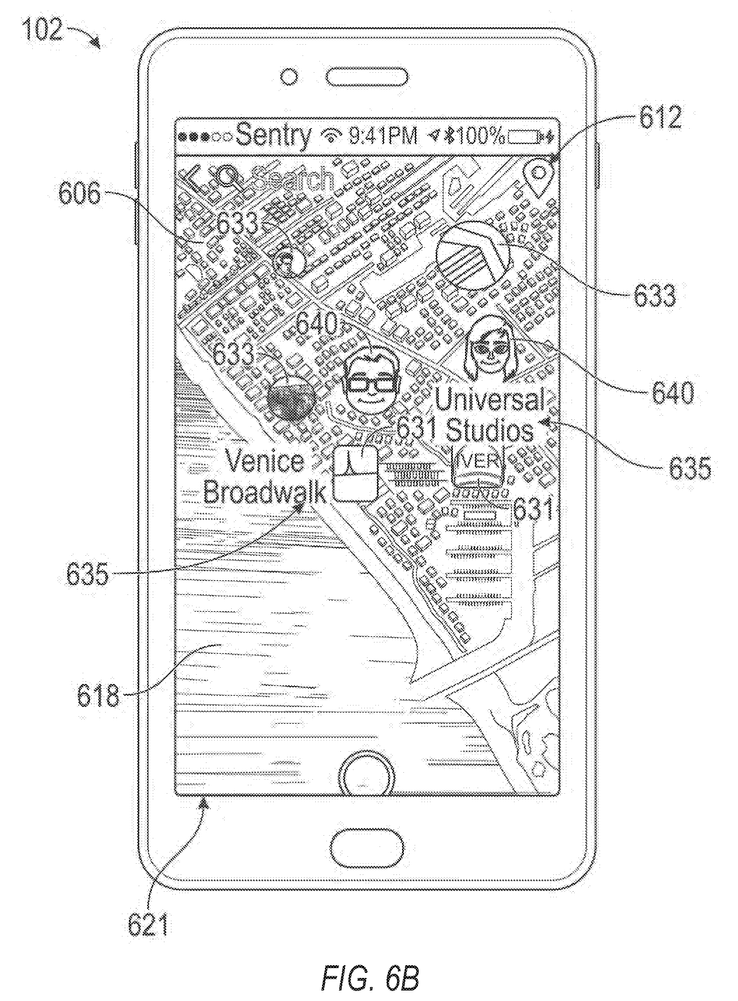

These and additional aspects of the disclosure will be described below with reference to specific example embodiments. First, platform architecture and a technical background to implementation of the various embodiments will be described with reference to FIGS. 1-5. Thereafter, specific example embodiments are described with reference to FIGS. 6A-19. FIGS. 20-21 finally describe aspects of software and hardware components that are in some instances used in the implementation of the described example embodiments.

### DETAILED DESCRIPTION

The description that follows includes systems, methods, devices, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the disclosed subject matter may be practiced without these specific details. In general, well-known instruction instances, protocols, structures, and techniques are not necessarily shown in detail.

### System Architecture and Operating Environment

FIG. 1 is a block diagram showing an example social media platform system 100 for exchanging data (e.g., social media items or messages and associated content) over a network. In this description, items communicated from one user to one or more other users via a social media application or platform, as well as items uploaded or provided by users to a social media application or platform for availability to or consumption by other users via the social media application or platform, are referred to as “messages.” Thus, the term “messages” as used herein is not limited to communications from one user to specified recipient users, but includes messages made available for public consumption via the relevant social media platform.

The social media platform system 100 includes multiple client devices 102, each of which hosts a number of applications including a social media client application 104. Each social media client application 104 is communicatively coupled to other instances of the social media client application 104 and a social media application server system 108 via a network 106 (e.g., the Internet).

Accordingly, each social media client application 104 is able to communicate and exchange data with another social media client application 104 and with the social media application server system 108 via the network 106. The data exchanged between social media client applications 104, and between a social media client application 104 and the social media application server system 108, includes functions (e.g., commands to invoke functions) as well as payload data (e.g., text, audio, video, or other multimedia data).

The social media application server system 108 provides server-side functionality via the network 106 to a particular social media client application 104. While certain functions of the social media platform system 100 are described herein as being performed by either a social media client application 104 or by the social media application server system 108, it will be appreciated that the location of certain functionality either within the social media client application 104 or the social media application server system 108 is a design choice. For example, it may be technically expedient to initially deploy certain technology and functionality within the social media application server system 108, but to later migrate this technology and functionality to the social media client application 104 where a client device 102 has a sufficient processing capacity.

The social media application server system 108 supports various services and operations that are provided to the social media client application 104. Such operations include transmitting data to, receiving data from, and processing data generated by the social media client application 104. This data may include message content, client device information, geolocation information, media annotations and overlays, message content persistence conditions, social network information, and live event information, as examples. Data exchanges within the social media platform system 100 are invoked and controlled through functions available via user interfaces (UIs) of the social media client application 104.

Turning now specifically to the social media application server system 108, an application programming interface (API) server 110 is coupled to, and provides a programmatic interface to, an application server 112. The application server 112 is communicatively coupled to a database server 118, which facilitates access to a database 120 in which is stored data associated with messages processed by the application server 112.

Dealing specifically with the API server 110, this server receives and transmits message data (e.g., commands and message payloads) between the client device 102 and the application server 112. Specifically, the API server 110 provides a set of interfaces (e.g., routines and protocols) that can be called or queried by the social media client application 104 in order to invoke functionality of the application server 112. The API server 110 exposes various functions supported by the application server 112, including account registration; login functionality; the sending of messages, via the application server 112, from a particular social media client application 104 to another social media client application 104; the sending of media files (e.g., images or video) from a social media client application 104 to a social media server application 114, for possible access by another social media client application 104; the setting of a collection of media data (e.g., a story or gallery); the retrieval of such collections; the retrieval of a list of friends of a user of a client device 102; the retrieval of messages and content; the adding and deletion of friends to and from a social graph; the location of friends within a social graph; opening an application event (e.g., relating to the social media client application 104); and so forth.

The application server 112 hosts a number of applications and subsystems, including the social media server application 114, an image processing system 116, and a social network system 122. The social media server application 114 implements a number of message processing technologies and functions, particularly related to the aggregation and other processing of content (e.g., textual and multimedia content) included in messages received from multiple instances of the social media client application 104. As will be described in further detail, the text and media content from multiple sources may be aggregated into collections of content (e.g., called “stories” or “galleries”). These collections are then made available, by the social media server application 114, to the social media client application 104. Other processor- and memory-intensive processing of data may also be performed server-side by the social media server application 114, in view of the hardware requirements for such processing.

The application server 112 also includes the image processing system 116, which is dedicated to performing various image processing operations, typically with respect to images or video received within the payload of a message at the social media server application 114.

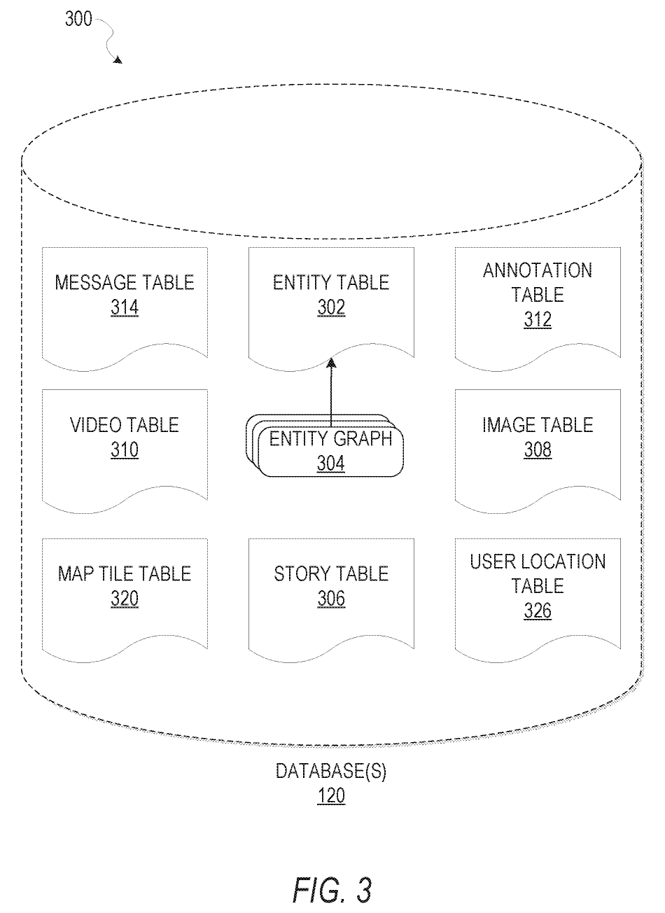

The social network system 122 supports various social networking functions and services, and makes these functions and services available to the social media server application 114. To this end, the social network system 122 maintains and accesses an entity graph 304 (described below with reference to FIG. 3) within the database 120. Examples of functions and services supported by the social network system 122 include the identification of other users of the social media platform system 100 with whom a particular user has relationships or whom the particular user is “following,” and also the identification of other attributes and interests of a particular user. In some embodiments, the social network system 122 includes an identification of other users whose location is available for viewing by a particular user via a map-based GUI displayable on a client device 102 using the corresponding social media client application 104.

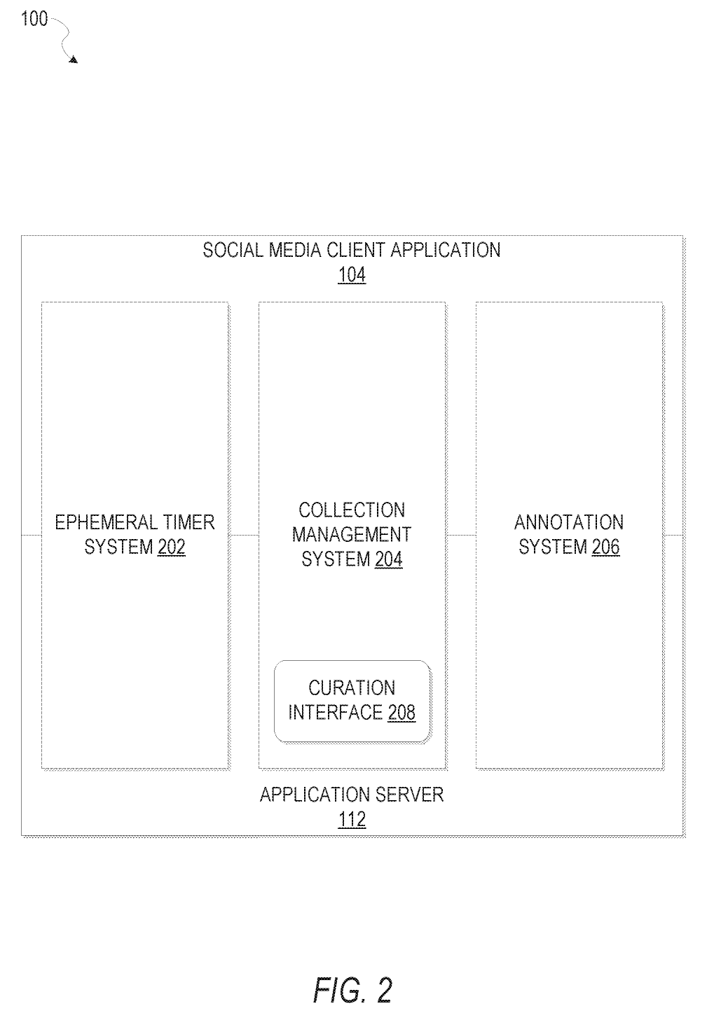

FIG. 2 is a block diagram illustrating further details regarding the social media platform system 100, according to example embodiments. Specifically, the social media platform system 100 is shown to comprise the social media client application 104 and the application server 112, which in turn embody a number of some subsystems, namely an ephemeral timer system 202, a collection management system 204, and an annotation system 206.

The ephemeral timer system 202 is responsible for enforcing the temporary access to content permitted by the social media client application 104 and the social media server application 114. To this end, the ephemeral timer system 202 incorporates a number of timers that, based on duration and display parameters associated with a message, or collection/gallery of messages (e.g., a SNAPCHAT story), selectively display and enable access to messages and associated content via the social media client application 104. Further details regarding the operation of the ephemeral timer system 202 are provided below.

The collection management system 204 is responsible for managing collections of media (e.g., collections of text, image, video, and audio data). In some examples, a collection of content (e.g., messages, including images, video, text, and audio) may be organized into an “event gallery” or an “event story.” Such a collection may be made available for a specified time period, such as the duration of an event to which the content relates, or until expiry of a last message or snap in the gallery. For example, content relating to a music concert may be made available as a “story” for the duration of that music concert. The collection management system 204 may also be responsible for publishing an icon that provides notification of the existence of a particular collection to the user interface of the social media client application 104. As will be described in greater detail with reference to the specific example embodiments that follow, the collection management system 204 may also be responsible for compiling and managing multiple location-based social media galleries based at least in part on geo-tag data of social media items or messages uploaded to the social media platform by multiple users. Other types of galleries that may be provided by the collection management system 204 include a “place story” that collects ephemeral messages having geotag data indicating a location within a predefined associated geographical area; and an ad-hoc story or spike story that is dynamically surfaced on a map GUI as described herein based on underlying location-based social media activity, e.g., based on geo-temporal volume or anomality/unusualness of social media items submitted by users for public consumption (e.g., for inclusion in a “Live Story” or “Our Story”). With “anomality” is meant is metric indicating a how anomalous something is.

The collection management system 204 furthermore includes a curation interface 208 that allows a human operator (e.g., a collection manager) to manage and curate a particular collection of content. For example, the curation interface 208 enables an event organizer to curate a collection of content relating to a specific event (e.g., to delete inappropriate content or redundant messages). Instead, or in addition, the collection management system 204 may employ machine vision (or image recognition technology), geotag data, and/or content rules to automatically compile and/or curate a content collection. In certain embodiments, compensation may be paid to a user for inclusion of user-generated content into a collection. In such cases, the curation interface 208 operates to automatically make payments to such users for the use of their content.

The annotation system 206 provides various functions that enable a user to annotate or otherwise augment, modify, or edit media content associated with a message. For example, the annotation system 206 provides functions related to the generation and publishing of media overlays for messages processed by the social media platform system 100. The annotation system 206 operatively supplies a media overlay (e.g., a SNAPCHAT filter) to the social media client application 104 based on a geolocation of the client device 102. In another example, the annotation system 206 operatively supplies a media overlay to the social media client application 104 based on other information, such as social network information of the user of the client device 102. A media overlay may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo) at the client device 102. For example, the media overlay includes text that can be overlaid on top of a photograph taken by the client device 102. In another example, the media overlay includes an identification of a location overlay (e.g., Venice Beach), a name of a live event, or a name of a merchant overlay (e.g., Beach Coffee House). In another example, the annotation system 206 uses the geolocation of the client device 102 to identify a media overlay that includes the name of a merchant at the geolocation of the client device 102. The media overlay may include other indicia associated with the merchant. The media overlays may be stored in the database 120 and accessed through the database server 118.

In one example embodiment, the annotation system 206 provides a user-based publication platform that enables users to select a geolocation on a map, and upload content associated with the selected geolocation. The user may also specify circumstances under which a particular media overlay should be offered to other users. The annotation system 206 generates a media overlay that includes the uploaded content and associates the uploaded content with the selected geolocation.

In another example embodiment, the annotation system 206 provides a merchant-based publication platform that enables merchants to select a particular media overlay associated with a geolocation via a bidding process. For example, the annotation system 206 associates the media overlay of a highest-bidding merchant with a corresponding geolocation for a predefined amount of time

FIG. 3 is a schematic diagram illustrating data 300 which may be stored in the database 120 of the social media application server system 108, according to certain example embodiments. While the content of the database 120 is shown to comprise a number of tables, it will be appreciated that the data could be stored in other types of data structures (e.g., as an object-oriented database).

The database 120 includes message data stored within a message table 314. An entity table 302 stores entity data, including an entity graph 304. Entities for which records are maintained within the entity table 302 may include individuals, corporate entities, organizations, objects, places, events, etc. Regardless of type, any entity regarding which the social media application server system 108 stores data may be a recognized entity. Each entity is provided with a unique identifier, as well as an entity type identifier (not shown).

The entity graph 304 furthermore stores information regarding relationships and associations between entities. Such relationships may be social, professional (e.g., work at a common corporation or organization), interested-based, or activity-based, merely for example.

The database 120 also stores annotation data, including in the example form of filters, in an annotation table 312. Filters for which data is stored within the annotation table 312 are associated with and applied to videos (for which data is stored in a video table 310) and/or images (for which data is stored in an image table 308). Filters, in one example, are overlays that are displayed as overlaid on an image or video during presentation to a recipient user. Filters may be of various types, including user-selected filters from a gallery of filters presented to a sending user by the social media client application 104 when the sending user is composing a message. Other types of filters include geolocation filters (also known as geo-filters), which may be presented to a sending user based on geographic location. For example, geolocation filters specific to a neighborhood or special location may be presented within a user interface by the social media client application 104, based on geolocation information determined by a Global Positioning System (GPS) unit of the client device 102. Another type of filter is a data filter, which may be selectively presented to a sending user by the social media client application 104, based on other inputs or information gathered by the client device 102 during the message creation process. Examples of data filters include a current temperature at a specific location, a current speed at which a sending user is traveling, a battery life for a client device 102, or the current time.

Other annotation data that may be stored within the image table 308 is so-called “lens” data. A “lens” may be a real-time special effect and sound that may be added to an image or a video.

Yet further annotation data that may be stored within the annotation table 312 is user-generated annotations or augmentations provided by the user to overlay an underlying photographic image or video. Such augmentations/annotations can include, for example, text annotations and drawing annotations or augmentations provided by the user, e.g., via a client device touchscreen.

As mentioned above, the video table 310 stores video data which, in one embodiment, is associated with messages for which records are maintained within the message table 314. Similarly, the image table 308 stores image data associated with messages for which message data is stored in the message table 314. The entity table 302 may associate various annotations from the annotation table 312 with various images and videos stored in the image table 308 and the video table 310.

A story table 306 stores data regarding collections of messages and associated image, video, or audio data, which are compiled into a collection (e.g., a SNAPCHAT story or a gallery). The creation of a particular collection may be initiated by a particular user (e.g., any user for whom a record is maintained in the entity table 302). A user may create a “personal story” in the form of a collection of content that has been created and sent/broadcast by that user. To this end, the user interface of the social media client application 104 may include an icon that is user selectable to enable a sending user to add specific content to his or her personal story. In the context of this description, such messages and stories/galleries are understood to be for private consumption, being limited for viewing via the social media application to particular users identified by the submitting user or to users who are members of a social network of the submitting user. This is to be contrasted with social media items provided for public or non-private consumption via the social media application, not being limited to a user-specific or user-specified subset of all users of the social media application. An example of a publicly viewable collection or gallery is a “Live Story” or “Our Story.”

As mentioned, a collection may also constitute a “Live Story,” which is a collection of content from multiple users that is created manually, automatically, or using a combination of manual and automatic techniques. For example, a “Live Story” may constitute a curated stream of user-submitted content from various locations and events. Users whose client devices have location services enabled and are at a common event location at a particular time may, for example, be presented with an option, via a user interface of the social media client application 104, to contribute content to a particular Live Story. The Live Story may be identified to the user by the social media client application 104, based on his or her location. The end result is a “Live Story” told from a community perspective. In accordance with some example embodiments of this disclosure, a submitting user can submit social media items or messages to a non-specific common Live Story. Such content is accessible to other users via a map-based graphical user interface, with such social media items or messages being accessible via the map GUI based on a respective location indicated by corresponding geo-tag data, either by forming part of a location-based gallery or story, or by such other users using location-based search mechanisms forming part of the map GUI.

A further type of content collection is known as a “location story,” which enables a user whose client device 102 is located within a specific geographic location (e.g., on a college or university campus) to contribute to a particular collection. In some embodiments, a contribution to a location story may require a second degree of authentication to verify that the end user belongs to a specific organization or other entity (e.g., is a student on the university campus). In some embodiments of this disclosure, a message uploaded to a Live Story or Our Story generally, without the user specifying a particular location story in which the message is to be included, can automatically or semi-automatically be included in a location story based at least in part on geo-tag data of the message.

A map tile table 320 stores multiple map tiles that can be used for presenting a map in a map viewport of a map-based GUI, according to some embodiments of this disclosure. In a particular example embodiment, each map view is composed of 9 or 16 map tiles stitched together. A plurality of sets of map tiles may be maintained for different map zoom levels. In some example embodiments, a superset of map tiles is maintained server-side, being forwarded to a requesting client device 102 for composing a map representation of specific requested areas.

A user location table 326 stores current or most recent user location data for multiple users of the social media application. The user location data may be based on location data received from respective client devices 102 associated with the respective users. Such user location data is in some example embodiments used to display in a map-based GUI respective locations of a plurality of users who form part of the social network of the requesting user and/or who have provided permission for the requesting user to view their locations. Each such user may be represented on a map forming part of the map GUI by a respective user icon or bitmoji.

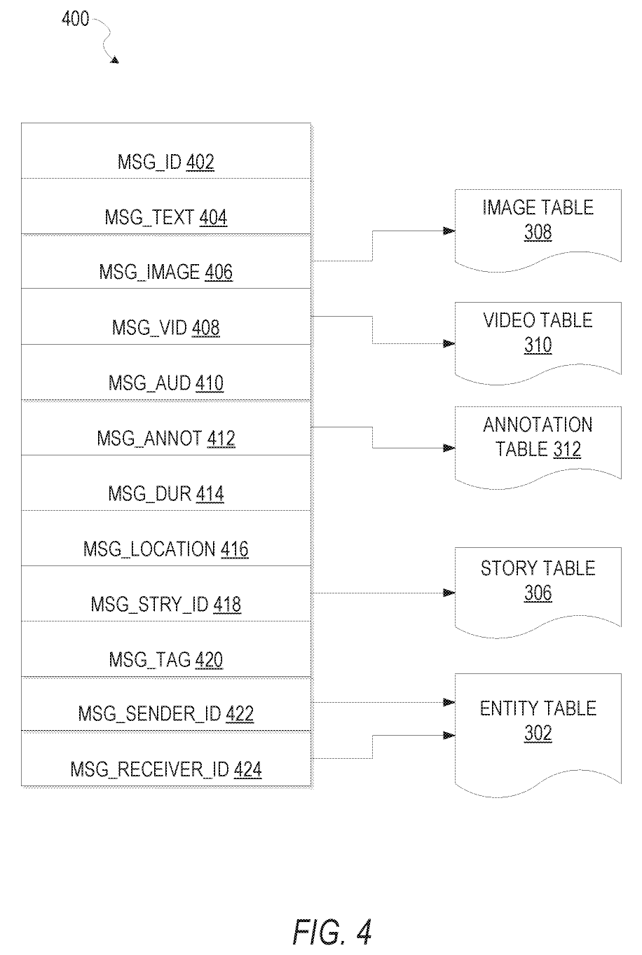

FIG. 4 is a schematic diagram illustrating a structure of a social media item or message 400, according to some embodiments, generated by one instance of the social media client application 104 for communication to a further instance of the social media client application 104 or to the social media server application 114. The content of a particular message 400 is used to populate the message table 314 stored within the database 120, accessible by the social media server application 114. Similarly, the content of a message 400 is stored in memory as “in-transit” or “in-flight” data of the client device 102 or the application server 112. The message 400 is shown to include the following components:

A message identifier 402: a unique identifier that identifies the message 400.

A message text payload 404: text, to be generated by a user via a user interface of the client device 102 and that is included in the message 400.

A message image payload 406: image data, captured by a camera component of a client device 102 or retrieved from memory of a client device 102, and that is included in the message 400.

A message video payload 408: video data, captured by a camera component or retrieved from a memory component of the client device 102 and that is included in the message 400.

A message audio payload 410: audio data, captured by a microphone or retrieved from the memory component of the client device 102, and that is included in the message 400.

A message annotation 412: annotation data (e.g., filters, stickers, or other enhancements) that represents annotations to be applied to the message image payload 406, message video payload 408, or message audio payload 410 of the message 400.

A display duration parameter 414: a parameter value indicating, in seconds, the amount of time for which content of the message (e.g., the message image payload 406, message video payload 408, and message audio payload 410) is to be presented or made accessible to a user via the social media client application 104. The display duration parameter 414 is also referred to herein as a “display duration timer.”

A message geolocation parameter 416: geolocation data or geo-tag data (e.g., latitudinal and longitudinal coordinates) associated with the content payload of the message 400. Multiple message geolocation parameter 416 values may be included in the payload, each of these parameter values being associated with respective content items included in the content (e.g., a specific image within the message image payload 406, or a specific video in the message video payload 408).

A message story identifier 418: identifier values identifying one or more content collections (e.g., “stories”) with which a particular content item in the message image payload 406 of the message 400 is associated. For example, multiple images within the message image payload 406 may each be associated with multiple content collections using identifier values. An example of such a message story identifier 418 can in some embodiments comprise one or more thumbnail images.

A message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.

A message sender identifier 422: an identifier (e.g., a messaging system identifier, email address, or device identifier) indicative of a user of the client device 102 on which the message 400 was generated and from which the message 400 was sent.

A message receiver identifier 424: an identifier (e.g., a messaging system identifier, email address, or device identifier) indicative of a user of the client device 102 to which the message 400 is addressed.

The contents (e.g., values) of the various components of the message 400 may be pointers to locations in tables within which content data values are stored. For example, an image value in the message image payload 406 may be a pointer to (or address of) a location within an image table 308. Similarly, values within the message video payload 408 may point to data stored within a video table 310, values stored within the message annotation 412 may point to data stored in an annotation table 312, values stored within the message story identifier 418 may point to data stored in a story table 306, and values stored within the message sender identifier 422 and the message receiver identifier 424 may point to user records stored within an entity table 302.

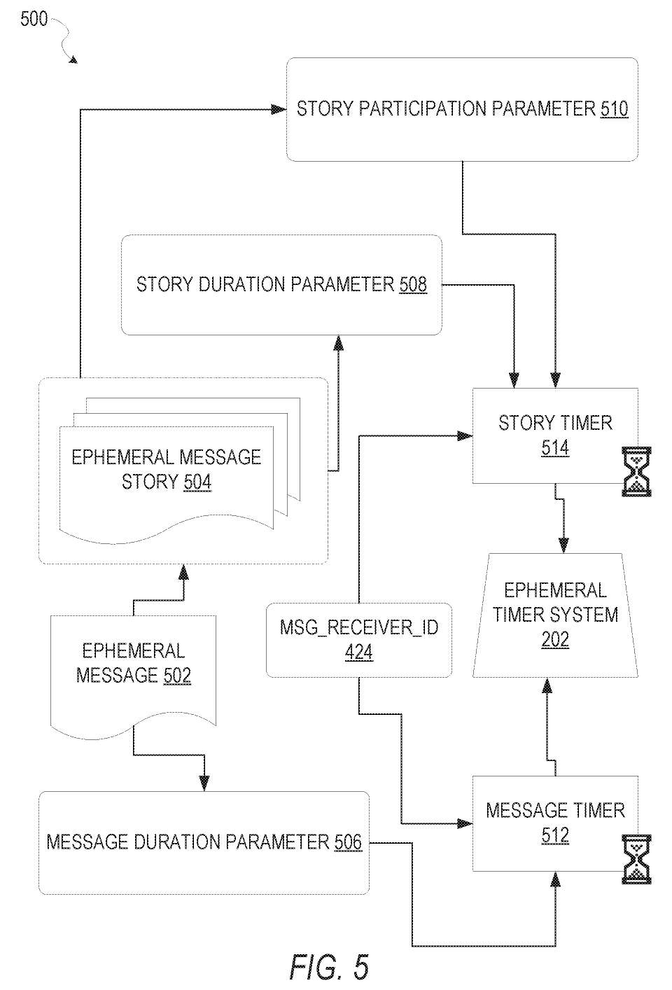

FIG. 5 is a schematic diagram illustrating an access-limiting process 500, in terms of which access to content (e.g., an ephemeral message 502, and associated multimedia payload of data) or a content collection (e.g., an ephemeral message story 504) may be time-limited (e.g., made ephemeral).

An ephemeral message 502 is shown to be associated with a display duration parameter 506, the value of which determines an amount of time that the ephemeral message 502 will be displayed to a receiving user of the ephemeral message 502 by the social media client application 104. In one embodiment, where the social media client application 104 is a SNAPCHAT client application, an ephemeral message 502 is viewable by a receiving user for up to a maximum of 10 seconds, depending on the amount of time that the sending user specifies using the display duration parameter 506. In some embodiments, the system automatically attaches a default display duration parameter 506 to photographic or still-image messages, e.g., having a default display duration of 5 seconds. The display duration parameter 506 of video-based messages may automatically correspond to the duration of the underlying video, with an automatically enforced upper limit. Thus, in an example embodiment in which an upper limit of 10 seconds is enforced, a 7-second video message will have a display duration parameter of 7 seconds.

The display duration parameter 506 and the message receiver identifier 424 are shown to be inputs to a message timer 512, which is responsible for determining the amount of time that the ephemeral message 502 is shown to a particular receiving user identified by the message receiver identifier 424. In particular, the ephemeral message 502 will only be shown to the relevant receiving user for a time period determined by the value of the display duration parameter 506. The message timer 512 is shown to provide output to a more generalized ephemeral timer system 202, which is responsible for the overall timing of display of content (e.g., an ephemeral message 502) to a receiving user.

The ephemeral message 502 is shown in FIG. 5 to be included within a social media gallery in the form of an ephemeral message story 504 (e.g., a personal SNAPCHAT story, or an event story). The ephemeral message story 504 has a story duration parameter 508, a value of which determines a time duration for which the ephemeral message story 504 is made available and is accessible to users of the social media platform system 100. The story duration parameter 508, for example, may be the duration of a music concert, where the ephemeral message story 504 is a collection of content pertaining to that concert. Alternatively, a user (either the owning user or a curator user) may specify the value for the story duration parameter 508 when performing the setup and creation of the ephemeral message story 504. In some embodiments, the story duration parameter 508 is determined based at least in part on respective story participation parameters 510 (or lifetimes) of one or more of the ephemeral messages 502 forming part of the particular ephemeral message story 504. In one example embodiment, the story duration parameter 508 corresponds to a story participation parameter 510 or lifetime of a last-posted one of the ephemeral messages 502 in the relevant ephemeral message story 504. In such a case, the ephemeral message story 504 expires (e.g., by becoming unavailable for viewing via the social media platform) when the last-posted ephemeral message 502 therein expires (e.g., when a story participation parameter 510 or lifetime of the last ephemeral message 502 expires).

As alluded to above, each ephemeral message 502 within the ephemeral message story 504 has an associated story participation parameter 510 (also referred to herein as a “gallery participation parameter” or a “gallery participation timer”), a value of which determines the duration of time for which the ephemeral message 502 will be accessible within the context of the ephemeral message story 504. Accordingly, a particular ephemeral message 502 may “expire” and become inaccessible within the context of the ephemeral message story 504, prior to the ephemeral message story 504 itself expiring in terms of the story duration parameter 508. The story duration parameter 508, story participation parameter 510, and message receiver identifier 424 each provide input to a story timer 514, which operationally determines, first, whether a particular ephemeral message 502 of the ephemeral message story 504 will be displayed to a particular receiving user, and, if so, for how long. Note that the ephemeral message story 504 is also aware of the identity of the particular receiving user as a result of the message receiver identifier 424.

Accordingly, the story timer 514 in some embodiments operationally controls the overall lifespan of an associated ephemeral message story 504, as well as an individual ephemeral message 502 included in the ephemeral message story 504. In one embodiment, each and every ephemeral message 502 within the ephemeral message story 504 remains viewable and accessible for a time period specified by the story duration parameter 508. In a further embodiment, a certain ephemeral message 502 may expire, within the context of the ephemeral message story 504, based on a story participation parameter 510. Note that a respective display duration parameter 506 may still determine the duration of time for which a particular ephemeral message 502 is displayed to a receiving user upon replay of the ephemeral message 502, even within the context of the ephemeral message story 504. Accordingly, the display duration parameter 506 determines the duration of time that a particular ephemeral message 502 is displayed to a receiving user, regardless of whether the receiving user is viewing that ephemeral message 502 inside or outside the context of an ephemeral message story 504.

The ephemeral timer system 202 may furthermore operationally remove a particular ephemeral message 502 from the ephemeral message story 504 based on a determination that it has exceeded an associated story participation parameter 510. For example, when a sending user has established a story participation parameter 510 of 24 hours from posting, the ephemeral timer system 202 will remove the relevant ephemeral message 502 from the ephemeral message story 504 after the specified 24 hours. The ephemeral timer system 202 also operates to remove an ephemeral message story 504 either when the story participation parameter 510 for each and every ephemeral message 502 within the ephemeral message story 504 has expired, or when the ephemeral message story 504 itself has expired in terms of the story duration parameter 508. Note that in this disclosure, at least some ephemeral messages 502 may be submitted by the user to the social media application for general or public viewing via the map-based GUI, without being included by the user in any particular event gallery and without being included in any location-based gallery represented by a respective gallery icon on the map GUI. Such ephemeral messages 502 in some embodiments also have respective story participation parameters 510 specifying time periods for which the ephemeral messages 502 are accessible via the map GUI as part of a collective Live Story or Our Story, as described with reference to specific example embodiments below. In a particular example embodiment, each ephemeral message 502 thus submitted for public or non-private view has a default gallery participation parameter or story participation parameter 510 of 24 hours. Such ephemeral messages 502 are thus viewable via the map GUI for only 24 hours after submission.

In certain use cases, a creator of a particular ephemeral message story 504 may specify an indefinite story duration parameter 508. In this case, the expiration of the story participation parameter 510 for the last remaining ephemeral message 502 within the ephemeral message story 504 will determine when the ephemeral message story 504 itself expires. In this case, a new ephemeral message 502, added to the ephemeral message story 504, with a new story participation parameter 510, effectively extends the life of an ephemeral message story 504 to equal the value of the story participation parameter 510.

In response to the ephemeral timer system 202 determining that an ephemeral message story 504 has expired (e.g., is no longer accessible), the ephemeral timer system 202 communicates with the social media platform system 100 (and, for example, specifically the social media client application 104) to cause an indicium (e.g., an icon) associated with the relevant ephemeral message story 504 to no longer be displayed within a user interface of the social media client application 104. Similarly, when the ephemeral timer system 202 determines that the story participation parameter 510 for a particular ephemeral message 502 has expired, the ephemeral timer system 202 causes the social media client application 104 to no longer display an indicium (e.g., an icon or textual identification) associated with the ephemeral message 502.

### Example Embodiments of Map GUI Functionality

First, various aspects and features of the disclosure will be described conceptually with respect to specific example embodiments discussed with reference to and illustrated in FIGS. 6A-11B.

### Basic Map GUI Architecture

FIG. 6A shows an example embodiment of a map-based graphical user interface, further referred to as a map GUI 612, displayed on a client device 102 in the example form of a mobile phone. In this example embodiment, the map GUI 612 is generated on a display in the form of a touchscreen 606 capable of receiving haptic input. The map GUI 612 includes an interactive map 618 showing a stylized aerial or satellite representation of a particular geographical area. The map 618 is displayed within a map viewport 621 which, in this example embodiment, uses the full available area of the touchscreen 606. In other example embodiments, the map viewport 621 may be a bounded panel or window within a larger display screen. The map GUI 612 further comprises a plurality of user-selectable graphical user interface elements displayed at specific respective geographic locations on the map 618. Each such geo-anchored GUI element is in this example embodiment represented by a respective indicium or icon overlaid on the map 618. The different types of icons and their respective functionalities will be described in greater detail below. As will also be described briefly, the map GUI 612 may further include one or more informational overlays rendered over the underlying geographical map 618, in this example embodiment including a heatmap 625 representative of the geographical distribution of underlying social media activity on the social media platform provided by the relevant social media application.

As mentioned, the map GUI 612 includes a number of different user-selectable icons or UI elements that indicate different geographically based content or information. In this example embodiment, the map GUI 612 includes a plurality of different gallery icons, also referred to in this description as “story icons.” Each story icon corresponds in location on the map 618 to a respective location-based social media gallery or collection, in this example embodiment corresponding to a location-based story of ephemeral messages in the example form of so-called “snaps,” as discussed elsewhere herein. Each of these stories that are represented by respective story icons on the map 618 consists of a respective set of snaps (respectively comprising augmented or unaugmented photographic or video content) that are grouped together based at least in part on respective geo-tag data associated with respective snaps.

In the example embodiment of FIG. 6A, the map GUI 612 includes two different types of gallery icons for two different respective types of location-based social media galleries, namely place icons 631 for place galleries/stories, and spike icons 633 for spike galleries/stories that are dynamically surfaced on the map GUI 612 based on one or more metrics of underlying social media activity relating to the submission of social media items/snaps to the social media platform with geo-tag data indicating the respectively associated geographical areas. Note that these different types of galleries are represented by different types of icons 631, 633. The differences between these different types of galleries and the corresponding visually distinct gallery icons 631, 633 are discussed later herein. The map GUI 612 in this example embodiment further includes friend icons in the example form of bitmojis 640 that are displayed on the map GUI 612 based on the current or last known geographic location of respective friends of the user associated with the client device 102.

### Message and/or Story Ephemerality

In this example embodiment, the social media items that are selectively playable by selection of the corresponding story icons 631, 633 in the map GUI 612 are ephemeral social media items or messages. As described previously, ephemeral content is social media content (e.g., augmented and/or unaugmented video clips, pictures, and/or other messages) that is available for viewing by social media users via the map GUI 612 for only a predetermined limited period, also referred to herein as a respective gallery participation parameter or timer. After expiry of a respective gallery participation parameter or timer for any ephemeral message or snap uploaded by a particular user, that ephemeral message or snap is no longer available for viewing by other users via the map GUI 612 generated on their respective client devices 102. Current examples of such ephemeral social media content include the respective snaps or messages included in so-called “stories” in the SNAPCHAT or the INSTAGRAM social media applications.

Instead of, or in addition to, management of ephemerality on a per-snap level using respective gallery participation timers, availability of the ephemeral messages by the map GUI 612 can in some instances be managed collectively, e.g., on a per-story level. In such instances, each story can have a respective story duration parameter 508 (e.g., being based on a corresponding story timer 514 – see FIG. 5), at the expiry of which availability of the corresponding story for viewing via the map GUI 612 is terminated. In some embodiments, the story duration parameter 508 is calculated based on the story participation parameter 510 of one of the ephemeral messages included in the relevant story. For example, a story may in some embodiments expire when a last uploaded item within the story expires, in response to which the corresponding story icon 631, 633 is no longer displayed on the map GUI 612. In one example embodiment, the map GUI 612 may include one or more event icons (e.g., similar in appearance to the place icons 631 of FIG. 6A) corresponding to respective event stories, with the story duration parameter 508 of the event story being set to expire a predetermined period of time from the start or conclusion of the underlying event. At expiry of the story duration parameter 508, the corresponding gallery icon 631, 633 is removed from the map GUI 612, irrespective of individual timers associated with respective snaps included in the event story.

### Story Playback

The user can select any one of the gallery icons 631, 633 by haptic contact with the touchscreen 606 at the on-screen location of the selected gallery icon 631/633. In response to such selection, automated sequential playback of the corresponding set of ephemeral messages or snaps in the selected story is performed by the client device 102 on the touchscreen 606. Such automated sequential playback of the selected story consists of :
displaying on the touchscreen 606 the content or media payload of a first one of the ephemeral messages for a corresponding display duration (e.g., a default value of five seconds for photo-based messages and a maximum value of 10 seconds for video-based snaps), in this example embodiment temporarily replacing the map GUI 612 on the touchscreen 606 with a full-screen replay of the relevant snap;
at expiry of the display duration, displaying the content of the next snap/message for its display duration; and
thus progressing in sequence through all of the ephemeral messages in the selected story until all of the snaps in the story have been replayed or until the user selectively dismisses the playback sequence.

In some embodiments, not all of the snaps in a particular story/gallery are necessarily included in the replay sequence. For example, if there are many overlapping snaps (e.g., snaps showing substantially identical content), some of those snaps are automatically skipped to keep a continuous narrative and not repeat some sections of an event commonly captured by the different snaps. Instead, or in addition, the social media server application 114 can in some embodiments be programmed automatically to identify and curate overlapping or contemporaneous snaps based on timestamp information associated with respective snaps.

In this example embodiment, the snaps automatically collected together in a replayable spike story or place story are arranged automatically to be played back in chronological order based on respective timestamps (e.g., being played in sequence from oldest to newest or earliest posted to most recently posted). A benefit of such chronological playback is that viewing of the story provides a user with sequentially arranged views of events transpiring at the relevant location. In some instances, however, a human curator may choose to rearrange snaps out of chronological order, for example to improve the narrative flow of the story. In other embodiments, the snaps may be played in reverse chronological order, from newest to oldest.

It can thus be seen that the example map GUI 612 includes multiple location-based gallery icons in the example form of story icons 631, 633 that are user-selectable to trigger playback of respective collections of ephemeral social media items, in this example embodiment being respective ephemeral stories consisting of respective sets of ephemeral messages (also referred to in this description as “snaps”). In this example embodiment, each of the plurality of location-based stories represented by the respective story icons 631, 633 may comprise media content contributed by multiple different users.

### Our Story and Publication of Ephemeral Messages to Our Story

The respective ephemeral stories are in this example embodiment compiled from ephemeral messages submitted by multiple users based at least in part on geo-tagging of the respective snaps. Note that the ephemeral messages made available for viewing via the map GUI 612 are in this example embodiment not limited to content provided by other users who are members of an in-application social network of the user on whose client device 102 the map GUI 612 is generated. Instead, the social media content to which the map GUI 612 allows access is in this example embodiment provided by snaps uploaded or submitted by any user to be publicly accessible via the map GUI 612.

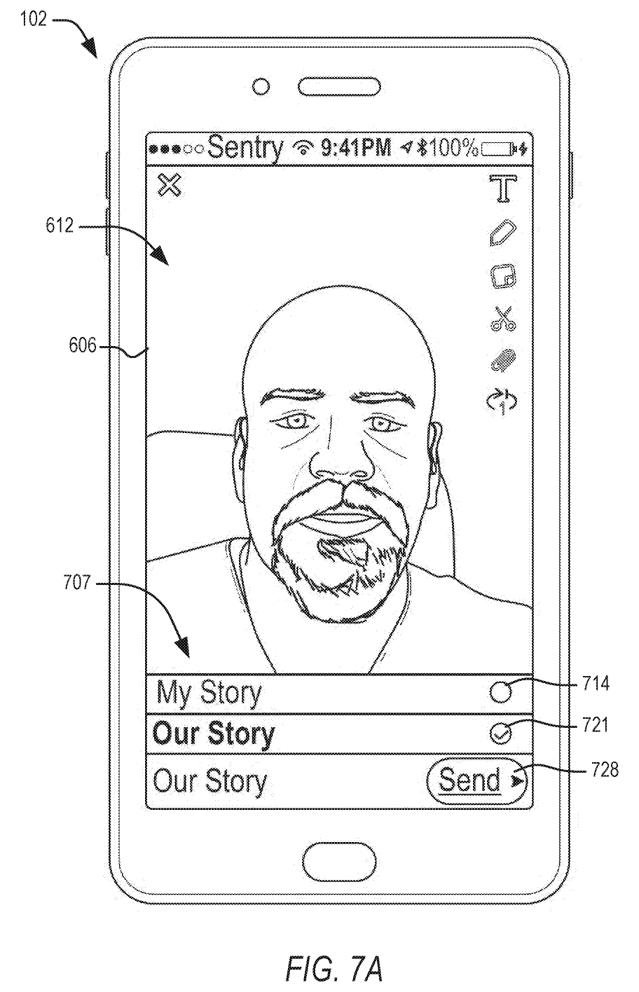

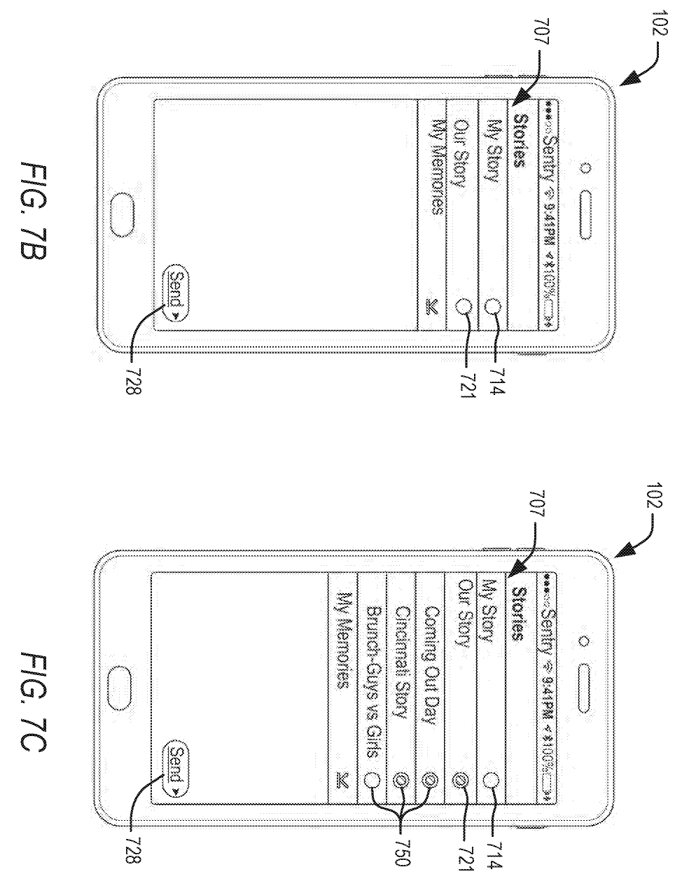

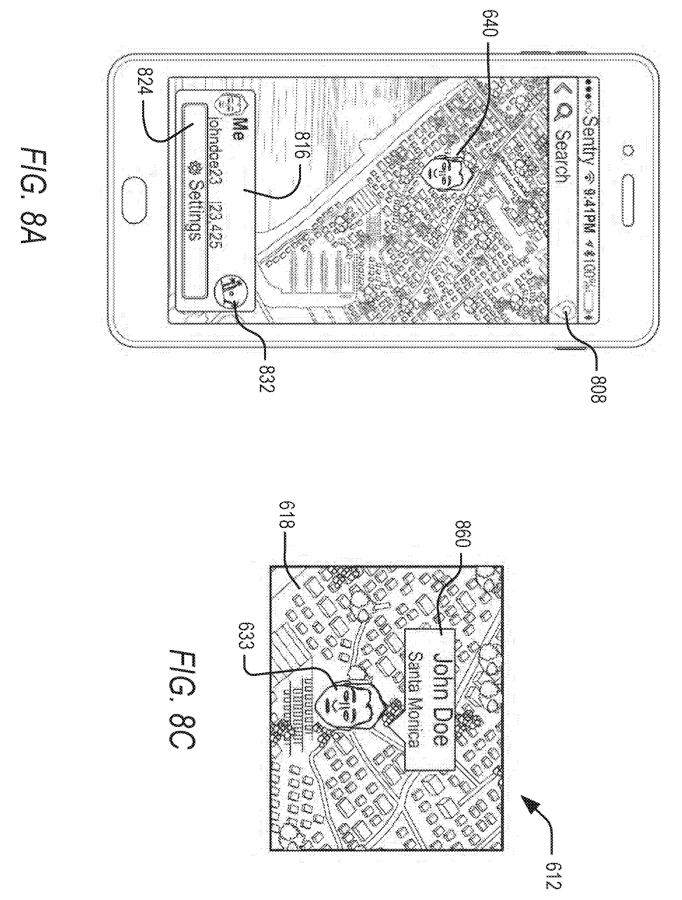

One aspect of the example map GUI 612 provides for the functionality for users to submit social media content that is publicly viewable via the map GUI 612. Turning briefly to FIG. 7A, therein is shown an example embodiment of a destination selection interface 707 forming part of the map GUI 612 to provide a mechanism that gives the user a selectable option to make a snap publicly viewable via the map GUI 612 upon capturing of the snap.

In this example embodiment, snaps can be captured via the map GUI 612 while the map viewport 621 is displayed (as seen in FIG. 6A) by operation of a camera soft button 650 (FIG. 6A) forming part of the map GUI 612. After capturing of photo or video content by operation of the camera soft button 650, the captured media content is displayed on the touchscreen 606 (FIG. 7A) together with the destination selection interface 707. In this example embodiment, the user can select one or both destination options identified in FIG. 7A as “My Story” and “Our Story,” represented in FIG. 7A by respective radio buttons 714, 721. By selecting the Our Story radio button 721 and thereafter selecting a “Send” soft button 728, the user can submit the snap over the network 106 to the application server 112 with an indication that the snap is available for non-private publication via the map GUI 612. If the snap is not so marked by the user, for example being associated with selection of the My Story radio button 714 only, then the snap is not available for inclusion in any of the stories associated with the story icons 631, 633 and is not available for inclusion in search results of a location-based search via the map GUI 612, as described later herein. Snaps included only in the My Story gallery are available only to friends of the user (e.g., members of the uploading user’s social network). The My Story gallery is a per-user location-agnostic gallery of ephemeral messages available to friend users only, thus being a non-public or private gallery.

In other example embodiments described herein, the superset of ephemeral messages made available by multiple users for public viewing via the map GUI 612 is alternatively referred to as the “Live Story” or simply as a “Live” gallery. For the purposes of the description of example embodiments herein, “Live Story” and “Our Story” are thus to be read as being synonymous. In the present example embodiment, the compilation and/or surfacing of gallery icons 631, 633 and the rendering of the heatmap 625 are based exclusively on publicly available social media content provided by snaps uploaded to Our Story. Calculation of metrics or attributes of social media activity upon which one or more aspects of the map GUI 612 are based (e.g., an unusualness or anomality metric indicating geo-temporal unusualness or anomality of social media activity within respective geographical areas) is in this example embodiment likewise based exclusively on snaps uploaded to Our Story.

### Visual Distinctions between Story Icons for Different Story Types

Returning now to the visual distinctions or differences between the different types of gallery icons 631, 633, it will be noted that each gallery icon 631/633 in this example embodiment comprises a circular graphical user interface element bearing a thumbnail image provided by the one of the snaps contained in the respective story. Each place icon 631, however, also includes an associated label 635 bearing a text indication of the associated place. In this example embodiment, the labels 635 indicate the respective places of the place stories surfaced in the geographic window presently displayed in the example map 618 as being the Rockefeller Center, Bryant Park, and the Empire State Building, respectively.

In other example embodiments, the visual distinctions between different types of story icons may be provided in a different manner. FIG. 6B, for example, shows another example embodiment of a map GUI 612 that is analogous to the example embodiment of FIG. 6A, a major difference being that the visual distinction between place icons 631 and spike icons 633 is provided at least in part by differently shaped thumbnail images. In the example of FIG. 6B, the thumbnails of the place icons 631 are rectangular, while the thumbnails of the spike icons 633 are circular.

The respective thumbnail images that are used for the spike icons 633 are in the example embodiments of FIGS. 6A and 6B automatically selected by the social media server application 114. In this instance, the thumbnail image for a spike icon 633 is automatically selected based on the posting time of the respective snaps forming part of the corresponding spike story, in this case being selected as a most recently posted snap in the relevant story. In other embodiments, automatic selection of the thumbnail image to be used in the spike icon 633 can be based on selecting the earliest-posted ephemeral message/snap that is still available for viewing as part of the spike story. The thumbnail images for the place icons 631 (or for icons associated with other curated stories, such as event stories) can in some embodiments likewise be selected automatically. In this embodiment, however, the thumbnail images for the place icons 631 can be selected from the snaps included in the corresponding story/gallery by a human operator via a content management interface forming part of the social media server application 114. Absent such an explicit designation of a particular snap to be used for the thumbnail image, thumbnail selection may revert to an automatic default selection as described previously.

### Differences between Different Story Types

### Place Stories

Returning to FIG. 6A, the differences between the different types of social media galleries or stories accessible via respective story icons 631, 633 on the map GUI 612 will now be briefly discussed.

Place stories, represented by respective place icons 631, are social media galleries for defined locations or places, typically being places that consistently have relatively large activity volumes (e.g., Times Square, Universal Studios, etc.). Note that, in this example embodiment, not all defined places are by default surfaced in the map GUI 612 by respective place icons 631. Instead, the geo-anchored place stories are surfaced based on the amount of activity (e.g., the raw number of uploaded snaps) captured within a defined geographical area associated with the relevant place, as indicated by associated geo-tag data. This ensures that places that regularly or always attract relatively large volumes of snaps are identified as such on the map 618.

Defined places for which place icons 631 may be surfaced in the map GUI 612 are in this example embodiment manually created by one or more human operators using a server-side gallery management system or content management system (CMS) 1224 provided by a server-side social media platform system 1200 (FIG. 12). In this example embodiment, each defined place has:
(a) an associated operator-defined polygon marking its geographical boundaries, that specify a particular geographical area for the place story;
(b) a thumbnail location or icon location, typically lying within the associated polygon, that specifies the on-map position at which the place icon 631 for a gallery or story associated with that place is displayed in the map 618; and
(c) a name by which the place is identified. In the example embodiment of FIG. 6A, this is the name that is displayed on the associated label 635 of the place icon 631.

In other embodiments, such places and associated place stories are automatically identified by historical snap volume. In some such embodiments, the defined places and their associated stories/galleries are created and curated automatically by server-side procedures.

In some instances, each place story includes all of the snaps having geotag information indicating a geographic location lying within the associated polygon. Selection of a particular place icon 631 (e.g., by clicking in a desktop application or by tapping on the touchscreen 606 in the example embodiment of FIG. 6A) in such cases plays all the snaps from within the corresponding polygon. In this example embodiment, the CMS 1224 provides functionality to operators or administrators to curate the collection of snaps associated with any operator-selected defined place (e.g., a particular geographical area defined by the corresponding polygon). The operator or one or more automated procedures can thus, for example, delete individual snaps from the place story, or can select individual snaps for inclusion in the place story.

When snaps are played in response to selection of a place icon 631, the name of the place appears on-screen together with the replayed content or payload of the respective snaps. As mentioned, in this example embodiment, the snap represented by a corresponding thumbnail within the relevant place icon 631 is played first, then the rest in time order.

### Spike Stories

The unlabeled circular spike icons 633 are automatically surfaced for geographical areas of unusually high activity, with the respective associated spike stories or ad hoc galleries including unexpired snaps within the associated geographical area. In the example embodiment of FIG. 6A, all ad hoc galleries associated with spike icons 633 are unmoderated, so that selecting a spike icon 633 triggers automated sequential replay of all of the snaps within a geographical area associated with the spike icon 633. In a particular example embodiment, the geographical area associated with the spike icon 633 includes all geographical points located within a predefined radius of the on-map location of the selected spike icon 633.

Thus, clicking or tapping on the spike icon 633 plays all the snaps in that cluster, showing the snap in the thumbnail first and then the rest of the snaps in time order. Note, again, that the snaps clustered under the common spike icon 633 are in this example uploaded by multiple different respective social media users to Our Story, and are uncurated by moderators. In other embodiments, the stories collected under such spike thumbnails may be curated.

Automated selection of spike icons 633 (and therefore of the associated social media gallery, collection, or story) for surfacing in the map GUI 612 is in this example embodiment based at least in part on calculation of respective anomality or unusualness metric values for different geographical areas. Thus, a higher level of unusualness or anomality of user activity in a particular geo-temporal space would in such instances increase the likelihood of a particular spike story being surfaced on the map GUI 612 by display of a corresponding spike icon 633. As mentioned, the anomality metric provides an indication of the level of geo-temporal unusualness or anomality of social media activity. Calculation of anomality metrics can in some embodiments comprise calculating a level or percentage of difference between historical activity levels in a given area, and activity levels in a current time window. It will be appreciated that heat map coloration and content surfacing increases with an increase in positive anomality levels (i.e., indicating unusually high social media activity). Also note that, in some embodiments, a social media activity metric upon which heat map generation and/or content surfacing is based on a combination of factors that include an anomality metric. In a particular example embodiment, the social media activity metric is provided by a combination of a raw activity metric and an anomality metric.

Instead, or in addition, human curators can, via the CMS 1224, also mark specific spike stories or clusters as “interesting,” thereby boosting the unusualness or anomality score of the respective spike.

Note that, in the example embodiment described with reference to FIG. 6A, different social media activity attributes or metrics are used for surfacing of the place icons 631 and the spike icons 633 respectively. As discussed, spike icons 633 are in this example embodiment surfaced based on anomality metric values, while place icons 631 are surfaced based on raw snap volume. In other embodiments, surfacing of the place icons 631 may also be based at least in part on associated anomality values. Note that in some embodiments, various aspects of social media surfacing as described herein (including heatmap calculation and generation, story surfacing, etc.) are based on attributes other than anomality. For example, the heatmap 625 and story surfacing are in one embodiment based on raw activity levels. Therefore, discussion herein of aspects of the disclosure relating to informational overlays (such as the heatmap 625) and content surfacing based on the anomality metric is to be read as, in other embodiments, being performed based on a different social media activity value, such as raw snap numbers in a given time period, snap frequency, snap density, or the like.

### Other Types of Stories or Ephemeral Social Media Galleries

Other embodiments can instead, or in addition, provide for social media gallery types different from the place stories and the spike stories described with reference to FIGS. 6A and 6B. Each such different type of gallery may be represented on the map 618 by a visually distinct type of icon or other user interface element.

One example embodiment provides for event galleries pertaining to particular events occurring at a specific location. Such events can include, for example, concerts, festivals, sports events, or the like. These event galleries are in one embodiment created and curated server-side by human operators using the CMS 1224.

Some embodiments provide for surfacing on the map 618 story icons or thumbnails with respect to non-public snaps, e.g., snaps or stories that are access-restricted based at least in part on social network information. For example, individual stories uploaded by friend users may in some embodiments be represented on the map 618 by a respective icon or thumbnail. For example, the My Story of friend users may in some embodiments be directly accessible via the map 618. Such story icons are in some embodiments indicated by a respective friend icon or bitmoji 640 located on the map 618 corresponding to the location at which the corresponding story was generated. In other embodiments, each such user story icon may be indicated on the map GUI 612 by a circular thumbnail analogous to the previously described example story icons 631, 633.

### Snap Submission to User-Selected Location-Based Stories

Another feature of the disclosure enables users to submit publicly viewable snaps designated for inclusion in any and all Live Stories or ephemeral galleries that might be happening at locations where the user is eligible to post, e.g., being geographically proximate to the current location of the user as indicated by the associated client device 102. In this manner, the user can specify snaps for inclusion in place stories, event stories, or other location-based ephemeral social media galleries as discussed above.

FIGS. 7B and 7C show an example embodiment of a destination selection interface 707 that provides a mechanism for such destination selection alternative to the example embodiment previously described with reference to FIG. 7A. The destination selection interface 707 of FIG. 7B is displayed on the client device 102 in response to the user initiating a snap submission flow, e.g., by capturing a snap.

The destination selection interface 707 of FIG. 7B is similar to that of the example embodiment of FIG. 7A, in that two different user-selectable user interface elements in the form of respective radio buttons 714, 721 are presented for posting a snap to a user-specific My Story (radio button 714) or to a publicly viewable Our Story (radio button 721). A distinction between the destination selection interface 707 of FIG. 7A and that of FIG. 7B is that the Our Story cell of FIG. 7B automatically expands upon selection of the radio button 721 to show subtitles of local place stories and/or event stories to which the snap could be submitted based on device location or the geo-tag of the associated snap.

FIG. 7C shows additional options presented as a result of selecting the Our Story radio button 721, which opens up a list showing the respective local stories for which the snap is eligible. In this example embodiment, all suboptions are selected by default via respective radio buttons 750. In other embodiments, separate selection of individual suboptions may be required. If the user chooses to submit the snap with all of the options selected, that snap is automatically associated with each of the selected suboptions as well as being made available for geographically based viewing as part of Our Story, separate from any curated location-based place or event gallery/story, as described above.

The user can deselect any particular suboptions by clicking or tapping on the corresponding default-selected radio button 750, as shown in FIG. 7C, in which the lowermost one of the suboptions has been deselected. If all suboptions are deselected, the snap is not posted to any curated location-based story, but is posted only to Our Story to be publicly viewable via the map GUI 612, as described elsewhere herein.

### Heatmap Considerations

As shown in FIG. 6A, the social media application map GUI 612 in this example embodiment includes a heat map layer overlaid on the geographical map 618, thus providing the heatmap 625 that indicates geographical distribution of one or more attributes of user activity within the social media application. As discussed previously, the heatmap 625 indicates user activity levels with respect to posting geotagged content that is publicly viewable (e.g., Live Stories/Our Story). Instead, or in addition, the heatmap 625 can in some embodiments be based on snaps that are available for viewing by the particular user on whose client device 102 the map GUI 612 is displayed, in which case the heatmap 625 may differ from person to person depending on who gave the viewer permission to see their snaps.

In this example embodiment, the map 618 is color-coded, with warmer colors corresponding to higher levels of unusualness, as indicated by higher anomality metric values. Thus, in the map 618 illustrated in FIG. 6A, the red areas of the heatmap 625 indicate those geographical areas with snap clusters corresponding to the highest anomality metric values. Again, different metrics or attributes for generation of the heatmap 625 may be used in other embodiments, for example being based on snap density (e.g., raw snap volume per unit area of the map 618).

In some embodiments, the map GUI 612 displays information pertaining to the heatmap 625 differently at different magnification levels. For example, calculation of anomality metrics and consequent rendering of the heatmap 625 based thereon is in some embodiments performed separately for each of a plurality of zoom levels. In addition, different sets of spike icons 633 may be surfaced at different magnification levels. In one example embodiment, the heatmap 625 may be displayed at a first zoom level without individual spike icons 633 surfaced in the map GUI 612, while multiple gallery or story icons 631, 633 are automatically surfaced in response to user-controlled zooming in on a particular portion of the map 618 shown at the first zoom level.

### Anomality Metric Calculation

Some features of the map GUI 612 in this example embodiment provide for calculating with respect to social media content an anomality metric that quantifies geospatial anomality or unusualness of the social media content, and for surfacing the social media content in the map GUI 612 based on respective values for the anomality metric. In this example embodiment, respective collections of snaps associated with different geographical locations are ranked based at least in part on corresponding anomality metric values, and a predetermined number of the collections are automatically selected based on their anomality rankings for surfacing on the map GUI 612 with respective spike icons 633. Instead, or in addition, all spike stories with a positive anomality metric value (i.e., reflecting anomalously high, not low, activity) higher than a predefined threshold value can automatically be surfaced by the display of a corresponding spike icon 633. As described elsewhere herein, the calculation and display of heatmap information is in some embodiments based at least in part on anomality metric calculation.

Anomality metrics may in some embodiments be calculated for individual social media items. In this example embodiment, however, anomality metrics are calculated for collective user behavior. In particular, anomality metrics are calculated for multiple snaps (in this example being respective geotagged social media submissions) based on a comparison between geo-temporal distribution of the multiple snaps and historic geo-temporal social media behavior in or around the relevant geographic location.

Note that the calculation of anomality metrics is in this example embodiment time sensitive. Thus, the same volume of snaps in a particular location may be identified as being anomalous at one time of the day but not at another time. For example, a certain level of social media activity (here, posting of snaps to Our Story) at the Empire State Building would be flagged as above-threshold anomalous at 4 AM, but would not be thus identified as anomalous during daytime.

An aspect of the disclosure provides for determining one or more geo-temporal attributes of social media activity by a process comprising, for each of multiple social media postings, representing the posting as having a distribution in time and/or in space. In some embodiments, representing respective postings as having a geo-temporal distribution comprises treating respective social media items as a probability cloud, for example having a Gaussian distribution. Instead, or in addition, the method may comprise generating or extrapolating a historical model or historical representation of social media activity based at least in part on a resampling procedure executed with respect to a multiplicity of historical geo-tagged social media items. In one example embodiment, the resampling procedure comprises a bootstrapping operation.

In some embodiments, the representation of social media postings as having respective distributions in time and/or space is performed as part of an operation to represent a geo-temporal reference profile or model for historical social media activity for a particular geographical area. Instead, or in addition, the representation of social media postings as having respective distributions in time and/or space may be performed as part of a procedure to represent recent or near-live social media activity in the particular geographical area. In such cases, the geo-temporal reference profile and the representation of the recent or near-live social media activity may be used in combination to identify within the geographical area one or more regions of interesting or anomalous social media activity, e.g., by calculating a geographical distribution of a quantified anomality metric based on differences between the geo-temporal reference profile and the corresponding representation of recent or near-live social media activity.

### Dynamic Variation of Icon Size

Turning briefly to FIG. 6B, it will be seen that the map GUI 612 illustrated therein provides an example embodiment of an aspect of the disclosure that provides for automated variation in one or more visual attributes of user interface elements associated with respective social media content based at least in part on a quantified attribute of underlying social media activity. In particular, the example embodiment of FIG. 6B provides for dynamic variation in the on-screen size of respective spike icons 633 based on respective anomality metric values for the corresponding clusters or spike galleries. On-screen size of the respective spike icons 633 thus indicates a level of unusualness or anomality of the underlying social media activity. Worded differently, the size of a spike icon 633 represents how unusual it is for there to be the relevant amount of activity in that spot, with a larger spike icon 633 indicating a greater level of unusualness.

Instead, or in addition, a visual attribute (such as its on-screen size) of the place icons 631 may likewise be variable based on a corresponding anomality value. In the example embodiment of FIG. 6B, however, the on-screen size of the place icons 631 is variable based on snap volume, with a greater number of snaps included in any place story corresponding to a larger on-screen size of the associated place icon 631. Thus, it is intuitively intelligible from the example screenshot shown in FIG. 6B that the Universal Studios story has a greater number of snaps than the Venice Boardwalk story.

### Location Sharing and User Icons

### User Location Display

As mentioned previously, the map GUI 612 includes a graphical representation of associated locations of the user associated with the client device 102 and/or other users, each user being represented by a respective user icon or friend icon (for users who are members of an in-application social graph associated with the viewing user), in the illustrated embodiments being in the form of respective bitmojis 640. In this example embodiment, a user of the social media platform will not be sharing their location if they have never interacted with the map GUI 612. The first time the user interacts with the map GUI 612, the user is taken through an on-boarding flow which allows for the setting of individual location sharing preferences.

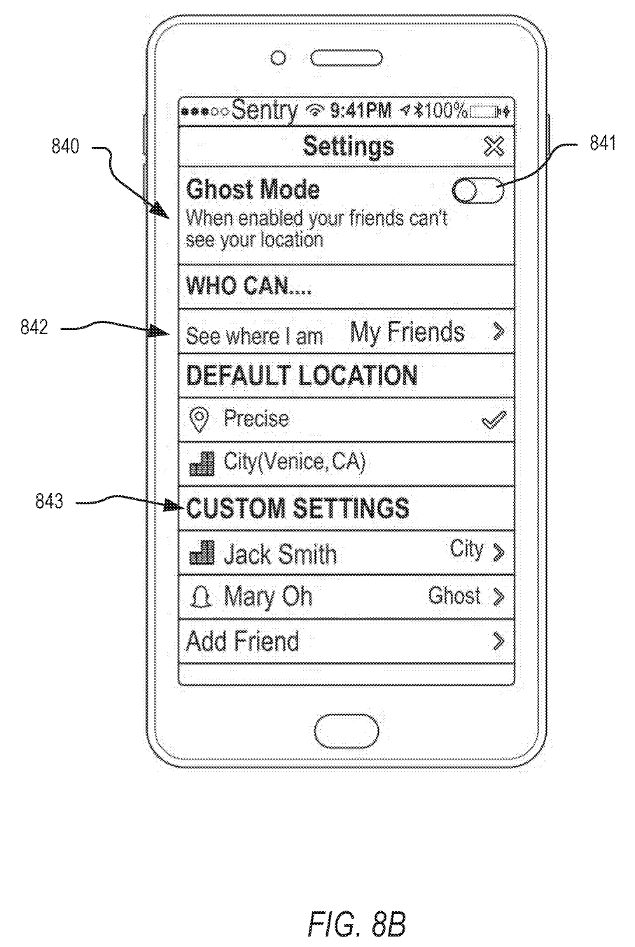

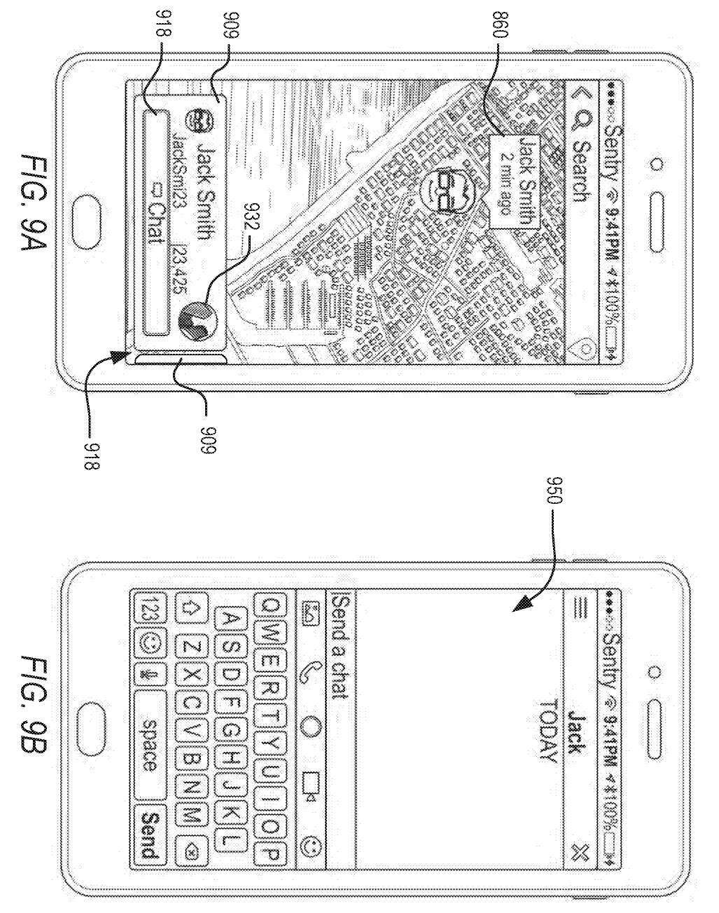

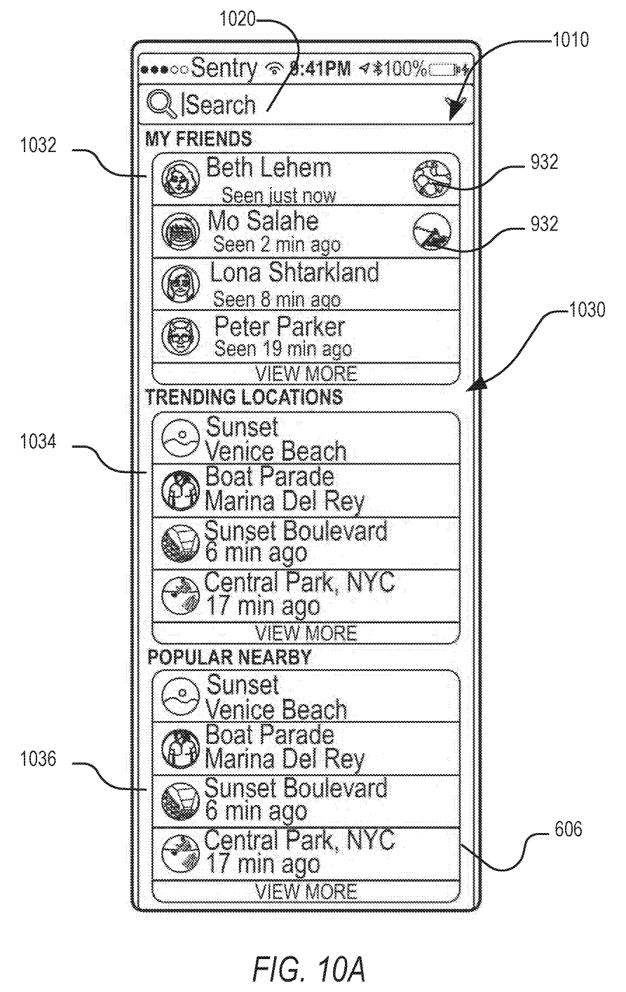

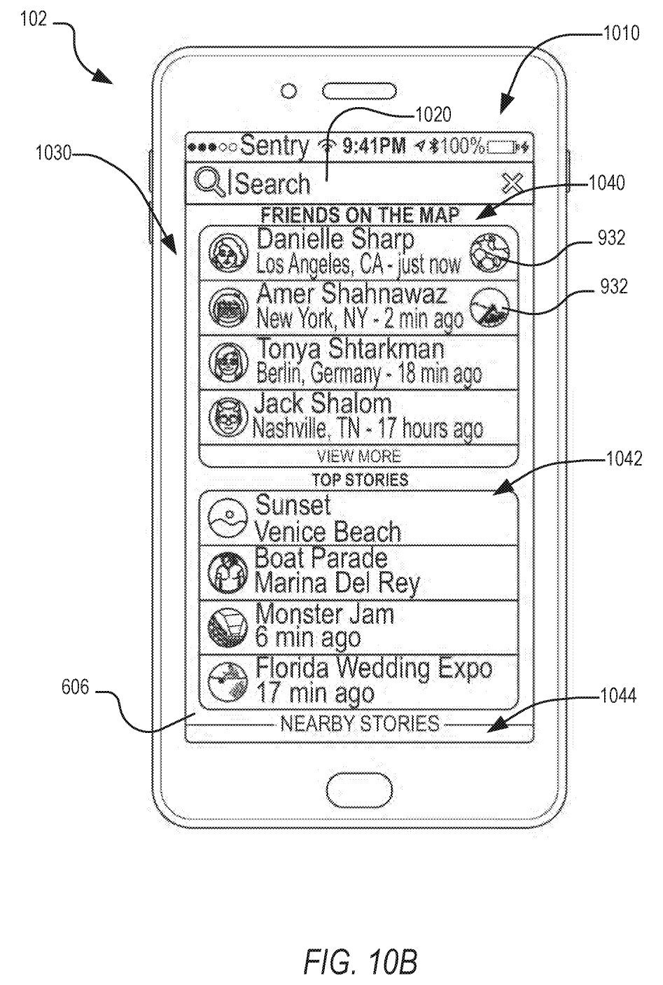

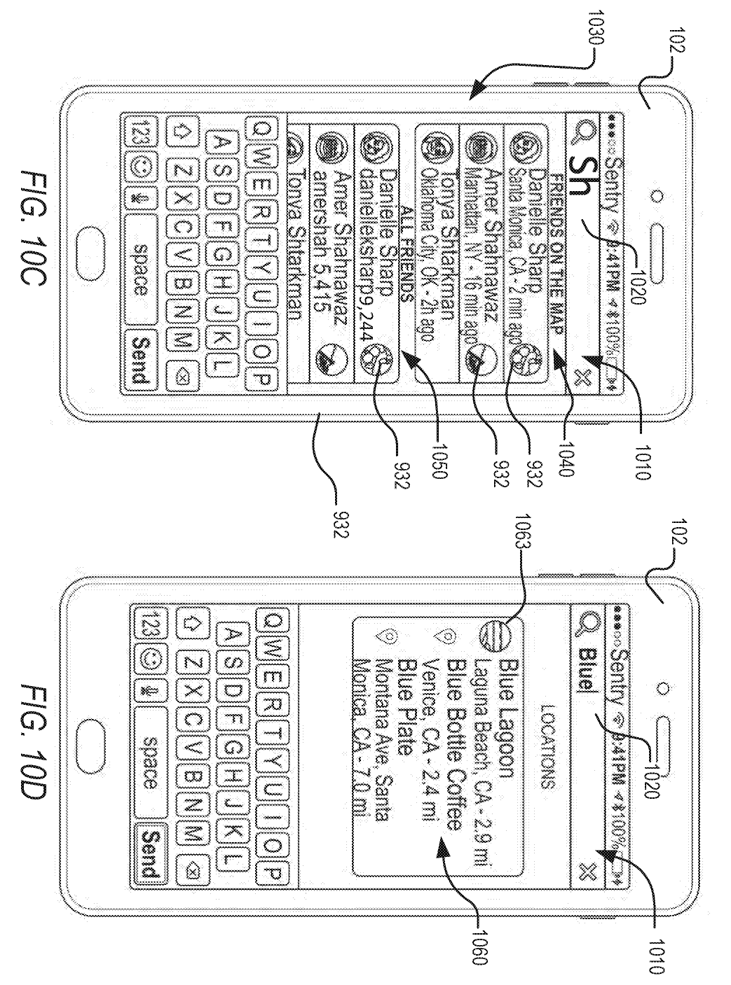

Regardless of whether the user has selected to show their location to anyone, the user can see their own current location on the map at all times, and, if the user’s bitmoji 640 is no longer in view, snap back to it, causing the map focus to re-center on the user location. FIG. 8A shows an example embodiment in which the viewing user’s location is indicated by a custom user-selected or user-generated user interface element in the form of the user’s bitmoji 640.

Location sharing preferences can be changed from the graphical user interface of FIG. 8A. In this embodiment, changes to location sharing preferences can be affected by (a) entering an invisible mode in which the user’s location is not visible by any other user (also referred to herein as Ghost Mode), and (b) changing default location sharing settings and/or respective settings for different friend users and/or groups of friend users.

Location sharing can be turned off or on from within the map GUI 612, thereby to enter or exit Ghost Mode. In this embodiment, Ghost Mode can be toggled on/off via a map pin icon 808 in the top right (see FIG. 8A). When location sharing is off (i.e., when in Ghost Mode), the user’s location is no longer displayed in the map GUI 612 on other user’s client devices 102. The user can still, however, see his/her location in the map GUI on his/her own device. When in Ghost Mode, a ghost icon (not shown) slowly pulses in the top right of the screen in replacement of the map pin icon 808.

Note that the Ghost Mode functionality described herein is to be distinguished from turning off location services on a mobile user device. Thus, when Ghost Mode is turned on, the device location services of the client device 102 are still functioning, so that the user location can still be determined and displayed on the map GUI 612 of the user’s own device 102, with social media content captured in Ghost Mode still being geo-tagged.

When the user turns on Ghost Mode after previously being present on the map, the user’s bitmoji 640 disappears within seconds from other people’s maps. When in Ghost Mode, the user can still see anyone on the map who has chosen to share their location with the user.

If the user selects their own bitmoji 640, a user bubble or user panel 816 is launched at the bottom of the touchscreen 606, enabling the user to access location sharing preferences via a settings soft button 824. The user panel 816 further includes a location-agnostic collection icon in the form of a My Story icon 832. The My Story icon 832 is selectable to launch replay of the viewing user’s My Story, being a location-agnostic collection of social media items (here, ephemeral snaps) submitted by the user. Analogous to other location-agnostic GUI features disclosed herein, location-agnostic in this context means that the collection of social media items playable via the My Story icon 832 is collated and displayed without regard to any location constraint, thus being unaffected by geo-tagging information associated with the respective items, by the user’s current location, or by the current focus of the map 618.

### Location Sharing Preferences

Selecting the settings soft button 824 causes display in the map GUI 612 of a location sharing preferences interface 840 (FIG. 8B) that, in this example embodiment, provides the user with options for specifying who will get to see their location, and at what granularity. Default sharing granularity options provided in this example embodiment include:
Precise, meaning in this embodiment is that the user’s bitmoji 640 is displayed to friend users via their map GUIs 612 at the user’s actual location (e.g., as indicated by the location services of the client device 102). In other words, the display location and the actual location for the user is substantially the same; and
City, meaning that the display location of the user’s bitmoji 640 will be different from the actual location, but will be located within a defined geographical region corresponding to the current actual location. In this example embodiment, the defined geographical region within which the user’s location is displayed is at a city level (e.g., Venice, CA, London, etc.).

When the city option is selected for a particular group of users or for particular individuals, the user’s bitmoji 640 will in this example embodiment be shown in the map GUI 612 generated on the user devices 102 of the selected persons (or persons within the selected group) at a random location within that city, and which will in this embodiment not change if the user does not leave that city. FIG. 8C shows an example of display of a user bitmoji 640 in the interactive map 618 of the map GUI 612 at such a city-level display granularity, in which the user bitmoji 640 is shown at the random location in the city, together with an associated label 860 specifying, broadly, the city in which the user is located (in the illustrated example embodiment being Santa Monica).

Note that the features related to intentionally inaccurate display of the user’s location has the effect that the user’s location is displayed differently on, the one hand, an instance of the map GUI 612 generated on their own device 102 (e.g., FIG. 8A, in which the display location of the user bitmoji 640 corresponds to the actual location of the user) and, on the other hand, instances of the map GUI 612 generated on the user devices 102 of friend users having a non-precise viewing permission (e.g., labeled city-level display such as that illustrated in FIG. 8C, in which the display location of the user bitmoji 640 differs from the user’s actual location). In this example embodiment, the display location of the user bitmoji 640 at a non-precise regional level (e.g., at city-level) is the same across different friend user devices 102, so that different friends see the user bitmoji 640 as being displayed at the same random location. In other embodiments, the display location can be different for different friend users.

It will be seen that this aspect of the disclosure thus provides for a method comprising: determining a location of a user device associated with the user of a social media application; determining a user-selected location display setting that specifies a manner in which the user location is to be displayed on a map-based GUI displayed to other users of the social media application, the location display setting being selected from a predetermined set of location display settings that correspond to display of the user location at different respective levels of precision on the map-based GUI; and representing the user on the map-based GUI of the friend user by rendering a UI element associated with the user at a location on the map-based GUI in accordance with the selected location display setting.

The defined geographic region is in the example embodiment of FIG. 8B as being available only at city level. In other embodiments, different or additional levels of display granularity can be provided, for example identifying different levels of cartographically and/or politically defined geographical regions, such as county-, city-, town-, or neighborhood level. Note that, in the example embodiment of FIG. 8B, Ghost Mode can not only be toggled at a general level (via a Ghost Mode toggle 841), but can be selected for groups of users or for individual friend users via a group selector 842 and a friend selector 843 respectively. In some embodiments, the displayed user location remains fixed at the randomly selected display position until the user device 102 leaves the defined geographic area. Thus, a new display location is in some embodiments determined each time the user enters the relevant area.

As mentioned, the user can also via the location sharing preferences interface 840 select different groups of other users to which his location will be displayed, and may in some embodiments specify different display attributes for the different respective groups or for different respective individuals. In this example, audience options available via the group selector 842 include: Best Friends, Friends, and Custom (which is an individual-level whitelist of people specified by the friend selector 843).

If Friends are selected, all new people added to the user’s friends list will automatically be able to see their location, consistent with the granularity level selected in the group selector 842 (e.g., being selectable as precise or at city level in the group selector 842 of FIG. 8B). If they are already sharing with the user, they appear within seconds on the user’s map.

In this example embodiment, the location sharing relationships are two-way – if John is sharing his location with Jack, Jack will not see John on his map 618 unless he has added him as a friend. The user cannot add anyone who is not a friend to the Custom section. The user can furthermore, via the friend selector 84343, define more specialized permissions for specific people, which override the default setting

When viewing the map GUI 612, the user will thus be able to see the locations of all his/her friends that have shared their location with him/her on the map 618. As discussed, each user is in this example embodiment represented by a bitmoji 640. If the friend does not have a bitmoji 640, a profile picture within a generic UI element is shown. If no profile pictures available for a particular friend, a default icon (e.g., a blank profile) is displayed at the corresponding location.

### Friend-Level Access via Friend Icon/Friend Carousel

In this example embodiment, friend-level access to friend information and friend-specific content is enabled via the interactive map 618. Such friend-level access is distinguished from location-based access mechanisms such as a location-based search or snap collections accessible via respective geo-anchored story icons 631, 633. One example of such a friend-level access mechanism is a friend bubble or friend panel 909 (FIG. 9A that pops up at the bottom of the screen when the user taps on the bitmoji 640 of a displayed friend. The friend panel 909 and a friend carousel 918 of which it forms part, provide a number of functionalities to the user.

In the example embodiment of FIG. 9A, the friend panel 909 displays summary information about the user. As illustrated in FIG. 9A, the friend panel 909 forms part of a friend carousel 918 that enables the user selectively to switch focus between different friends. Note that, in addition to the main friend panel 909, the friend carousel 918 includes a next friend panel 909 whose left edge is exposed on the right-hand side of the touchscreen 606.

The user can swipe between friends on the map 618 via the friend carousel 918. In this example embodiment, switching between friends is achieved by swiping the current focus friend panel 909 left or right. Swiping left or right on the friend panel 909 brings into view the next or previous friend panel 909, as the case may be. In this example embodiment, swiping to a particular friend automatically centers the map 618 on the bitmoji 640 of that friend. Note that all of the friends for whom the user has viewing permission should be available as part of the friend carousel 918, not just those friends who are visible in the map viewport 621. Friends are in this embodiment ordered in the carousel by update recency.

The friend panel 909 also includes a chat soft button 918 that can be selected to launch a chat interface 950 (see FIG. 9B) in temporary replacement of the interactive map 618, but without leaving the map GUI 612. In other embodiments, tapping on the friend bitmojis 640 causes a fly-out menu to be displayed, with initiation of a chat session being one of the selectable options.

In this example embodiment, selection of the chat soft button 918 causes the chat interface 950 to pop up in a modal over the map 618, which modal can be swiped down to dismiss. Incoming chat notifications can be opened in this modal view.

The friend carousel 918 additionally provides location-agnostic access to social media content provided by respective friend users via the map GUI 612. In this example embodiment, such location-agnostic access is available via a location-agnostic collection icon in the form of a respective Friend Story icon 932 displayed in the friend panel 909. The Friend Story icon 932 is selectable to trigger replay of a corresponding story (in this example being that the My Story of the selected friend) comprising a series of snaps uploaded by the corresponding friend user, without any location constraint on the replayed material. In other words, no location information has any effect on the availability and identity of these snaps. The friend carousel 918, via the Friend Story icon 932 thus provides a link from the user location to social media content that is not located anywhere, in that the snaps or stories thus available will be the same irrespective of the friend user’s current location, the current focus of the map viewport 621, or the current location of the viewing user. Worded differently, this and other location-agnostic access features of the map GUI 612 provide for access to friend content via the map GUI 612 in a manner similar to that which would be provided by a GUI that is not map-based. Thus, in one example embodiment, selecting a particular friend bitmoji 640 causes display of a menu or user interface element (in the example embodiment of FIG. 9A, the respective Friend Story icon 932 of the selected user) through which available snaps and/or stories of the target user can be viewed, without regard to any geo-tagging information of the respective snaps/stories.

As will be described below, certain aspects of the search mechanisms provided by the map GUI 612 similarly provide access to location-agnostic social media content of friend users via the map GUI 612.

### Search Functionalities

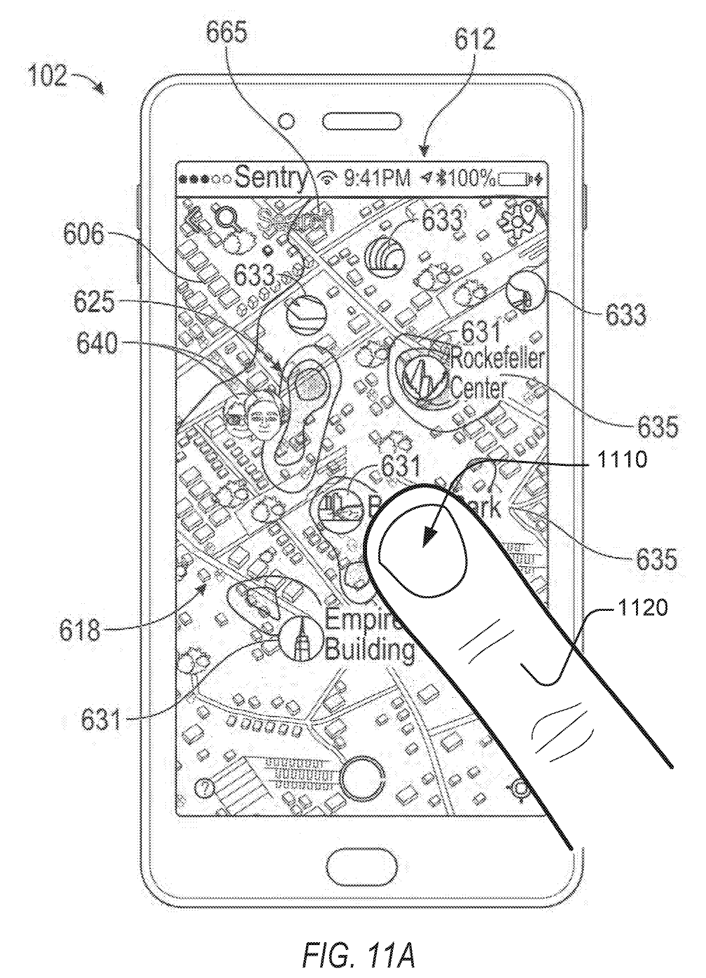

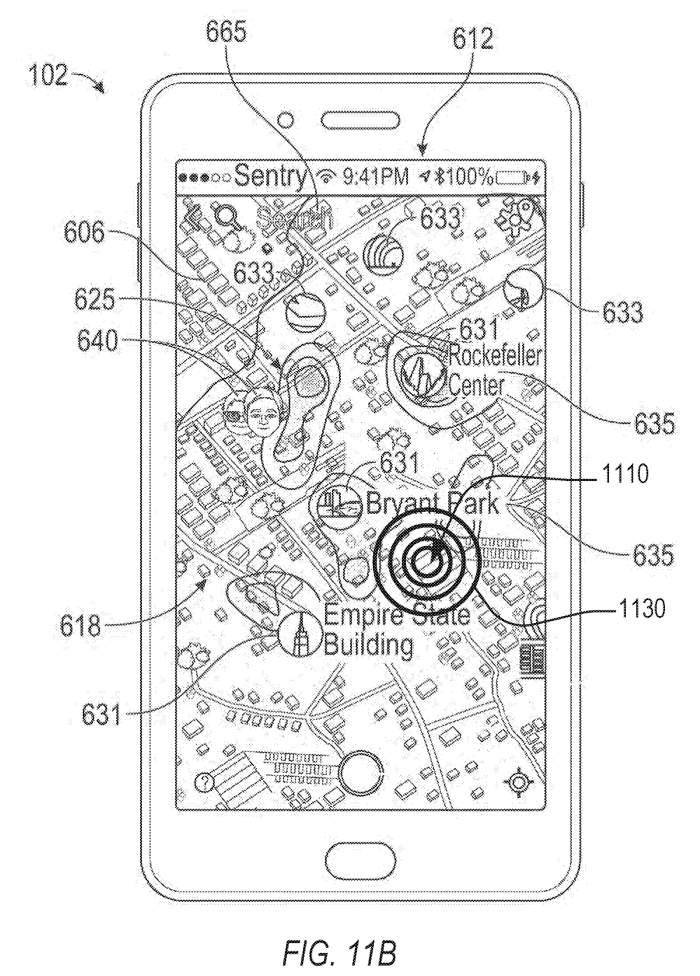

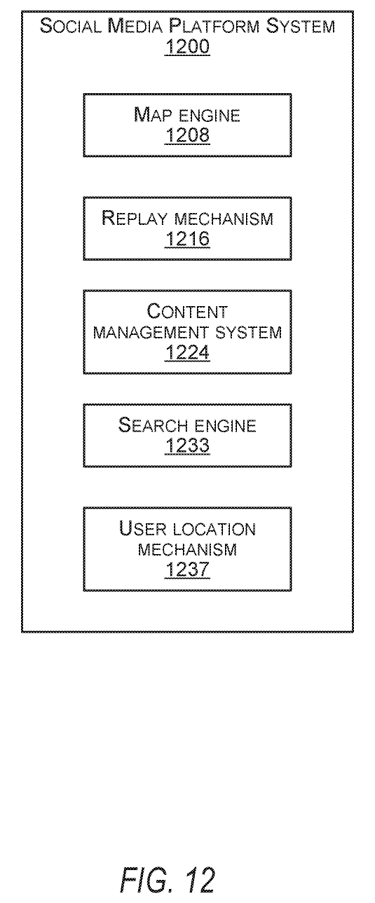

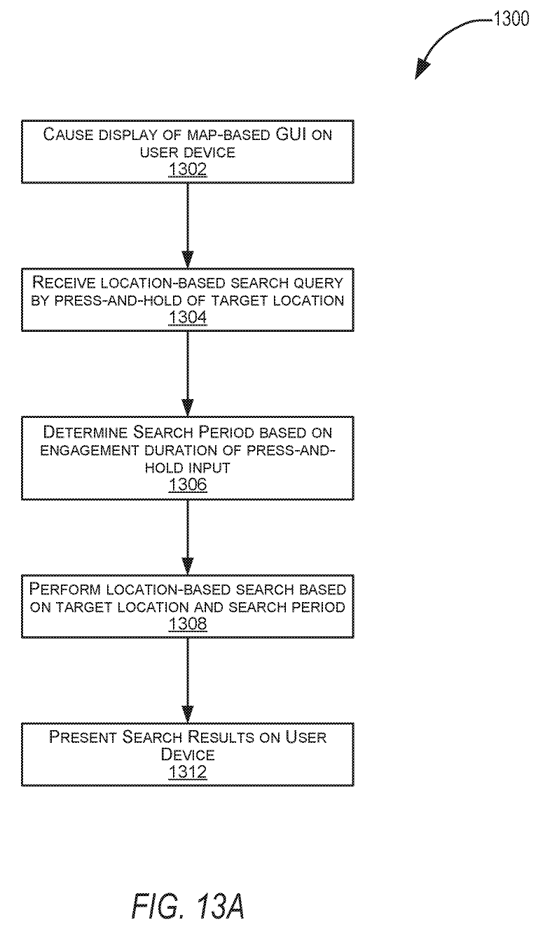

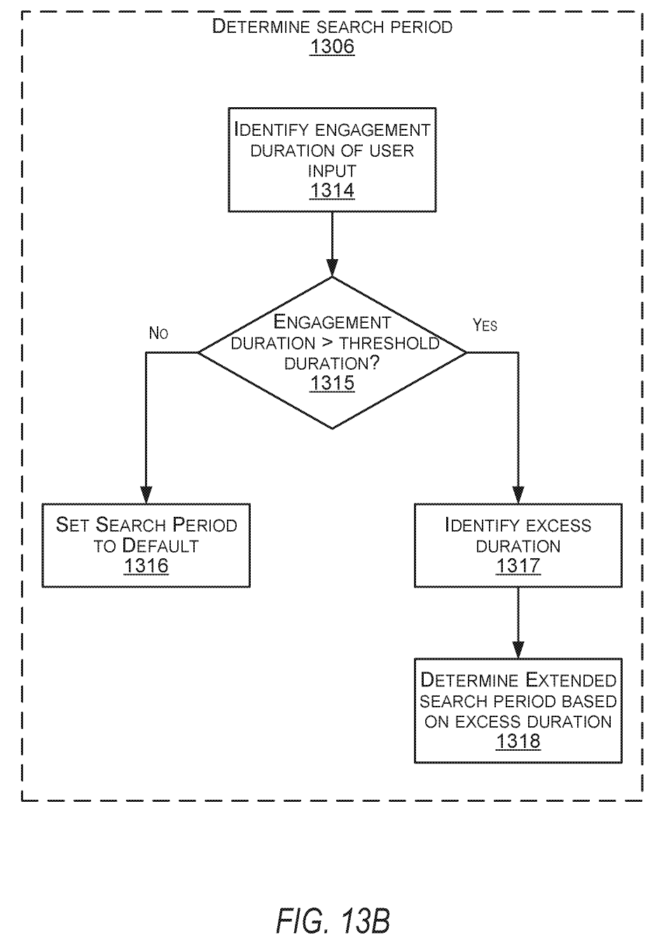

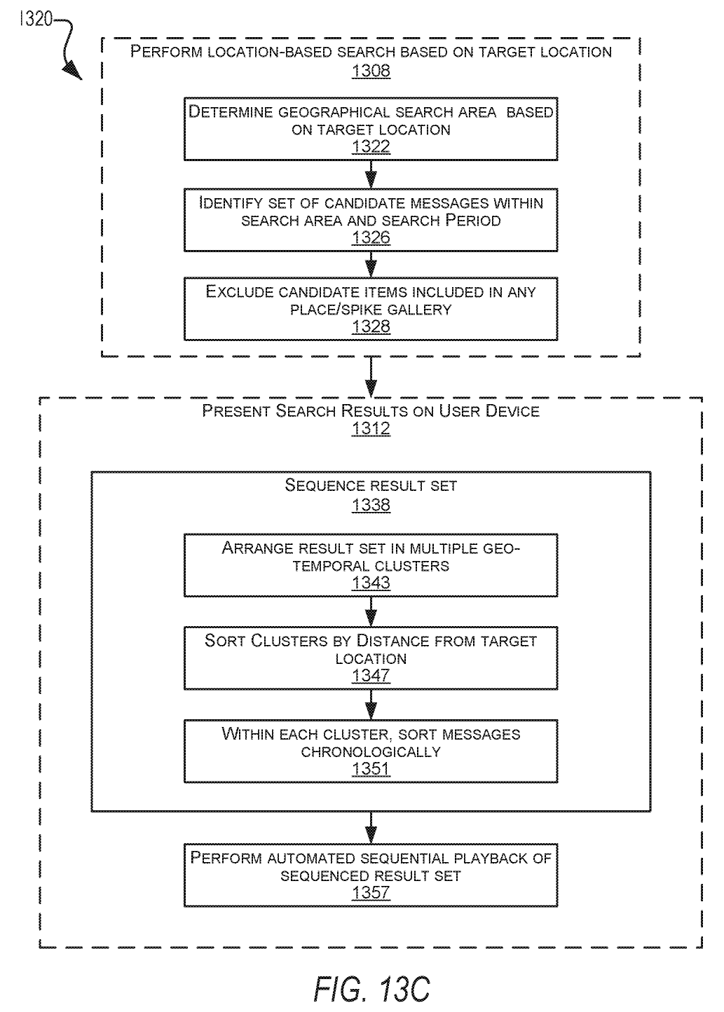

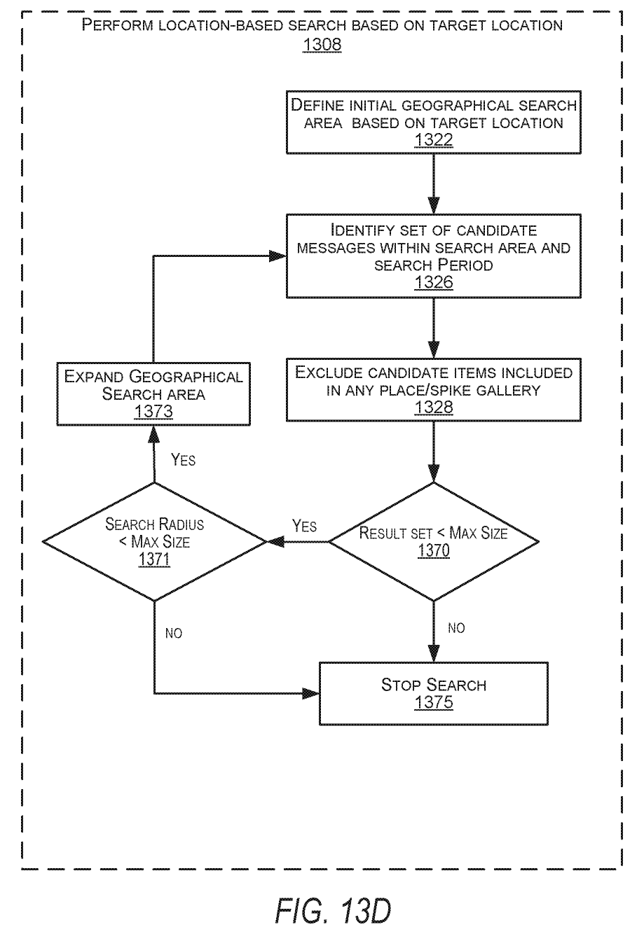

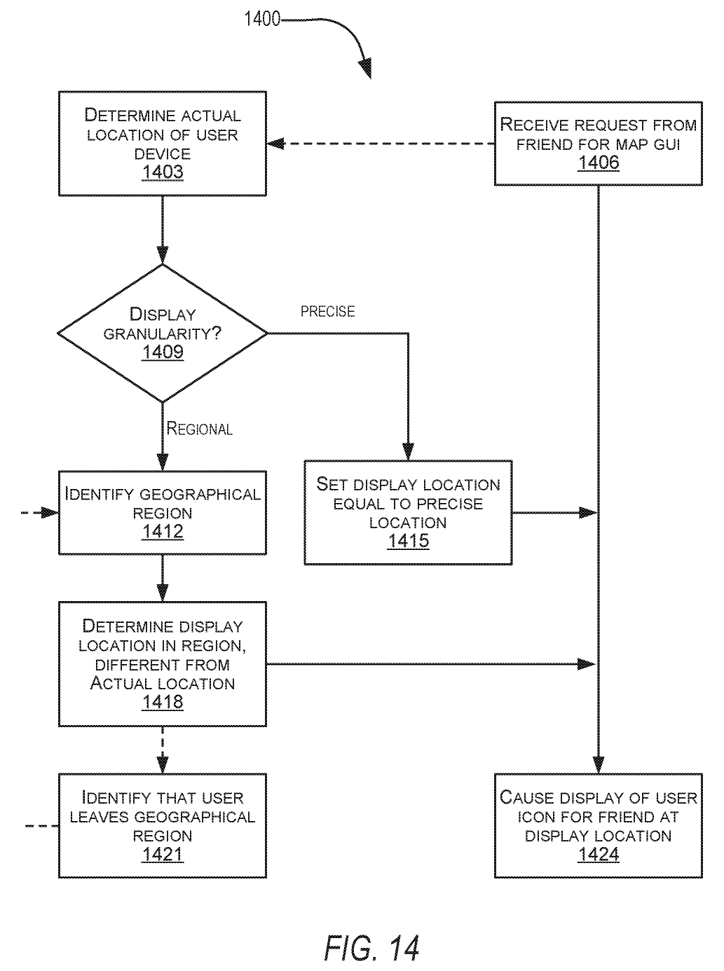

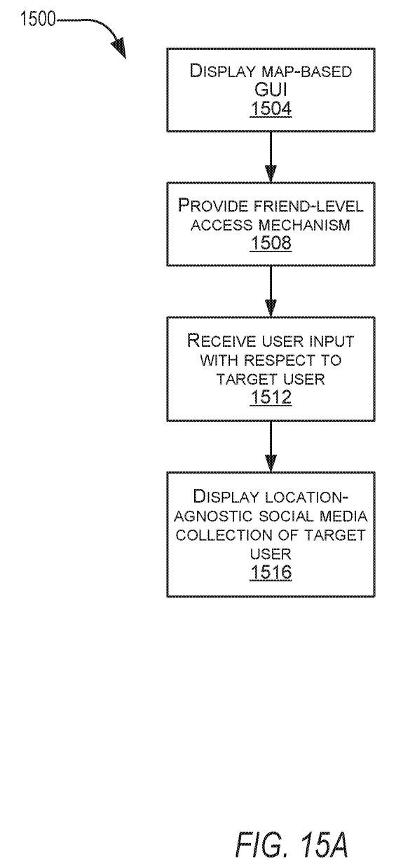

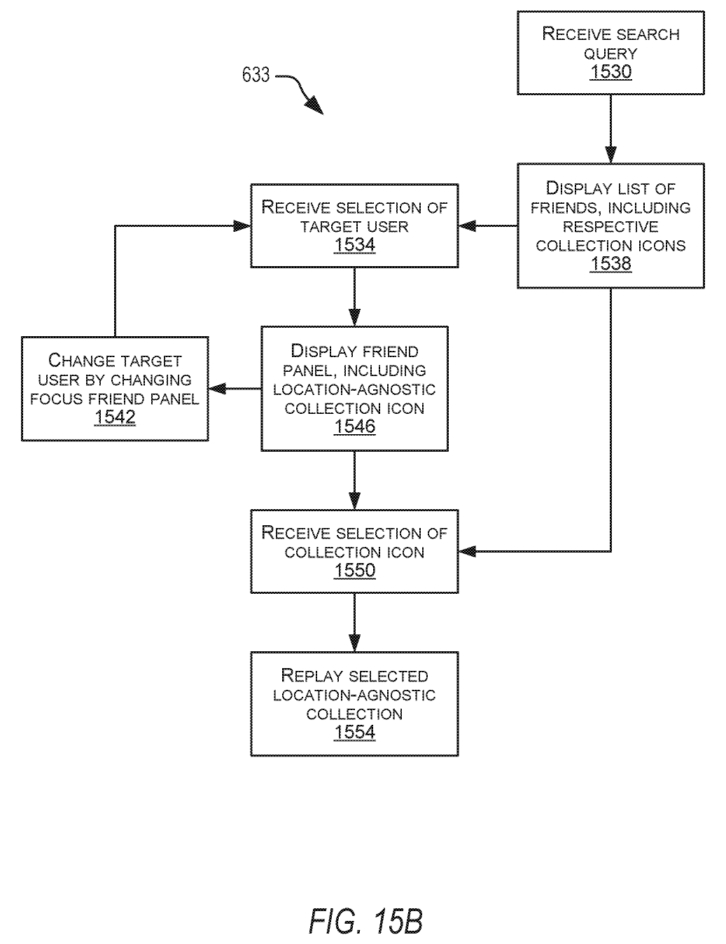

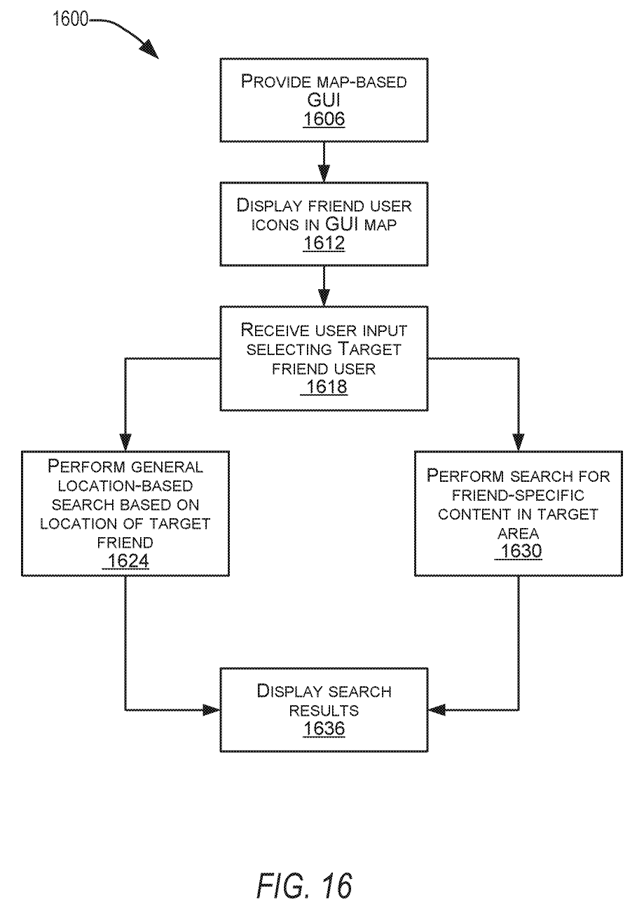

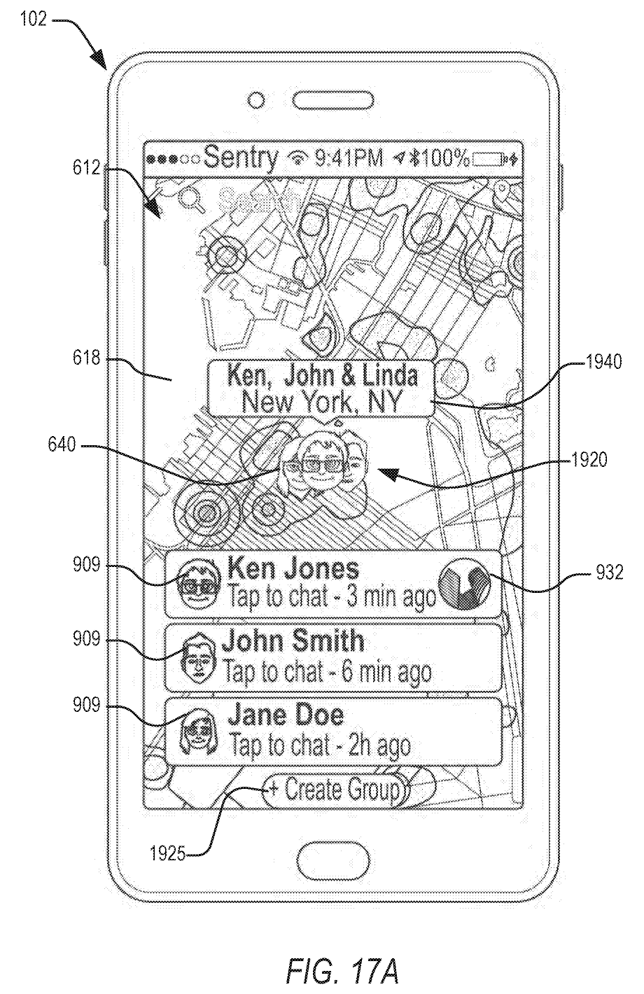

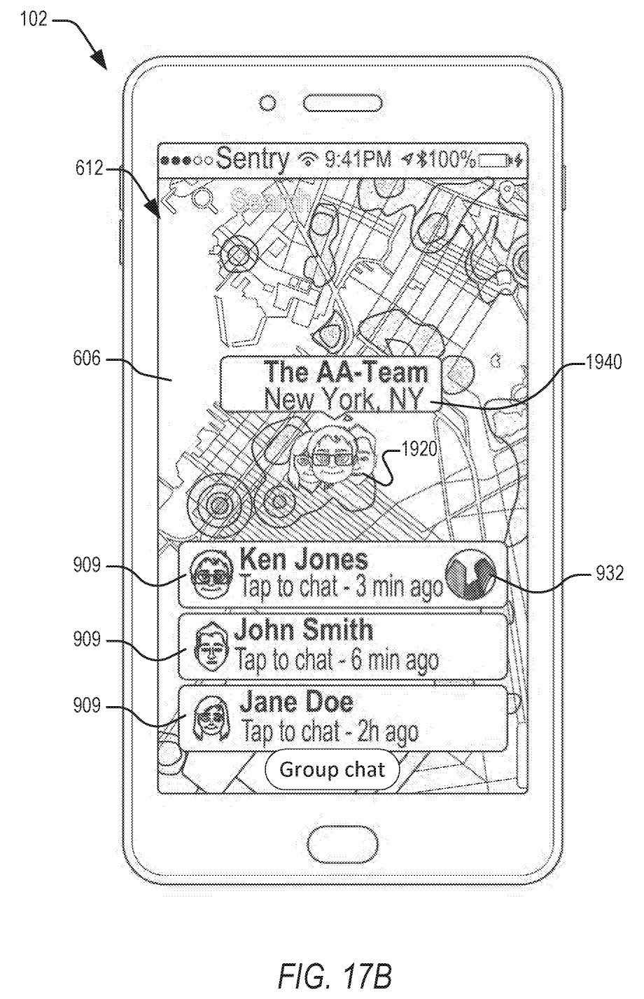

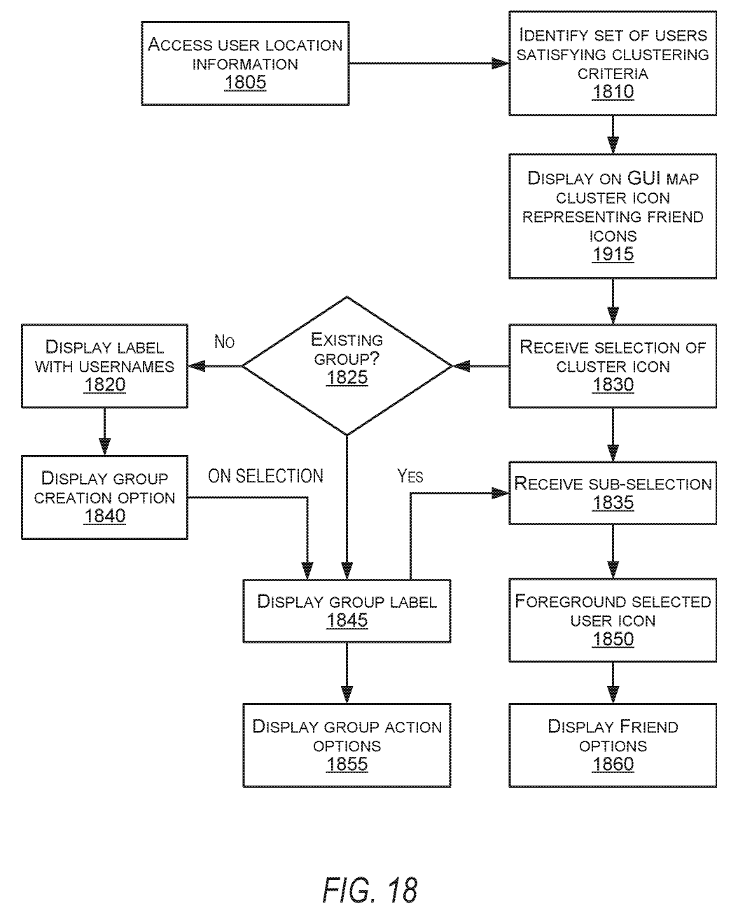

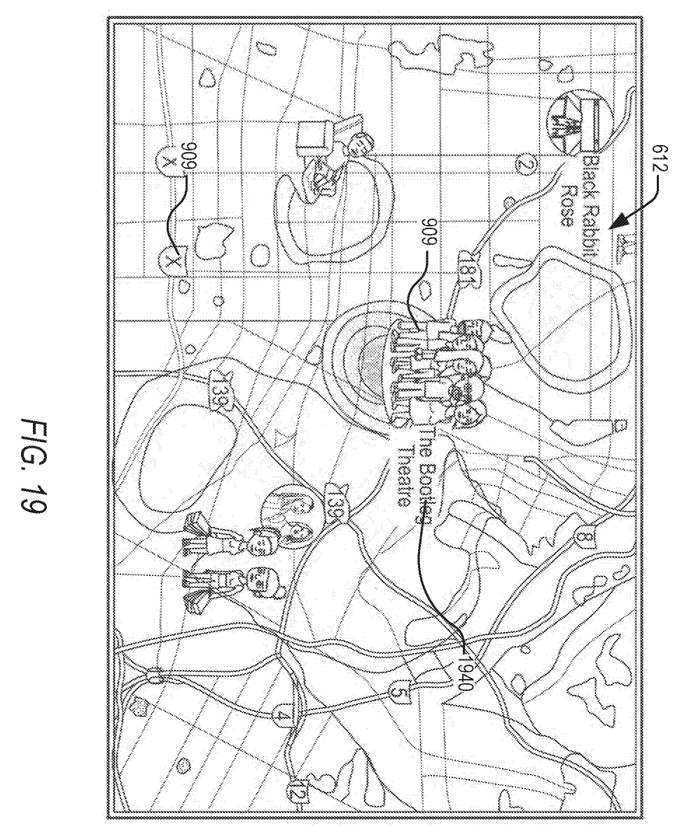

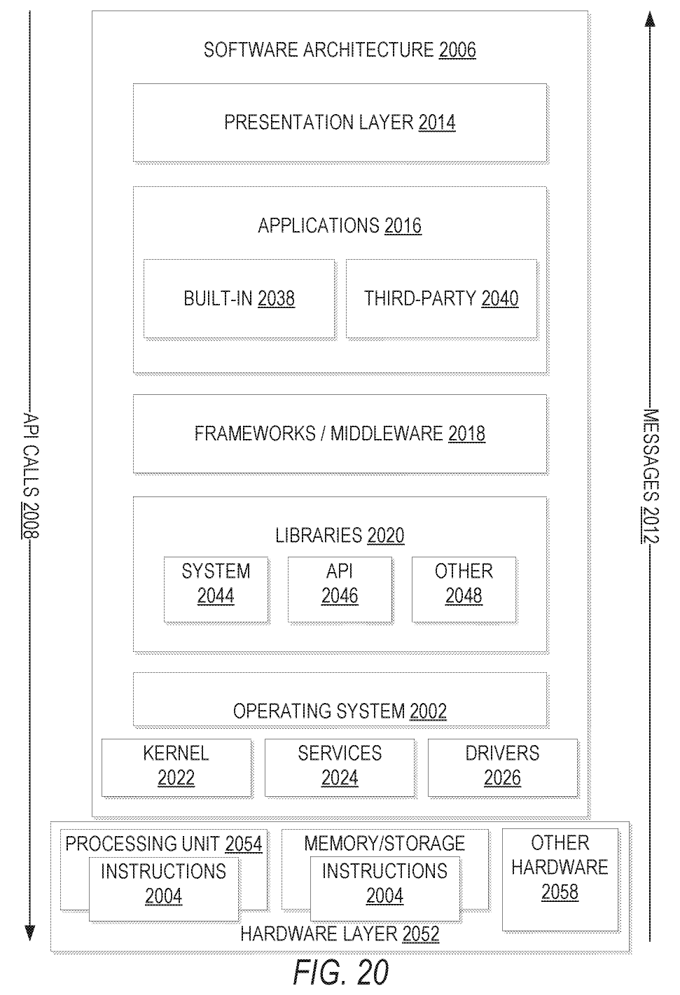

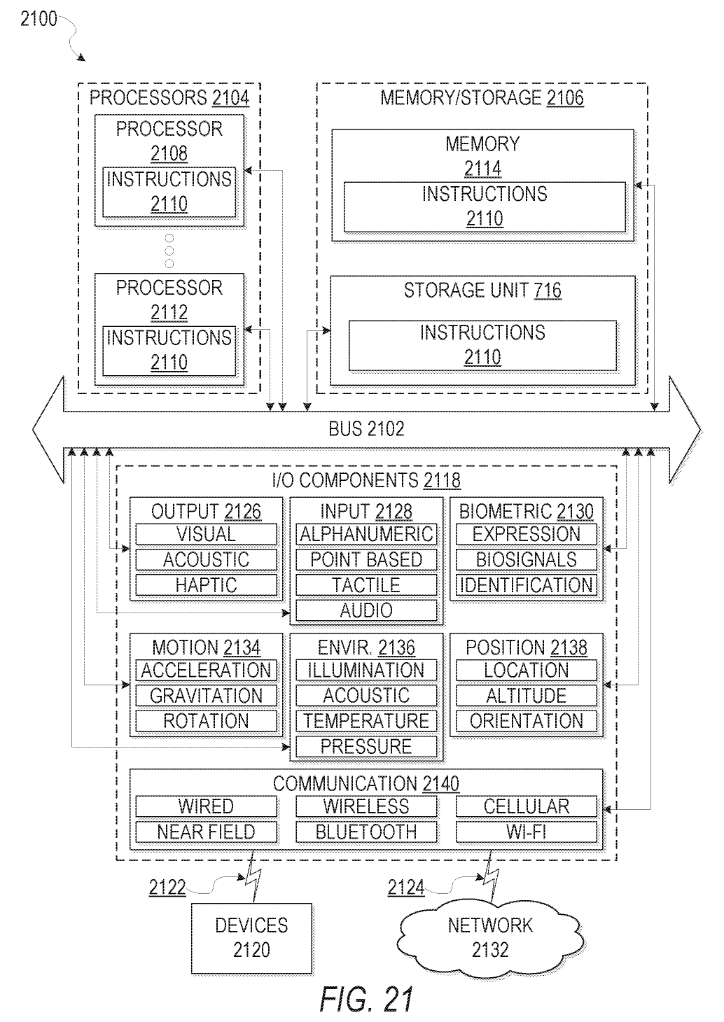

In addition to viewing clustered stories by selection of the story icons 631, 633, the user can access snaps by use of one or more search functionalities provided by the map GUI 612. In this example embodiment, the map GUI 612 provides a number of different search mechanisms through which the user can access targeted social media content, the search mechanisms including:
a search bar 665 (FIG. 6A) that enables the entry of a text string search query to cause display of search results comprising a list of entries satisfying the search query (FIG. 10C);
location-based searches to search for social media content based at least in part on their respective geo-tag information. In some embodiments, these location-based search mechanisms include:
   a location-targeted search triggered by clicking or tapping at a target location on the map 618 (illustrated schematically in FIGS. 11A and 11B); and
   a friend-based location search to locate social media content based at least in part on the location of a selected friend user; and one or more friend-level access mechanisms that provide access to social media content of the selected friend users. In a particular embodiment, these include:
      access to location-agnostic friend content via the user icons, friend carousel 918 and/or individual friend panels 909; and
      location-agnostic collection icons (e.g., Friend Story icons 932, as described below with reference to FIGS. 10A-10C) displayed in association with respective friend users in a list of search results.

### Search Bar Mechanism

Two example embodiments of operation of a search mechanism provided via the search bar 665 is illustrated schematically with reference to FIG. 10A and FIGS. 10B-10D respectively. Discussing first the example embodiment of FIG. 10A, it will be seen that selection of the search bar 665 (FIG. 6A) causes display of a drop-down search interface 1010 that includes a search box 1020 for entering a text-based search query, and a number of lists of suggestions 1030 in respective user interface cells displayed below the search box 1020. In the example embodiments of FIGS. 10B-10D, individual suggestion cells correspond to individual snaps, stories, places, and/or friends. As can be seen with reference to a corresponding screenshot of the search interface 1010 in FIG. 10C, the particular cells displayed as part of the suggestions 1030 are dynamically filtered in response to text entry in the search box 1020, to include only stories, friends, or places that satisfy the entered search query.

When the user clicks on a selected cell in the list of suggestions 1030, the map GUI 612 in this example automatically navigates with a fly-over to the corresponding point on the map 618. If the selected cell is for a spike collection or cluster (also referred elsewhere herein as a spike story), the snaps in the corresponding story starts playing sequentially. If the selected cell is a friend cell, the map viewport 621 navigates to the corresponding friend bitmoji 640, and the associated a friend panel 909 pops up, as the case may be. In the example embodiment of FIG. 10A, at least some aspects of the display search results or suggestions 1030 are location-agnostic, returning search results from any location, without any constraint based on the user current location or the display area of the map 618. In particular, the “My Friends” section of the suggestions 1030 in the embodiment of FIG. 10A includes any friends for whom the user has viewing permission.

Thus, features provided by the search interface 1010 of FIG. 10A include:
Searching for a location anywhere in the world, and navigating to it by selecting the corresponding suggestion cell; and
Viewing, before typing, suggestions 1030 of interesting social media content, and, while or after typing, suggestions that dynamically satisfies the search query. In the example embodiment of FIG. 10A, these include:
   Friends of the user, in section 1032, identified as a “My Friends”;
   Trending place stories, event stories, and/or spike stories or clusters, irrespective of location, identified as “Trending Locations” in section 1034;
   Nearby place stories, event stories, and/or spike stories or clusters, in section 1036, identified as “Popular Nearby.”

Note that the “My Friends” and “Trending Locations” in the example embodiment of FIG. 10A shows friends/content from all over the world, not just friends/content that shows up in your viewport. All friends are shown section 1032 in order of how recently seen. In contrast, the “Popular Nearby” entries have a location restraint, being in this example embodiment limited to stories falling within the area of the current map viewport 621. In other embodiments, the location restraint is based on the user’s current location, as indicated by the client device 102.

The “Trending Locations” and “Popular Nearby” stories are ranked globally according to a metric based on the underlying social media activity, in this example embodiment being ranked according to the number of unique users contributing to a story. In some embodiments, the trending locations may be ranked according to anomality metrics or interestingness scores. In yet further embodiments, surfacing of stories in the search interface 1010 can be based on raw snap volume, snap density over time, rate of increase in snap volume, or the like.

When users click on an entry in the search box dropdown, the map GUI navigates with a fly-over to the corresponding point on the map 618, after which the story/spike cluster starts playing, or friend panel 909 pops up, as the case may be.

Searching functionality available via other example embodiments of the map GUI 612 will now be described with reference to FIGS. 10B-10D. FIGS. 10C and 10D show behavior of the search interface during and after typing by the user in a search box forming part of the search interface 1010. It will appreciated that items listed during and after typing are limited to items (e.g., friends, places, events, or stories) that satisfy the search string entered thus far. Each one of a number of different sections of suggestions 1030, in which respective entries are ranked by priority, will be described separately below. Different embodiments may employ different combinations of these suggestions sections.

FRIENDS ON THE MAP - This section, indicated by reference numeral 1040 in FIG. 10B, shows friends that are that are on the map 618. In this example embodiment, the displayed friends are limited to friends who are visible in the map viewport 621 (i.e., in the geographical area of the map 618 displayed immediately before launching the search interface 1010). In other embodiments, the displayed friends include any friends who are currently available somewhere on the map 618. In this example, the top four friends are listed, followed by a View More button if necessary. The user can tap on a friend cell to locate them on the map 618.

Each friend cell includes, if available, a location-agnostic collection icon in the form of a Friend Story icon 932. Any of the Friend Story icons 932 can be tapped to view the corresponding friend story modally. Viewing of a story comprises sequential replay of the series of snaps included in the story. Each Friend Story icon 932 in this example embodiment comprises a user interface element in the form of a circular thumbnail to the right of the respective friend name. In this example, the stories thus playable include any of the friend’s stories, without regard to any location information that may be associated with the story or with any snaps forming part of the story, thus being in accordance with the disclosed feature of map-based access to location-agnostic social media content of a target friend user. In other embodiments, however, the stories surfaced for replay are limited to those geo-tagged on the current map view.

In addition to the Friend Story icon 932, each friend entry in this example embodiment comprises an associated bitmoji, name, last seen timestamp, and associated location indicator. The listed friends are ordered by update recency.

ALL FRIENDS - This section, identified by reference numeral 1050 in FIG. 10C is similar to the My Friends section 1032 of FIG. 10A, in that it surfaces friends that satisfy the search string, irrespective of whether or not that friend is present on the map. In addition to a My Story icon 832 were available, a user name and a score indicator is shown as subtext for each friend. In this example embodiment, the indicated score is a user score that is used throughout the application to represent a user’s engagement level. In some embodiments, as previously described, tapping on a friend cell navigates the map to focus on the display location of that friend. In this example embodiment, however, tapping on cell launches the chat interface 950 modally (see FIG. 9B). Dismissing the chat brings the user back to the search interface 1010.

TOP STORIES - This section, identified by reference numeral 1042 in the example embodiment of FIG. 10B, showcases the top stories from around the world (selected by curators daily or ranked by quality score or viewer volume).

NEARBY STORIES - This section, identified by reference numeral 1044 in FIG. 10B, shows interesting event clusters nearby or within the viewport. These will be ranked by descending quality score. In some embodiments, the nearby stories can be ranked according to the anomality metric, or according to a ranking score based at least in part on the anomality metric. Thus, it will be seen that some embodiments of the disclosure provide for social media application search interface that automatically surfaces ephemeral galleries based at least in part on geographical proximity between the user device and geolocations associated with the respective galleries. Ranking of the surfaced ephemeral galleries may be based at least in part on respective anomality metrics.

LOCATIONS - This section, identified by reference numeral 1060 in FIG. 10D, shows all points of interest (POIs) or places (as defined by the CMS 1224) that matches the search query. In some embodiments, surfacing and ranking of locations satisfying the search string includes locations with stories available for replay, i.e. having an associated place story. Thus, for example, in the screenshot of FIG. 10D, Blue Lagoon is ranked above Blue Bottle Coffee because it has an associated collaborative story, even though the latter is closer to the location of the user device 102.

If the place has a story, a story icon 1063 in the form of a thumbnail is in this example embodiment shown before the title (see FIG. 10D). Tapping the story icon 1063 (or anywhere in the cell) centers the place on the map and auto-plays the story. If the place does not have a thumbnail, tapping the cell in this example embodiment reverts to the map viewport 621, focusing on the relevant location, without playing any story. Fallback prioritization is by proximity to current viewport (after POIs and/or places with playable stories have been prioritized to the top).

### Location-Based Search Via Target Location on Map

As an alternative to entering a text-based search query, the user can initiate a location-based search by selecting a target location on the map 618 separate from any of the story icons 631, 633, friend bitmojis 640, or any other selectable user interface element overlaid on the map 618. In this manner, the map 618 itself provides an interactive search mechanism. An example embodiment of such a location-based search is illustrated schematically with reference to FIGS. 11A and 11B.

In response to the user’s clicking or tapping on a particular location on the map viewport 621, a search is conducted for social media items within a predefined radius from the click- or tap location. In this example embodiment, such a location-based search does not return a list of graphical user interface elements that are selectable to play respective items, but instead automatically triggers automated sequential replay of items returned as a result of the search.

In the example embodiment of FIG. 11A, selection of a target location 1110 is by haptic contact at the selected on-screen position, consisting of tapping the touchscreen 606 with a single finger 1120 of the user. Thus, tapping on a non-thumbnail place on the map 618 will radiate out a search around the target location 1110, as illustrated schematically in FIG. 11B by a substantially circular geographical search area 1130 centered on the target location 1110. Such a location-based search can have a predefined search radius from the tap location. If any snaps are found in the geographical search area 1130, they are automatically played back in sequence, as described before. If there are no snaps in that area, the search bounces back to show no results found.

In some embodiments, such a location-based search is dynamically restrained by a predefined search limit, so that the size of the geographical search area 1130 can be variable in different instances. In some embodiments, the search limit for a location-based search is a predefined maximum size defined by the number of snaps located in the search. In an example embodiment, the geographical search area 1130 will thus radiate out from the target location 1110 to a point where a predefined maximum number of snaps are found, after which all snaps from that area will start playing in sequence. Worded differently, a predefined search metric or limit is provided in some embodiments to determine when the search should be stopped. As mentioned, the search limit may be an upper limit to the number of snaps located, with the search radiating out no further from the target location once the number of snaps located reaches the upper limit. Thus, it will be seen that different location-based searches can return snaps from geographical search areas 1130 that differ in size, depending on the density of snaps in the vicinity of the target location 1110.

In some example embodiments, such a location-triggered social media content search (i.e., a search for social media content uploaded by other users triggered by a user click/tap at the target location 1110 that does not coincide with a story icon 631/633 or friend bitmoji 640) can be configured automatically to exclude social media items included in one or more of the clustered collections represented by respective icons 631, 633 on the map. Thus, in this embodiment, the social media application will not include in search results or replay any snaps that are included in any of the place stories or any of the spike stories on the map.

As mentioned, initiating a location-based search by clicking or tapping on a non-thumbnail area in this example embodiment triggers automatic replay of snaps located within a geographical search area 1130 centered on the target location 1110. In other embodiments, such a search input by target location selection may cause display of a graphical user interface element listing the snaps found within the search area, for example including a thumbnail and username for each found snap. The user can thereafter select from the list of found snaps those which are to be replayed.

In some embodiments, the snaps located in a location-based search are played back in chronological sequence, as indicated by respective timestamp data indicating when the corresponding snap was uploaded. In some example embodiments, a sequencing operation may be performed on the subset of snaps identified in a location-based search, so that the replay sequence does not strictly follow chronological sequence. In one example embodiment, an improved sequence for media playback in response to a user tap on the map viewport is achieved by a sequence of operations comprising (a) finding all snaps in a fixed radius of the tap point, (b) doing geo-temporal clustering of those snaps, (c) sorting those clusters by distance from tap, and (d) sorting within the clusters by time.

In some embodiments, the location-based search is by default performed for material uploaded within a predefined default time period. For example, the location-based search may identify all snaps that (a) are located within the geographical search area 1130; (b) are not included in any story represented by a corresponding story icon 631/633; and (c) have timestamps within a default preceding ephemeral timespan. Thus, in an example embodiment in which a snap is by default available for 24 hours via the map GUI 612, the location-based search may by default locate snaps having timestamps indicating upload dates within the past 24 hours.

In some embodiments, however, the preceding period with respect to which the search is performed is selectively variable by the user. For example, the search period timespan is automatically variable in response to an interval for which a search input gesture or signal is provided by the user.

In embodiments in which the map GUI 612 is displayed on a touchscreen 606 (as is the case in the example embodiment of FIGS. 11A and 11B), a geo-temporal search is triggered by haptic contact at a particular location within the map 618, with the search being geographically centered on a target location 1110 defined by the on-screen position of the haptic contact. In some embodiments, an input interval indicated by the time period for which the haptic contact is maintained with the touchscreen 606 automatically determines the preceding timespan with respect to which the search is carried out. In such a case, for example, a tap on the screen triggers a geo-temporal search for material within the default time period, while a press and hold automatically triggers a geo-temporal search for material within an extended time period which is longer than the default time period. In one example embodiment, a tap input triggers a geo-temporal search with a 12-hour timespan, while a tap and hold triggers a geo-temporal search with a 24-hour timespan. In other embodiments, the extended timespan is variable in graduated fashion, so that multiple different search timespans are selectable based on the press-and-hold interval. Note that the operations described with reference to the haptic contact on the touchscreen 606 can be performed analogously by a click-and-hold input in instances where user input is provided by a cursor control mechanism, such as a mouse.

Instead, or in addition, the search radius (i.e., the size of the geographical search area 1130) may be variable based on the length of the input interval, with longer input intervals (e.g., a longer hold period) corresponding to a larger search radius.

### Location-Based Searching via Friend Location or for Friend Content

Some embodiments of the map GUI 612 provide functionalities for searching for social media content with a location restraint based at least in part on a location attribute of the selected friend user. The location restraint may, for example, operate to limit the search to social media content geo-tagged within a predefined geographic range centered on a geographic location of the selected friend user.

For example, the user can in some example embodiments trigger a location-based search with a location constraint based on the location of a selected friend user. In one example embodiment, such a location-based search with respect to a particular friend location can be performed in a manner analogous to that described below with respect to a general location-based search as described with reference to FIGS. 11A, 11B and 13A-13D. The various considerations and features discussed for general location-based searching can thus in some example embodiments apply, mutatis mutandis, to location-based searching based on friend location.

In one example embodiment, a friend-targeted location-based search can be triggered by user interaction with the friend icon or bitmoji 640 of a target friend user. In such an example embodiment, a click or tap input on the bitmoji 640 surfaces a menu or friend panel 909, while a press-and-hold input or a click-and-hold input automatically triggers a location-based search such as that previously described, the search area being centered on the location of the selected user. Instead, or in addition, a menu or friend panel 909 launched responsive to selection of the bitmoji 640 in some embodiments include a selectable user interface element to trigger a search for social media content targeted with a location constraint defined with respect to the location of the selected user.

In some embodiments, the friend-based social media content search additionally has an owner constraint such that the search results are limited to social media items of the selected friend user. In other embodiments or instances, the friend-based social media content search may search for content including but not limited to that uploaded or provided by the selected friend user.

Other example embodiments in which social media content searches via the map GUI 612 has a location constraint based on a selected friend user’s location include instances where (while map focus is on a selected user) search results are limited to items currently displayed in the map viewport 621. The result section 1030 in the embodiment of FIG. 10B provides one such example. In other instances, the map GUI 612 provides for the option of searching for content exclusively contributed by a selected target user. Responsive to triggering such a friend-specific search, the user can change the focus and/or zoom level of the map viewport 621, with social media items surfaced in the map viewport 621 being limited to social media content posted by the target friend user.

As described with reference to some example embodiments herein, a social media application executing on the user device in some embodiments generates a map GUI having a map viewport on which displayed geographic locations of at least some friend users may differ from the actual geographic locations of those users. In some embodiments, the friend-centered location-based social media content search may be centered on the actual geographic location of the selected friend user, being distinct from a displayed location of the selected friend user on the map GUI. In other embodiments, the search may be performed with reference to the displayed location of the selected friend user.

### Overview of Map GUI Functionality

In use, the map GUI 612 thus surfaces different types of location-based stories, which the user can view from the map 618. In the example embodiment of FIGS. 6A and 6B, the user can access via the map GUI 612 snaps posted to Our Story from anywhere in the world. This can be achieved by navigating to different geographical areas displayed within the map viewport 621. In particular, the displayed geographical area can be changed by zooming in or zooming out, and by moving the focus area of the map viewport 621. In the example embodiment of FIGS. 6A and 6B, in which the map GUI 612 is provided on a touchscreen 606, zooming in and zooming out can be achieved by haptic gestures in the form of a pinch-out or a pinch-in haptic input. Movement of the map 618 within the map viewport 621, so as to change the displayed geographical area, is achieved by a haptic dragging gesture at any point on the map 618.

In this example embodiment, the map 618 is not selectively rotatable by the user, having a fixed default orientation relative to the touchscreen 606. In other embodiments, the map 618 may have a fixed orientation relative to the Earth. In some embodiments, the map 618 is selectively rotatable, e.g., with all map content rotating around a fixed anchor.

As discussed at length above, in any particular map viewport 621, the displayed information can include:
the color-coded heatmap 625, visually displaying the geographical distribution of snap uploading activity within a preceding window (for example the default snap lifetime, in this example 24 hours), allowing the user readily to identify places with more or less activity. This enables the user more effectively to target location-based searches via the map GUI 612. In some embodiments, the color-coded heatmap 625 is shown only at a highest level of magnification. In this example embodiment, however, the color-coded heatmap 625 is rendered at all zoom levels.
Thumbnail icons 631, 633 for surfaced content forming part of ephemeral galleries or stories. As described previously, these include in this example embodiment place icons 631 for geo-anchored stories associated with particular labeled locations, and spike icons 633 for location-based stories surfaced based on anomalous levels of geo-spatial activity.
Friend bitmojis 640 of friend users most frequently contacted by the user who is logged in to the social media client application 104 executing on the client device 102 and by which the map GUI 612 is generated.

In some embodiments, no spike icons 633 are shown at some levels of magnification. In a particular example embodiment, no spike icons 633 are shown at the original zoom level at which the map GUI 612 loads by default. In such an example, only the heatmap 625, friend bitmojis 640, and a number of place icons 631 are displayed on the map 618 at the original zoom level. As the user zooms in, spike icons 633 are surfaced, representing respective clusters of activity.

It will be appreciated that different icons 631, 633 are surfaced at different zoom levels. In this example embodiment, the map GUI 612 displays no more than a predefined maximum number of place icons 631 and no more than a predefined maximum number of spike icons 633 in any particular view. For example, at any zoom level, the top three place stories (ranked by snap volume) are surfaced by displaying respective place icons 631 in the map viewport 621. Likewise, at any zoom level, the top three spike stories (ranked by anomality or unusualness metric value) are surfaced by displaying respective spike icons 633 in the map viewport 621.

In addition to viewing stories surfaced in the map 618 by respective story icons 631, 633, the user can use one or more of the search functionalities described above to access any snap uploaded to Our Story and whose gallery participation timer or availability lifetime has not yet expired.

It will be appreciated that the map GUI 612 is dynamic, in that the information displayed therein changes dynamically with time. New snaps may continually be uploaded to Our Story, while the underlying social media items upon which surfacing of the story icons 631, 633 and generation of the heatmap 625 is based can further continually change due to the expiration of the availability of snaps. In this example embodiment, however, the information displayed in the map viewport 621 is not dynamically updated during display of any particular geographical area. Instead, changing of the focus of the map viewport 621 is associated with receiving updated information with respect to the story icons 631, 633 and heatmap 625 from the application server 112.

It is a benefit of the map GUI 612 as described with the example embodiments that it provides for user-friendly and intuitive interaction with geographically distributed social media content. The provision of different types of social media galleries (e.g., represented respectively by spike icons 633 and place icons 631) provides a system that automatically surfaces only content which is most relevant for user-selection in such a manner that the very large number of individual social media items that may be available via a social media platform is reduced in complexity, and that allows selection of targeted content in which the user might be interested.

### EXAMPLE SYSTEM

FIG. 12 shows an example embodiment of a social media platform system 1200 configured to provide a map-based graphical user interface for a social media application, such as the map GUI 612 described with reference to FIGS. 6A-11B. The system 1200 and its associated components can in some embodiments be provided server-side, for example by the social media application server system 108 (FIG. 1). In such instances, the respective components of the system 1200 can be provided by execution of the social media server application 114 on the application server 112. In other embodiments, one or more components of the system 1200 are provided client-side, for example by execution of the social media client application 104 on a respective client device 102 (FIG. 1). In yet further embodiments, the system 1200 is provided collaboratively server-side and client-side, the application server 112 and a client device 102 in communication therewith being configured to provide the respective system components by execution of the social media client application 104 on the client device 102 and by execution of the social media server application 114 on the application server 112.

The system 1200 includes a map engine 1208 to generate the map GUI 612, including the location-based social media information displayed in the map GUI 612. Thus, the map engine 1208 is configured to generate or to facilitate generation of the map 618 (FIG. 6A) in the map viewport 621 of the client device 102. To this end, the map engine 1208 can be configured to surface and cause display of particular story icons 631, 633, to identify and cause display of respective friend bitmojis 640, to generate heatmap information and display or cause display of a heatmap 625 overlaid on the map 618, and to perform operations that provide other related functionalities of the map GUI 612 described with reference to FIGS. 6A-11B.

The system 1200 further includes a replay mechanism 1216 configured to cause automated sequential replay of the content of a set of social media items or snaps on the client device 102. The replay mechanism 1216 can thus cause sequential display of all of the snaps in a selected place story or spike story, as described previously herein. In some embodiments, the replay mechanism 1216 may provide for transmission of the set of snaps to the client device 102 in response to selection of a corresponding story icon 631/633. In some such embodiments, information automatically transmitted by the application server 112 to the client device 102 upon initial rendering of a map view in the map GUI 612 can include a first few (e.g., 2 or 3) snaps for each of the story icons 631, 633 surfaced in the map viewport 621. Upon selection of a particular story icon 631/633, the first few snaps in the story are immediately available for replay, with the subsequent snaps in the story being pulled from the application server 112 during presentation of the first few snaps.

The system 1200 also includes a content management system (CMS) 1224, as mentioned earlier. In this example embodiment, the CMS 1224 provides an administration interface enabling operators to manage content, for example by defining various attributes of different place and/or event stories. The CMS 1224 in this example embodiment also includes the collection management system 204 (FIG. 2) as previously described. The CMS 1224 is configured for the automated or semiautomated compilation of the respective social media galleries or stories as previously described. This may include curation or moderation of respective stories by use of a server-side curation interface 208 provided by the CMS 1224.

The system 1200 further includes a search engine 1233 configured to provide search functionalities with respect to social media content via the map GUI 612. In particular, the search engine 1233 in this example embodiment provides for user-directed searching both via the search interface 1010 (FIGS. 10A-10D) and via location-based searching by direct selection of a target location on the map 618 (FIGS. 11A-11B). Automated operations which the search engine 1233 is configured or programmed to perform in some example embodiments are described in greater detail below with reference to the flowcharts of FIGS. 13A-13D.

The system 1200 further includes a user location mechanism 1237 configured to determine respective user locations, in this example embodiment indicated by the respective device locations, to determine for each user the particular friend users who are viewable via the map GUI 612, and to provide for display of associated user icons at corresponding display locations. The user location mechanism 1237 in some embodiments comprise, as part of the server system 108, a user location datastore and an per-user access control list (ACL) that lists the particular friend users viewable by each user. In some embodiments, the per-user ACL specifies respective viewing level granularity for each viewable user. The user location mechanism 1237 in such example embodiments is additionally configured to determine and manage respective user display granularity. This includes calculating non-precise display locations for some users, and causing display of a corresponding user icons at the non-precise display locations.

### EXAMPLE METHODS

The example methods that follow are in the respective embodiments executed using system 1200 as described with reference to FIG. 12, employing the system architecture and environment described with reference to FIGS. 1-5. Different parts of the description, and different associated flowcharts, focus on different respective aspects of the various functionalities described with reference to the example map GUI 612 of FIGS. 6A-11B. For avoidance of repetition, not all of the different operations previously described are repeated in the respective flowcharts and associated method descriptions. The various operations that provide respective functionalities described with reference to the example map GUI 612 of FIGS. 6A-11B are, however, to be read as forming part of the respective methods, except where clearly not applicable.

### Location-Based Searching with Variable Search Period

FIG. 13A is a schematic flow chart illustrating a high-level view of a method 1300 of providing a map-based GUI for a social media application, according to an example embodiment, including the functionality of location-based searching.

At operation 1302, the map engine 1208 effects display of the map GUI 612 on the client device 102. This can comprise compiling location-based social media galleries by identifying the respective set of snaps that are included in each of multiple stories or galleries viewable via the map GUI 612. Note that in this description the superset of snaps or social media items that are publicly viewable via the map GUI 612 (e.g., all of the snaps uploaded to Our Story) is used as an overarching gallery, with operations performed by the CMS 1224 (such as managing respective gallery participation timers for the multiple snaps) in some instances applying also to snaps that are not included in any story replayable by user-selection of a corresponding story icon 631/633.

The display of the map GUI 612, at operation 1302, is triggered by receiving a request for map display via the map GUI 612. Thus, for example, an initial loading of the social media client application 104 on the client device 102 in some embodiments automatically requests map information for a geographical area centered on the user’s current location at a default magnification level. Likewise, when the user changes the geographical area to be displayed in the map viewport 621 (e.g., by changing the magnification level and/or by changing the centerpoint of the map 618), a request for corresponding map information is issued.

In response to the request for map display information, the map engine 1208 in an automated operation identifies the particular social media galleries that are to be surfaced in the requested map view by displaying respective story icons 631, 633 on the map 618. In this example embodiment, as described previously, a number of spike stories are identified for surfacing based on previously calculated respective anomality metric values, and a number of place stories are identified for surfacing based on snap volume.

The map engine 1208 causes display in the map GUI 612 of respective story icons 631, 633 for each gallery or story identified for surfacing. In this example embodiment, the application server 112 communicates to the client device 102 gallery information in the form of respective story manifests that provide information necessary for displaying the respective story icons 631, 633. For example, the application server 112 can provide, for each of the surfaced stories, a location of the corresponding story icon 631/633, an indicator of the type of story icon (e.g., whether it is a place icon 631 or a spike icon 633), a name or label of the story (if any), a thumbnail image for inclusion in the respective story icon 631/633, and a list of snaps forming part of the corresponding story. In some embodiments, as discussed previously, such gallery information may include the payload of a first few of the snaps, to enable immediate commencement of story playback in response to user selection. Based on the gallery information thus received, the client device 102 generates the requested map view in the map GUI 612, in some instances including display of a plurality of place icons 631 and a plurality of spike icons 633 at different respective locations on the map 618.

At operation 1304, a location-based search query is received via the map GUI 612, user input indicating a location-based search query. In this example embodiment, the user input comprises user engagement with a feature of the map GUI 612 for a certain engagement duration. In instances where the map GUI 612 is rendered on the touchscreen 606 (FIG. 6A) receptive to haptic input, the user engagement to trigger a location-based search query comprises haptic input in the form of a manual tap or press-and-hold operation at the user-selected target location 1110, as illustrated schematically in FIG. 11A.

At operation 1306, the search engine 1233 automatically determines a search period with respect to which the location-based search is to be conducted, the value of the search period being variable depending on the length of the engagement duration for which the user input is maintained. As discussed with reference to the description of FIG. 11, the search period indicates a length of preceding time with respect to which the social media content search is performed.

Turning briefly to FIG. 13B, therein is shown a flowchart of an example procedure 1306 for determining the search period. First, the engagement duration of the user input is identified, at operation 1314. In this example embodiment, the engagement duration is the interval for which the user maintains contact with the touchscreen 606 at the target location (FIG. 11A).

In this example embodiment, a default search period is applied if the engagement duration a shorter than a predefined threshold duration, in this instance being 0.5 seconds. It will be appreciated that different threshold durations can be used in different embodiments. Thus, at operation 1315, it is determined whether or not the engagement duration is greater than the threshold duration. If not, the search period is set to the default search period, at operation 1316. In the present example embodiment, the default search period is 12 hours. Thus, a tap input at the target location 1110 will trigger a location-based search for snaps respective timestamp information falling within the preceding 12 hours.

If, however, it is determined, at operation 1315, that the engagement duration is greater than a threshold duration, then the search period is set to a time window greater than the default search period. In some embodiments, search period variation is binary, in that any engagement duration longer than the threshold duration triggers a consistent search period. In one such embodiment, a tap input triggers a 6 hour search period, while a press-and-hold input (e.g., held for longer than 0.5 seconds) invariably triggers a search period of 12 hours.

In this example embodiment, however, the search period progressively increases with an increase in an excess interval, being the time interval for which the user input is maintained past the threshold duration. Thus, at operation 1317, the search engine 1233 identifies the excess interval, and then determines and sets the extended search period based on the identified excess interval. In this example embodiment progressive increase in the extended search period is stepwise, for example providing for a 2 hour increase in the search period for every 0.25 second increase in the excess interval.

Returning now to FIG. 13A, a location-based search for social media content is performed based on the user-selected target location 1110 and search period is performed, at operation 1308, identifying a set of social media items (in this example embodiment, ephemeral messages in the form of snaps) lying within a geographical search area 1130 centered on the target location 1110 and having timestamp information falling within the search period. Two alternative example embodiments for the operation of performing the location-based search, at operation 1308, will be described below with reference to FIG. 13C and FIG. 13D, respectively.

At operation 1312, the search results provided by the location-based search are presented on the client device 102. In the present example embodiment, such presentation of the search results comprises automated sequential replay of the snaps included in the search result set. In one example, the snaps are played back in chronological sequence based on respective timestamps, with the earliest snap being played first. In other embodiments, presentation of the search results, at operation 1312, can comprise displaying the snaps in the search result set as a list of selectable user interface elements.

Turning now to FIG. 13C, therein is shown a flowchart 1320 illustrating one example embodiment of procedures for performing the location-based search, at operation 1308 in the method 1300 of FIG. 13A, and performing the presentation of search results on the client device 102, at operation 1312 in the method 1300 of FIG. 13A.

In the example embodiment of FIG. 13C, the location-based search (operation 1308) is performed with respect to a static geographical search area 1130 (FIG. 11B) of predetermined size. Thus, in response to user selection of the target location 1110, the geographical search area 1130 is determined, at operation 1322, by defining a substantially circular geographical area centered on the target location 1110. The geographical search area 1130 is thus defined as including all the locations lying within a predetermined radius of the target location 1110.

At operation 1326, a set of candidate messages/snaps is identified as consisting of all publicly viewable ephemeral messages (in this example embodiment being snaps uploaded to Our Story) having geotag data indicating a respective location falling within the geographical search area 1130. The set of candidate messages is further limited to snaps having timestamp data indicating a respective submission time falling within the relevant search period. In some example embodiments, a consistent predetermined search period applies, e.g., being equal to the default availability lifetime (also referred to herein as the “gallery participation timer” or “story participation timer”) of snaps uploaded to the social media application. Thus, in one example where snaps uploaded to Our Story are by default available for viewing for a period of 24 hours, the search timespan is 24 hours. In this example embodiment, the search period is dynamically variable based on the engagement duration of the user input, as described with reference to FIG. 13B.

At operation 1328, the set of candidate snaps identified based on geo-tag data and timestamp data is filtered by excluding therefrom all snaps that are included in any one of the place stories or the spike stories represented in the map GUI 612 by respective story icons 631, 633. The filtered set of candidate snaps provides the search result set.

In the example embodiment of FIG. 13C, presentation of the search results on the client device 102 (operation 1312) comprises sequencing the result set, at operation 1338, to arrange the snaps in the search result set in an order that is not strictly chronological, and thereafter, at operation 1357, performing automated sequential playback of the snaps in the search result set in the identified sequence.

The sequencing procedure (operation 1338) in this example embodiment comprises, at operation 1343, clustering the snaps in the search result set into multiple geo-temporal clusters. In some embodiments, the geo-temporal clustering may be based exclusively on location (as indicated by geo-tag data), so that the clusters are purely geographical clusters. In this example embodiment, however, the clustering is geo-temporal in that the snaps are clustered based on a combination of geographic location and timestamp. To this end, a clustering metric is defined as a geo-temporal distance that quantifies a “distance” between snaps in time and space. The snaps are thus clustered based on their geo-temporal proximity.

At operation 1347, the respective clusters of snaps are sorted by distance from the target location 1110. In particular, the clusters are ordered such that clusters closer to the target location 1110 are earlier in the sequence than clusters that are further from the target location 1110. At operation 1351, the snaps within each cluster are sorted by timestamp, such that earlier snaps are located earlier in the sequence.

At operation 1357, automated sequential playback of the snaps in the search result set is performed based on the sequence identified at operation 1338.

FIG. 13D shows a schematic flow chart illustrating operations forming part of a procedure for performing a location-based search based on a user-selected target location, at operation 1308 in the example method 1300 of FIG. 13A. In the example embodiment of FIG. 13C, the location-based search is performed based on a dynamic geographical search area 1130 which progressively grows in size until a predefined number of snaps are located for playback, or until the geographical search area 1130 reaches a maximum size.

In response to user input of the search query by selecting the target location 1110, operations 1322, 1326, and 1328 initially proceed similarly to like-numbered operations described in the example embodiment of FIG. 13B, with an initial geographical search area 1130 being defined at operation 1322 to have a predefined initial radius. At operation 1370, the search engine 1233 determines whether or not the number of snaps in the current search result set is smaller than a predefined maximum size. For example, the predefined maximum size may be 20 snaps, so that the location-based search in no instance returns a search result set greater than 20 snaps. If it is determined, at operation 1370, that the search result set is equal to or greater than the predefined maximum size, the search is stopped, at operation 1375.

Otherwise, however, it is determined, at operation 1371, whether or not the geographical search area 1130 has a radius smaller than a predefined maximum size. Of course, at the first iteration of the process, the geographical search area 1130 will be found to be smaller than the maximum size. In some embodiments, the maximum size of the geographical search area 1130 is defined in terms of actual geographical size. In this embodiment, however, the maximum size of the geographical search area 1130 is defined based on on-screen size. The geographical search area 1130 thus has a consistent maximum on-screen size, irrespective of the magnification level of the map 618.

If it is determined, at operation 1371, that the geographical search area 1130 is equal to or larger than the predefined maximum size, the search is stopped, at operation 1375. If, however, it is determined, at operation 1371, that the geographical search area 1130 is smaller than the maximum size, the geographical search area 1130 is expanded, at operation 1373, and further compilation of the search result set is performed at operations 1326 and 1328 based on the expanded geographical search area 1130.

It will thus be seen that, consistent with the example embodiment of FIG. 13C, ephemeral snaps available for public viewing and not included in any of the replayable stories represented by story icons 631, 633 are identified with respect to a progressively growing geographical search area 1130 until the search result set reaches a maximum size, or until the geographical search area 1130 reaches a maximum size, whichever occurs first.

### Friend Location Display at Non-Precise Regional Granularity

FIG. 14 is a schematic flow chart illustrating a method 1400 for providing a map-based GUI for a social media application, according to an example embodiment, the map-based GUI allowing display of friend user locations at a non-precise location within a defined geographical area, as described previously with reference to FIGS. 8A-8C.

At operation 1406, a request is received from the client device 102 for display of a particular geographical area in the map viewport 621. In response, the user location mechanism 1237 of the system 1200 causes display, at operation 1424, of the map GUI 612 on the user device 102, including display of respective user icons (in this example embodiment in the form of bitmojis 640) at respective on-screen display locations for each friend user whose display location falls within the focus area of the map viewport 621.

In this example embodiment, respective display locations for users are on an ongoing basis calculated or determined by the server system 108. Responsive to the view request, at operation 1406, the server system 108 in such instances serves for each friend user geographical coordinates indicating a respective display location. Instead or in addition (as illustrated schematically by the dotted line connecting operations 1406 and 1403), determining of a respective display location is in some embodiments triggered by the view request from the client device 102, at operation 1406. In instances where the display location is determined server-side a benefit is that the display location will be consistent across user devices 102 for users viewing the location at the same granularity level.

In some embodiments, the display location is determined client-side, with the server system 108 serving to the client device 102 the actual location for each friend together with an indication of the display granularity level, with an operation performed by the social media client application determining the non-precise display location.

At operation 1403, a precise location associated with a particular friend user is determined based on an actual location of the user device 102 (as indicated by its location services) associated with that friend user.

At operation 1409, the applicable display granularity level for a particular user is determined. In this example embodiment, a binary granularity scheme is provided, in which the user is viewed either at a precise location or at city-level (being a particular instance of a regional level as referred to in the drawings and elsewhere herein). The specific defined geographical region within which the user’s bitmoji 640 is to be displayed is thus in this example embodiment the particular city or town within the user’s actual location is situated. As discussed, other example embodiments may provide for a greater number of different stratified granular view levels, in which case the determining operation of 1409 serves to identify the particular applicable level of granularity.

If it is determined, at operation 1409, that the particular friend user allows the requesting user to view their precise location, the display location for that user is, at operation 1415, set to equal the actual location associated with that friend user.

If, however, it is determined that the particular friend user allows the requesting user to view their location at regional level, the specific geographical region (e.g., in this example the specific city/town) in which the user is located is determined, at operation 1412.

At operation 1418, a non-precise regional display location is determined for the particular friend user, such that the display location differs from the actual location of the friend’s user device 102, but such that the display location is situated within the identified geographic location. In this example embodiment, a random location within the applicable city is generated as display location. In other embodiments, the display location is determined in a partially random procedure, for example having a probability distribution centered on the user’s actual location. Instead, or in addition, one or more location constraints may be applied to the display location, for example specifying that the display location be no closer than a predefined buffer distance from any boundary of the applicable city or geographical region.

In other embodiments, the determining of the display location may be nonrandom. A benefit of a nonrandom, deterministic location calculation in embodiments where the display location is determined client-side is that it enables the regional display location for a particular user to be consistent across different client devices 102.

In either case, however, the display location determination is such as to be different for different user icons and/or to be different for different instances of determination. This avoids displaying all users present within a given geographical region at a common location, which complicates user access to and selection of the respective user icons. Furthermore, such distributed display locations within the geographical region creates at least a superficial appearance of accuracy. In this manner user privacy is promoted, encouraging users to allow their presence on the social media platform to be visible via the map GUI 612 and promoting user engagement.

In this example embodiment, the intentionally inaccurate regional display location thus determined is maintained constant for as long as the particular friend user remains within the relevant city, as indicated by their device location. This avoids the appearance of fakeness that can be caused by displaying the user at a different location every time the map GUI 612 is rendered for the associated area. When it is thus identified, at operation 1421, that the user’s current actual location falls outside of the particular city, at operation 1421, a new display location is generated for the new city in which the user is located.

### Friend-Level Access to Location-Agnostic Content

FIG. 15A illustrates a high-level flow chart of a method 1500 that includes providing a map-based GUI that includes one or more friend-level access mechanisms which make available location-agnostic access to friend user content, according to an example embodiment.

At operation 1504, the map-based GUI is displayed via a client device 102. The method 1500 will further be described with reference to the map GUI 612 described earlier with reference to FIGS. 6A-11B. Display of the map GUI 612 includes displaying respective friend icons or bitmojis 640 at respective locations on an interactive map 618 forming part of the map GUI 612.

At operation 1508, one or more friend-level access mechanisms are provided as part of the map GUI 612. As will be seen with reference to FIG. 15B, the friend-level access mechanisms in this example embodiment includes at least one of a search mechanism (see FIGS. 10A-10C) and a friend panel 909 that launches automatically response to selection of a friend user (see, for example, FIG. 9A).

At operation 1512, user input with respect to a target friend user is received. In some example embodiments, such user input is the selection of a location-agnostic collection icon (e.g., a respective Friend Story icon 932 displayed as part of search suggestions 1030 or a friend panel 909). Responsive to the user input, a location-agnostic social media collection is displayed on the client device 102, e.g. by sequential replay of a series of snaps forming part of the selected story associated with the target friend user.

FIG. 15B shows a more detailed view of some of the operations of the method 1500. The description of these operations are in accordance with example embodiments described earlier with reference to FIGS. 9A, 10A, and 10B.

Display of a location-agnostic collection in the form of a friend’s personal story (without any location constraints) is in this example achievable by one of two separate mechanisms. First, the user can select, at operation 1534, a target user directly by selecting their friend icon (in this example embodiment, the bitmoji 640) displayed within the map viewport 621, or through operation of the friend carousel 918 by swiping to the friend panel 909 (and consequent map focus) of the selected friend user. It will be seen that the interactive bitmojis 640 and the friend carousel 918 thus in this embodiment separately and in combination provide a friend selector mechanism enabling the selection of a target friend.

Responsive to selection of the target user, the corresponding friend panel 909 (FIG. 9A) is displayed, which includes a location-agnostic collection icon in the form of the corresponding Friend Story icon 932. If the user wishes to change the target user, the focus friend panel 909 can be changed by swiping the friend carousel 918, as described previously.

Responsive to receiving, at operation 1550, selection of the Friend Story icon 932, the corresponding location-agnostic snaps are replayed in series on the touchscreen 606 of the client device 102. Note that the friend-level access mechanisms described above is operable in its entirety without leaving the interactive map 618 or displaying a modal interface in replacement thereof.

An alternative method of accessing the personal story or stories of a friend via the map is by triggering, at operation 1530, a suggestion or search interface 1010 (FIGS. 10A and 10B). The displayed list of suggestions 1030 or search results can include, at operation 1538, one or more friend users displayed with associated Friend Story icons 932 (or, in other embodiments, a different location-agnostic collection icon).

If the user selects one of the Friend Story icons 932, at operation 1550, the corresponding story is replayed directly, at operation 1554. Alternatively, the user can, at operation 1534, select a particular one of the friend cells included in the list of suggestions 1030 or search results, causing the map focus to switch to the selected user, together with display of the corresponding friend panel 909. The method can from there proceed as previously described.

It is a benefit of the location-agnostic access as described that it provides for combination of the advantages of the location-based search mechanisms provided by the map GUI 612, with the advantages of interacting with friend content without regard to any location constraint. In this manner, fewer operations are required to access location-agnostic information via the map-based GUI than would otherwise be the case, thus reducing resource consumption on the client device 102.

### Friend-Targeted Search

FIG. 16 shows a flowchart illustrating one example embodiment of a method 1600 of providing for friend-targeted search functionality via a map-based GUI, enabling the triggering of searches that have a location constraint and that is based at least in part on an attribute of a selected target user. Thus, for example, the location constraint can be based on the location of the target user. Instead, or in addition, the search can in some embodiments be limited to social media content uploaded by the target user. The considerations and features discussed above under the section titled Location-Based Searching via Friend Location or for Friend Content applies to the example embodiment of method 1600, and is to be read as forming part of the following description with respect to FIG. 16.

The method 1600 comprises, at operation 1606, causing display on a user device 102 of a map-based graphical user interface, such as the map GUI 612 described previously. At operation 1612, locations of respective friend users are graphically represented by displaying respective friend user icons or bitmoji 640 at corresponding locations in the map viewport 621.

At operation 1618, user input is received selecting a particular one of the friend users as a target user. This can be by selecting the corresponding bitmoji 640, a friend panel 909, or search results/suggestion cell, as described with reference to the corresponding portions of the example embodiment of FIG. 15B.

In this example embodiment, the user can interact with the map GUI 612 to trigger performance, at operation 1624, of a search with a location constraint based on the location of the selected friend user. As discussed earlier, this can be by triggering a search for social media content having geo-tag information falling within a geographic search area centered on the friend user location. In some embodiments, such as search can additionally have an owner constraint, so that search results are limited to social media items uploaded by the target user.

Alternatively, the user can trigger performance of a search, at operation 1630, of a friend-specific content search (i.e., having an owner constraint limiting search results to content uploaded by the target user) that has a location constraint independent of the location of the target user. In this example embodiment, the user can dynamically change the target area for the search by changing the particular geographical area displayed in the map viewport 621.

At operation 1636, search results are displayed in the map GUI 612. In some embodiments, the display of the search results comprises display of a list of social media items and/or collections satisfying the search criteria. Instead, or in addition, the displaying of the search results in this example embodiment includes surfacing on the map GUI 612 social media items uploaded by the target user. Previously discussed display features (including heatmap information, spike clustering, and/or spike story surfacing) can in some embodiments be applied in the current map viewport 621 exclusively to snaps uploaded by the selected friend user. Earlier description of those features are thus to be read as in some embodiments, mutatis mutandis, forming part of the method of FIG. 16.

### Multi-Friend Cluster Icons

One aspect of the disclosure provides for clustering together user icons or bitmojis 640 in a cluster icon that is a distinct user face element by use of which actions for the relevant friend users as a group can be performed. FIG. 17A shows one example embodiment of such a cluster icon 1920 displayed on a map GUI 612 according to the previously described example embodiments.

As can be seen in FIG. 17A, the cluster icon 1920 in one embodiment comprises respective bitmojis 640 clustered together, with the cluster including a topmost bitmoji 640, which is not obscured by any of the other bitmojis 640 in the cluster. In some embodiments, the identity of the topmost bitmoji in the cluster icon 1920 is dynamically variable based on a priority criterion related to social media activity. The priority criterion can, for example, be posting recency, so that the user who has most recently posted a social media items to the platform is automatically displayed as the topmost bitmoji in the cluster icon 1920. Note that social media items on which bitmoji prioritization is based may in some embodiments be limited to social media items that are publicly viewable via the map GUI 612.

Some embodiments provide for collective action functionality with respect to all the users represented in the bitmoji cluster icon 1920. Thus, for example, all of the users represented in the cluster icon 1920 may be selected simultaneously by selecting the bitmoji cluster icon 1920. In some embodiments, the cluster icon 1920 may be displayed with a common cluster label or tag. The label or tag may be user generated content, an ad hoc label, or a label comprising the name of two or more of the users represented in the cluster icon 1920.

Turning again to FIG. 17A, therein is shown a screenshot of an example embodiment of the map GUI 612 in which the locations of three users are represented in a common bitmoji cluster icon 1920. In this example, the display of these users in the cluster icon 1920 is based on identifying the respective locations of user devices associated with the users as being within a predefined threshold distance from each other.

In other embodiments, cluster display of bitmojis 640 are based on proximity not of actual user locations, but of fuzzed, obscured, or otherwise intentionally inaccurate location displays. Thus, for example, where a user’s presence within a particular geographic area (such as a city, neighborhood, or the like) is represented with display of their bitmojis 640 at a particular representative location, multiple users who are located at different positions within the geographical area may be represented in a common bitmoji cluster icon 1920 located on the map 618 at the representative location.

As can be seen FIG. 17A, the bitmojis 640 are clustered such that some of the bitmojis 640 are partially obscured by other bitmojis 640 in the cluster icon 1920. In the example of FIG. 17A, a single one of the bitmojis 640 is unobscured, being a topmost bitmoji. In other example embodiments, such as for example the example embodiment illustrated in FIG. 19 (in which six bitmojis 640 are arranged in a carousel-style cluster icon 1920 at the Bootleg Theater), a bitmoji cluster icon 1920 can include more than one unobscured bitmojis 640.

In this example embodiment, the order of the bitmojis 640 in the cluster icon 1920 is determined by recency of posting snaps that are viewable by the user via the map GUI 612. Such postings can in this example include items posted to Our Story (thus being generally available) and items posted to personal stories accessible by the user. In other embodiments, cluster order may be determined exclusively by recency of posting publicly available content to the map GUI 612. Note in this regard the timestamps on the respective user cards or friend panels 909 in FIG. 17A and FIG. 17B, indicating how recently the respective users last posted content to the social media platform.

In other embodiments, the priority criterion for arranging the order of bitmojis 640 in the cluster icon 1920 may instead, or in addition, include a number of other attributes. In one example embodiment, cluster order may be determined based on recency of accessing or looking into the map GUI 612, so that a player who accesses the social media platform more recently than another player would be displayed above that other player in the bitmoji cluster icon 1920.

In yet further example embodiments, bitmoji cluster order may be determined based on recency of location update, so that the user with the most recently updated location will be displayed on top, with the display order descending by a recency of location update. It will appreciated that, in such an example embodiment, timestamps on the corresponding user cards are last seen timestamps, indicating time expired since last location update by the corresponding user.

The system may provide for certain exceptions to the arrangement of the bitmojis 640 in the cluster icon 1920 according to the relevant applied priority criterion. In this example, a bitmojis 640 upon which the user focuses is automatically displayed on top of the cluster icon 1920. Such focusing on a particular bitmojis 640 can be by way of selecting a particular one of the bitmojis 640 in the cluster icon 1920. Thus, for example, a user may wish to access content or view information about a certain user represented in the cluster icon 1920, and in order to do so may click on the partially obscured bitmoji 640 of that user. Responsive to such specific selection, the selected bitmoji 640 is brought to the top of the cluster icon 1920. Note that such selection of a specific bitmoji 640 in the cluster icon 1920 is in this example embodiment possible only subsequent to selection of the cluster globally, as described below.

Another instance in which the default bitmoji priority in the cluster icon 1920 is overridden is when the cluster icon 1920 is displayed responsive to a user-initiated search for a target user within the cluster icon 1920. Thus, when the user interacting with the map GUI 612 searches for a user that is currently in a cluster icon 1920, and thereafter clicks on a result cell to navigate to the target user, the map focus switches to the relevant cluster icon 1920 and the searched-for user is brought to the top of the cluster icon 1920.

Turning briefly to FIG. 18, there any shown a

In this example embodiment, selection of the cluster icon 1920 within the map GUI 612 automatically causes selection of the entire cluster, without zooming in. Furthermore, in response to selection of the cluster icon 1920, a label 1940 appears above the cluster icon 1920, with the particular label 1940 that is applied being determined by predefined cluster labeling logic. Note that both of the cluster icons 631, 633 of FIG. 17A and FIG. 17B are shown immediately subsequent to such selection.

In this example embodiment, cluster labeling logic include the following predefined operations:
If the cluster is not associated with a predefined group, then two or more names of individuals forming part of the bitmoji cluster is displayed in the label 1940.
   In this example embodiment, up to six names can be displayed in the cluster label 1940. In the example screenshot of FIG. 17A, the names of all three of the cluster members are displayed in the label 1940.
   If the customer has more than six people, the label 1940 shows the first five names, followed by "& X others," where X indicates the number of other users in the cluster.
If the cluster matches a previously defined group (e.g., a chat group or a self-identified group), then the label 1940 will use the group name. In the instance illustrated in FIG. 17B, the individuals represented in the cluster exactly matches a group chat of the user on whose device the map GUI 612 is displayed, and the label 1940 thus automatically displays the group name of that group chat.

In this example embodiment, the map GUI 612 further automatically provides, responsive to selection of a bitmoji cluster, a soft button 1925 for creating a group composed of the members of the selected cluster. Responsive to selection of the “Create Group” soft button 1925, the soft button is replaced by a “chat group” soft button that is selectable launch a chat interface with the chat group created from the cluster icon 1920.

Turning now to FIG. 18, therein is shown a flowchart of a method of providing a map-based graphical user interface such as the exemplified map GUI 612. The method is in this example embodiment performed by the map engine 1208 in cooperation with the client device 102. At operation 1805, user location information is access, based on the position of the respective user devices. At operation 1810, a set of users are identified as a formal clustered based on predefined clustering criteria. In this example embodiment, the clustering criteria is that the users are all present within in the geographical bounds of a defined place, e.g. such as that which can be represented by a place icon 631.

Responsive to identifying the relevant users satisfying the clustering criteria, their respective locations are displayed on the map 618 (responsive to a request for viewing the relevant area in the map viewport 621 of a user with viewing permission) by a cluster icon 1920, as discussed with reference to FIG. 19.

At operation 1830, the cluster icon 1920 is selected by a user via the touchscreen 606. Responsive to selection, respective friend panels 909 for the users in the cluster are displayed in the map GUI 612. Selection of the cluster icon 1920 also launches the icon label 1940. At operation 1825, it is determined whether or not the set of users in the cluster exactly matches a pre-existing defined group. If so, a group label 1940 is displayed, at operation 1845, being the icon label with the relevant group name, as is the case in FIG. 17B. If not, the label 1940 is displayed, at operation 1820, with the list of usernames or handles (see FIG. 17A). A grouping option presented by the grouping button 1925 is also displayed, at operation 1840. On selection of the grouping option, a new group is created and named, after which the group label 1940 is displayed, at operation 1845. While displaying the group label, communal actions with respect to the set of clustered users are available via the map GUI 612, for example via a chat button.

If, at any stage after selection of the cluster icon 1920, a subselection is received, at operation 1835, the bitmoji 640 of the selected user is foregrounded, at operation 1850, and accessible user interface elements for performing actions with respect to the selected friend is displayed in the map GUI 612, for example via the corresponding friend panel 909.

### RECAPITULATION OF SELECTED EXAMPLE EMBODIMENTS

From the preceding description it will be seen that a number of example embodiments and combinations of example embodiments are disclosed. The disclosed embodiments include, but are not limited to, the enumerated list of example embodiments that follow.

Example 1: A method comprising:
causing display on a user device of a graphical user interface (GUI) for a social
   media application;
receiving a search query provided by a user input that comprises user engagement
   with a selected feature of the GUI, the user input having an engagement
   duration for which user engagement with the selected feature is maintained;
calculating a search period based at least in part on the engagement duration, the
   search period indicating a length of preceding time with respect to which a
   social media content search is to be performed, such that the search period is
   variable in length dependent on variation in length of the engagement duration;
performing a search for social media content having timestamp information falling
   within the search period; and
causing display on the user device of search results of the search.

Example 2: The method of example 1, wherein the user input is a tap-and-hold or a click-and-hold input, with the engagement duration being defined by time elapsed between tap or click initiation and release.

Example 3: The method example 1 or example 2, wherein:
the GUI is a map-based GUI that includes an interactive map of a geographic area;
wherein the search query is a location-based search query, the user input comprising
   selection of a target location on the map of the GUI; and
wherein the search is a location-based search for geo-tagged social media content,
   the location-based search being performed based at least in part on a combination of:
      the user-selected target location; and
      the search period indicated by the engagement

Example 4: The method of example 3, wherein:
the interactive map includes one or more gallery icons that are displayed at
   respective locations on the map and that are user-selectable to trigger display
   of social media content associated with the respective gallery icons; and
wherein the target location is spaced from the one or more gallery icons, the
   location-based search being performed with respect to a target area
   substantially centered on the target location.

Example 5: The method of example 3 or example 4, wherein:
the GUI is displayed on a touchscreen forming part of the user device; and
wherein the user input comprises haptic contact with the touchscreen, the
   engagement duration being defined by an interval for which the user
   maintains contact with the touchscreen at the target location.

Example 6: The method of any one of examples 1-5, wherein the calculating of the search period comprises:
determining whether or not the engagement duration exceeds a predefined
   threshold duration, and
determining the search period based at least in part on the determination as to
   whether or not the engagement period exceeds the predefined threshold duration.

Example 7: The method of example 6 wherein the calculating of the search period further comprises, in response to determining that the engagement duration does not exceed the threshold duration, setting the search period to a predefined default search period.

Example 8: The method of example 6, wherein the calculating of the search period further comprises, in response to determining that the engagement duration exceeds the threshold duration, determining the search period to be greater than the default search period.

Example 9: The method of example 8, wherein the calculating of the search period is such that the search period is variable in length as a function of an excess interval by which the engagement duration exceeds the threshold duration, such that the search period increases with an increase in the excess interval.

Example 10: The method of example 1, wherein display of the search results comprises automated sequential replay of the user device of a plurality of social media items comprising the search results.

Example 11: A system comprising:
a search engine comprising one or more computer processors configured to perform
   operations comprising:
      causing display on a user device of a graphical user interface (GUI)
         for a social media application;
      receiving, via a user device on which a graphical user interface (GUI)
         for a social media application is displayed, a search query
         provided by a user input that comprises user engagement with
         a selected feature of the GUI , the user input having an
         engagement duration for which user engagement with the
         selected feature is maintained;
      calculating a search period based at least in part on the engagement
         duration, the search period indicating a length of preceding
         time with respect to which a social media content search is to
         be performed, such that the search period is variable in length
         dependent on variation in length of the engagement duration;
      performing a search for social media content having timestamp
         information falling within the search period; and
      causing display on the user device of search results of the search.

Example 12: The system of example 11, wherein the user input is a tap-and-hold or a click-and-hold input, with the engagement duration being defined by time elapsed between tap or click initiation and release.

Example 13: The system example 11 or claim 12, further comprising:
a map engine comprising one or more computer processors configured to cause
   display of an interactive map of a geographic area as part of the GUI, the
   GUI being a map-based graphical user interface;
wherein the search query is a location-based search query, the user input comprising
   selection of a target location on the map of the GUI; and
wherein the search engine is configured to perform the search as a location-based
   search for geo-tagged social media content, the location-based search being
   performed based at least in part on a combination of:
      the user-selected target location; and
      the search period indicated by the engagement

Example 14: The system of example 13, wherein:
the interactive map includes one or more gallery icons that are displayed at
   respective locations on the map and that are user-selectable to trigger display
   of social media content associated with the respective gallery icons; and
wherein the target location is spaced from the one or more gallery icons, the search
   engine being configured to perform the location-based search with respect to
   a target area substantially centered on the target location.

Example 15: The system of example 13 or claim 14, wherein:
the map engine is configured to cause display of the map-based GUI on a
   touchscreen forming part of the user device; and
wherein the user input comprises haptic contact with the touchscreen, the
   engagement duration being defined by an interval for which the user
   maintains contact with the touchscreen at the target location.

Example 16: The system of any one of examples 11-15, wherein the search engine is further configured to perform operations comprising:
determining whether or not the engagement duration exceeds a predefined
   threshold duration, and
determining the search period based at least in part on the determination as to
   whether or not the engagement period exceeds the predefined threshold duration.

Example 17: The system of example 16, wherein the search engine is further configured to perform operations comprising:
in response to determining that the engagement duration does not exceed the
   threshold duration, setting the search period to a predefined default search period; and
in response to determining that the engagement duration exceeds the threshold
   duration, calculating the search period to be greater than the default search period.

Example 18: The system of example 17, wherein the search engine is configured to calculate the search period such that the search period is variable in length as a function of an excess interval by which the engagement duration exceeds the threshold duration, so that the search period increases with an increase in the excess interval.

Example 19: The system of example any one of examples 11-18, wherein the search engine is configured to display the search results as an automated sequential replay of the user device of a plurality of social media items located in the search.

Example 20: A non-transitory computer-readable storage medium having stored thereon instructions for causing a machine, when executing the instructions, to perform operations comprising:
causing display on a user device of a graphical user interface (GUI) for a social
   media application;
receiving a search query provided by a user input that comprises user engagement
   with a selected feature of the GUI, the user input having an engagement
   duration for which user engagement with the selected feature is maintained;
calculating a search period based at least in part on the engagement duration, the
   search period indicating a length of preceding time with respect to which a
   social media content search is to be performed, such that the search period is
   variable in length dependent on variation in length of the engagement duration;
performing a search for social media content having timestamp information falling
   within the search period; and
causing display on the user device of search results of the search.

Example 21: A system comprising:
a user location mechanism comprising one or more computer processors configured
   to perform operations comprising:
      determining an actual location of a user device associated with a user
         of a social media application;
      identifying a defined geographical region within which the actual
         location of the user device is situated; and
      determining a display location for the user such that the display
         location differs from the actual location of the user device,
         and such that the display location is within the defined geographical region; and
a map engine comprising one or more computer processor devices configured to
   perform operations comprising:
      causing generation of a map-based graphical user interface (GUI) for
         a social media application, the map-based GUI including an
         interactive map of a geographical area that includes at least
         part of the defined geographical region; and
      causing display on the interactive map of the GUI of a user icon at
         the display location, the user icon being representative of the
         user associated with the user device.

Example 22: The system of example 21, wherein the map-based GUI is generated on a friend user device that is associated with a friend user who is a member of a social network of the user.

Example 23: The system of example 22, wherein the map engine is configured to, in response to generation of an instance of the map-based GUI on the user device, cause display of the user icon for the user substantially at the actual location, so that the display location of the user icon is different on the user device than it is on the friend user device.

Example 24: The system of any one of examples 21-23, wherein the defined geographical region is a cartographically defined area.

Example 25: The system of example 24, wherein the geographically defined region is a city.

Example 26: The system of example 24, wherein the geographically defined region is a neighborhood.

Example 27: The system of any one of examples 22-26, wherein the user location mechanism is configured to determine the display location by generating the display location in an at least partially randomized procedure.

Example 28: The system of any one of examples 22-26, wherein the user location mechanism is configured to determine the display location by generating a random location within the defined geographical region.

Example 29: The system of example 22-28, wherein the user location mechanism is further configured to maintain, while the user device is located in the defined geographical region, the display location consistent between different instances of generation of the map-based GUI.

Example 30: The system of example 22-29, wherein the map engine is configure to display in association with the user icon a label indicating the identified defined geographical region.

Example 31: A method comprising:

determining an actual location of a user device associated with a user of a social media application;

identifying a defined geographical region within which the actual location of the user device is situated;

determining a display location for the user such that the display location differs from the actual location of the user device, and such that the display location is within the defined geographical region;

causing generation of a map-based graphical user interface (GUI) for a social media application, the map-based GUI including an interactive map of a geographical area that includes at least part of the defined geographical region; and

causing display on the interactive map of the GUI of a user icon at the display location, the user icon being representative of the user associated with the user device.

Example 32: The method of example 31, wherein the map-based GUI is generated on a friend user device that is associated with a friend user who is a member of a social network of the user.

Example 33: The method of example 32, further comprising, in response to generation of an instance of the map-based GUI on the user device, causing display of the user icon for the user substantially at the actual location, so that the display location of the user icon is different on the user device than it is on the friend user device.

Example 34: The method of example 33, wherein the geographically defined region is a city.

Example 35: The method of example 33, wherein the geographically defined region is a neighborhood.

Example 36: The method of any one of examples 32-35, wherein determining the display location comprises generating the display location in an at least partially randomized procedure.

Example 37: The method of example 36, wherein the determining of the display location comprises generating a random location within the defined geographical region.

Example 38: The method of example 32-37, further comprising, while the user device is located in the defined geographical region, maintaining the display location consistent between different instances of generation of the map-based GUI.

Example 39: The method of example 32-38, wherein the displaying of the user icon comprises displaying in association with the user icon a label indicating the defined geographical region.

Example 40: A non-transitory computer-readable storage medium having stored thereon instructions for causing a machine, when executing the instructions, to perform operations comprising:
determining an actual location of a user device associated with a user of a social
   media application;
identifying a defined geographical region within which the actual location of the
   user device is situated;
determining a display location for the user such that the display location differs
   from the actual location of the user device, and such that the display location
   is within the defined geographical region;
causing generation of a map-based graphical user interface (GUI) for a social media
   application, the map-based GUI including an interactive map of a
   geographical area that includes at least part of the defined geographical
   region; and
causing display on the interactive map of the GUI of a user icon at the display
   location, the user icon being representative of the user associated with the
   user device.

Example 41: A method comprising:
causing display on a user device of a map-based graphical user interface (GUI) for a
   social media application, the map-based GUI including an interactive map of
   a geographical area, the map GUI providing one or more location-based
   access mechanisms, each of which enables user access to social media
   content based at least in part on location information associated with a set of
   social media items;
causing display on the interactive map of a plurality of friend icons representing
   respective geographic locations of a plurality of friend users of the user
   associated with the user device, each friend user being a member of a social
   network of the user;
providing via the map-based GUI a friend-level access mechanism that enables
   location-agnostic access to friend user content;
receiving, via the friend-level access mechanism, user input with respect to a target
   user selected from the plurality of friend users; and
responsive to the user input, causing display of a location-agnostic collection of
   social media items.

Example 42: The method of example 41, wherein the friend-level access mechanism comprises a location-agnostic collection icon displayed in association with an indicator of the target user, the location-agnostic collection icon being user-selectable to trigger replay of an associated collection of social media items without consideration of location information of the collection of social media items relative to the geographical area displayed in the interactive map.

Example 43: The method of example 42, wherein the friend-level access mechanism comprises a friend search mechanism that enables the user to search for the target user.

Example 44: The method of example 43, wherein the friend search mechanism enables the entry of a search query, the method further comprising: receiving a search query via the friend search mechanism; and
displaying a search result based on the search query, the search result including a
   respective location-agnostic collection icon for each of at least one friend
   user located based on the search query.

Example 45: The method of example 44, wherein displaying the search result comprises displaying a plurality of indicators for a corresponding plurality of friend users satisfying the search query, and displaying in association with each friend user indicator a corresponding location-agnostic collection icon. Location indicators can include a friend name, handle, or the like.

Example 46: The method of any one of examples 42-45, wherein the friend-level access mechanism comprises a friend selector mechanism that enables the user to select, via the map-based GUI, the target user, and that enables selective display of the location-agnostic collection of social media items without leaving the interactive map.

Example 47: The method of example 46, further comprising, upon selection of the target user, displaying a friend panel as part of the map-based GUI, the friend panel being an interactive GUI element that contains the location-agnostic collection icon associated with the target user.

Example 48: The method of example 47, wherein the plurality of friend icons displayed in the map are user-selectable, and wherein selection of any one of the plurality of friend icons automatically triggers display of a corresponding friend panel.

Example 49: The method of example 47 or example 48, further comprising, in response to selecting the target user, moving the geographical area displayed by the map to focus on the friend icon of the target user.

Example 50: The method of any one of examples 46-49, wherein the friend selector mechanism enables sequential selection of a plurality of friend users one after the other in sequence, the method further comprising, for each friend selected in the sequence, switching focus of the map to a currently selected friend user.

Example 51: The method of example 50, wherein sequential selection of friend users is by user interaction with a current friend panel displayed as part of the map-based GUI in association with a currently selected friend user, the method further comprising:
receiving a user swipe input with respect to the current friend panel; and
in response to the swipe input, dismissing the swiped friend panel and displaying in
   replacement thereof a friend panel of a next friend user in sequence.

Example 52: A system comprising:
one or more computer processors; and
one or more memories storing machine readable storage medium that configure the
   one or more computer processors, when executing the instructions, to
   perform operations comprising:
      causing display on a user device of a map-based graphical user
         interface (GUI) for a social media application, the map-based
         GUI including an interactive map of a geographical area, the
         map GUI providing one or more location-based access
         mechanisms, each of which enables user access to social
         media content based at least in part on location information
         associated with a set of social media items;
      causing display on the interactive map of a plurality of friend icons
         representing respective geographic locations of a plurality of
         friend users of the user associated with the user device, each
         friend user being a member of a social network of the user;
      providing via the map-based GUI a friend-level access mechanism
         that enables location-agnostic access to friend user content;
      receiving, via the friend-level access mechanism, user input with
         respect to a target user selected from the plurality of friend
         users; and
      responsive to the user input, causing display of a location-agnostic
         collection of social media items.

Example 53: The system of example 52, wherein the friend-level access mechanism comprises a location-agnostic collection icon displayed in association with an indicator of the target user, the location-agnostic collection icon being user-selectable to trigger replay of an associated collection of social media items without consideration of location information of the collection of social media items relative to the geographical area displayed in the interactive map.

Example 54: The system of example 53, wherein the friend-level access mechanism comprises a friend search mechanism that enables the user to search for the target user.

Example 55: The system of example 55, wherein the friend search mechanism enables the entry of a search query, the instructions further being configured to:
receive a search query via the friend search mechanism; and
display a search result based on the search query, the search result including a
   respective location-agnostic collection icon for each of at least one friend
   user located based on the search query.

Example 56: The system of example 55, wherein the display of the search result comprises display of a plurality of indicators for a corresponding plurality of friend users satisfying the search query, and displaying in association with each friend user indicator a corresponding location-agnostic collection icon.

Example 57: The system of any one of examples 53-56, wherein the friend-level access mechanism comprises a friend selector mechanism that enables the user to select, via the map-based GUI, the target user, and that enables selective display of the location-agnostic collection of social media items without leaving the interactive map

Example 58: The system of example 57, wherein the friend selector mechanism is configured to, upon selection of the target user, display a friend panel as part of the map-based GUI, the friend panel being an interactive GUI element that contains the location-agnostic collection icon associated with the target user.

Example 59: The system of example 58, wherein the plurality of friend icons displayed in the map are user-selectable, and wherein selection of any one of the plurality of friend icons automatically triggers display of a corresponding friend panel.

Example 60: The system of example 58 or example 59, wherein the system is further configured to, in response to selecting the target user, move the geographical area displayed by the map to focus on the friend icon of the target user.

Example 61: The system of any one of examples 57-60, wherein the friend selector mechanism enables sequential selection of a plurality of friend users one after the other in sequence, the system further comprising, for each friend selected in the sequence, switching focus of the map to a currently selected friend user.

Example 62: The system of example 61, wherein the friend selection mechanism enables sequential selection of friend users by user interaction with a current friend panel displayed as part of the map-based GUI in association with a currently selected friend user, the system further being configured to: receive a user swipe input with respect to the current friend panel; and in response to the swipe input, dismiss the swiped friend panel and display in
replacement thereof a friend panel of a next friend user in sequence.

Example 63: A computer-readable storage medium having stored thereon instructions for causing a machine, when executing the instructions, to perform operations comprising:
causing display on a user device of a map-based graphical user interface (GUI) for a
   social media application, the map-based GUI including an interactive map of a
   geographical area, the map GUI providing one or more location-based
   access mechanisms, each of which enables user access to social media
   content based at least in part on location information associated with a set of
   social media items;
causing display on the interactive map of a plurality of friend icons representing
   respective geographic locations of a plurality of friend users of the user
   associated with the user device, each friend user being a member of a social
   network of the user;
providing via the map-based GUI a friend-level access mechanism that enables
   location-agnostic access to friend user content;
receiving, via the friend-level access mechanism, user input with respect to a target
   user selected from the plurality of friend users; and
responsive to the user input, causing display of a location-agnostic collection of
   social media items.

Example 64: A system comprising:
a map engine comprising one or more computer processor devices configured to
   perform operations comprising:
      causing display on a user device of a map-based graphical user
         interface (GUI) for a social media application, the map-based
         GUI including an interactive map of a geographical area; and
      receiving, via the map-based GUI, user input selecting one of a
         plurality of friend users of a user associated with the user
         device, each friend user being a member of a social network
         of the user; and a
search engine comprising at least one computer device configured to perform
   operations comprising:
      performing an automated search for social media content based at
         least in part on one or more attributes of the selected friend
         user, the automated search having a location constraint that
         limits search result to social media content satisfying the
         location constraint; and
      causing display of search results of the automated search on the user
         device via the map-based GUI.

Example 65: The system of example 64, wherein the location constraint is based at least in part on a location attribute of the selected friend user.

Example 66: The system of example 65, wherein the search engine is configured such that the search for social media content is limited to social media items having associated geo-tag information indicating respective locations that are within a predefined distance of a geographic location associated with the selected friend user.

Example 67: The system of example 65 or example 66, wherein the geographic location associated with the selected friend user is an actual location of a friend user device associated with the selected friend user.

Example 68: The system of example 65 or example 66, wherein the geographic location associated with the selected friend user, upon which the search is based, is a display location at which a corresponding friend icon for the selected friend user is displayed on the interactive map, the display location being different from an actual location of a friend user device associated with the friend user.

Example 69: The system of any one of examples 64-68, wherein the search further has an owner constraint that limits social media content included in the search results to social media items created by a particular user.

Example 70: The system of example 69, wherein the owner constraint limits the search results to social media items created by the selected friend user.

Example 71: The system of any one of examples 64-70, wherein the location constraint limits the search results to social media items having associated geo-tag information indicating respective locations that are located within the geographical area displayed by the interactive map when the user input is provided.

Example 72: The system of any one of examples 64-71, wherein the user input selecting the selected friend user comprises selection of a corresponding friend icon that is associated with the selected friend user and that is displayed at an associated display location on the interactive map.

Example 73: The system of any one of examples 64-72, wherein the map engine is configured to enable user-selection of the selected friend user in a procedure comprising:
receiving a search input via a search mechanism provided by the map-based GUI;
responsive to the search input, displaying via the map-based GUI a list of user-
   selectable user interface elements associated with respective friend users;
   and
receiving user-selection from the list of a particular one of the user interface
   elements associated with the selected friend user.

Example 74: A method comprising:
causing display on a user device of a map-based graphical user interface (GUI) for a
   social media application, the map-based GUI including an interactive map of
   a geographical area;
receiving, via the map-based GUI, user input selecting one of a plurality of friend
   users of a user associated with the user device, each friend user being a
   member of a social network of the user;
performing an automated search for social media content based at least in part on
   one or more attributes of the selected friend user, the automated search
   having a location constraint that limits search result to social media content
   satisfying the location constraint; and
causing display of search results of the automated search on the user device via the
   map-based GUI.

Example 75: The method of example 74, wherein the location constraint is based at least in part on a location attribute of the selected friend user.

Example 76: The method of example 75, wherein the search for social media content is limited to social media items having associated geo-tag information indicating respective locations that are within a predefined distance of a geographic location associated with the selected friend user.

Example 77: The method of example 75 or example 76, wherein the geographic location associated with the selected friend user is an actual location of a friend user device associated with the selected friend user.

Example 78: The method of example 75 or example 76, wherein the geographic location associated with the friend user, upon which the search is based, is a display location at which a corresponding friend icon for the selected friend user is displayed on the interactive map, the display location being different from an actual location of a friend user device associated with the friend user.

Example 79: The method of any one of examples 74-78, wherein the search further has an owner constraint that limits social media content included in the search results to social media items created by a particular user.

Example 80: The method of example 79, wherein the owner constraint limits the search results to social media items created by the selected friend user.

Example 81: The method of any one of examples 74-80, wherein the location constraint limits the search results to social media items having associated geo-tag information indicating respective locations that are located within the geographical area displayed by the interactive map when the user input is provided.

Example 82: The method of any one of examples 74-81, wherein the user input selecting the selected friend user comprises selection of a corresponding friend icon that is associated with the selected friend user and that is displayed at an associated display location on the interactive map.

Example 83: The method of any one of examples 74-82, wherein user-selection of the selected friend user comprises:
receiving a search input via a search mechanism provided by the map-based GUI;
responsive to the search input, displaying via the map-based GUI a list of user-
   selectable user interface elements associated with respective friend users;
   and
receiving user-selection from the list of a particular one of the user interface
   elements associated with the selected friend user.

Example 84: A method comprising:
causing display on a user device of a map-based graphical user interface (GUI) for a
   social media platform, the map-based GUI including an interactive map of a
   geographic area, the map-based GUI providing one or more mechanisms for
   accessing social media content posted to the platform;
accessing location information for a plurality of users whose locations are to be
   viewable in the map-based GUI by display of respective user icons on the
   interactive map, the location information indicating, for each of the multiple
   users, a respective geographic location;
in an automated operation that is performed using one or more computer processors
   configured to perform the automated operation, identifying from the
   plurality of users a set of users that satisfies, based at least in part on their
   respective geographic locations, a predefined clustering criterion; and
causing display on the map of a cluster of icons that comprises respective user icons
   for the set of users, the cluster being a user interface element that is user-
   selectable as a distinct entity in the interactive map.

Example 85: The method of claim 84, wherein the predefined clustering criterion defines a threshold distance, the method comprising identifying the set of users such that the geographic locations of no pair of users in the set are distance exceed the threshold distance.

Example 86: The method of claim 84, wherein the predefined clustering criterion provides for identification of the set of users based at least in part on their respective geographic locations falling within a common defined geographical area.

Example 87: The method of any one of claims 84-86, further comprising causing display, responsive to receiving user input selecting the cluster, of a cluster label pertaining to the set of users in common.

Example 88: The method of claim 87, further comprising:
identifying that the set of users in the cluster exactly matches a predefined user
   group; and
displaying as part of the cluster label a pre-existing group name for the user group.

Example 89: The method of any one of claims 84-87, further comprising:
responsive to receiving user input selecting the cluster, displaying as part of the
   map-based GUI a group naming mechanism that enables the definition and
   naming of the clustered set of users as a defined user group.

Example 90: The method of any one of claims 84-89, wherein one or more of the user icons in the cluster are partially obscured by at least one other user icon in the cluster, the cluster including a topmost user icon that is unobscured.

Example 91: The method of claim 90, wherein the identity of the topmost user icon in the cluster is dynamically variable based on a priority criterion related to social media activity.

Example 92: The method of claim 91, wherein the priority criterion is posting recency, such that that one of the set of users who has most recently posted a social media item to the social media platform is automatically displayed as the topmost user icon in the cluster.

Example 93: The method of claim 91, wherein the priority criterion is recency of location update, such that that one of the set of users who most recently updated their location is displayed as the topmost user icon in the cluster.

Example 94: The method of any one of claims 90-93, further comprising:
receiving user input selecting a user icon in the cluster, the selected user icon being
   a user icon other than the topmost user icon; and
responsive to the selection, displaying the selected user icon as the topmost user
   icon.

Example 95: The method of claim 94, further comprising enabling user selection of individual user icons in the cluster only subsequent to user selection of the cluster.

Example 96: A system comprising:
one or more computer processor devices:
one or more memory devices having stored thereon instructions that configure the
   one or more computer processor devices, when executing the instructions, to
   perform operations comprising the method of any one of claims 84-95.

Example 97: A non-transitory computer readable storage medium having stored thereon instructions for causing a machine, when executing the instructions, to perform operations comprising the method of any one of claims 84-95.

### MACHINE AND SOFTWARE ARCHITECTURE

These systems, system components, methods, applications, and so forth described in conjunction with FIGS. 1-19 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines configured for particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. The software and hardware architectures presented here are example architectures for implementing the disclosure, and are not exhaustive as to possible architectures that can be employed for implementing the disclosure.

### Software architecture

FIG. 20 is a block diagram illustrating an example software architecture 2006, which may be used in conjunction with various hardware architectures herein described. FIG. 20 is a non-limiting example of a software architecture, and it will be appreciated that many other architectures may be implemented to facilitate the functionality described herein. The software architecture 2006 may execute on hardware such as a machine 2100 of FIG. 21 that includes, among other things, processors 2104, memory 2114, and I/O components 2118. A representative hardware layer 2052 is illustrated and can represent, for example, the machine 2100 of FIG. 21. The representative hardware layer 2052 includes a processing unit 2054 having associated executable instructions 2004. The executable instructions 2004 represent the executable instructions of the software architecture 2006, including implementation of the methods, components, and so forth described herein. The hardware layer 2052 also includes memory and/or storage modules memory/storage 2056, which also have the executable instructions 2004. The hardware layer 2052 may also comprise other hardware 2058.

In the example architecture of FIG. 20, the software architecture 2006 may be conceptualized as a stack of layers where each layer provides particular functionality. For example, the software architecture 2006 may include layers such as an operating system 2002, libraries 2020, frameworks/middleware 2018, applications 2016, and a presentation layer 2014. Operationally, the applications 2016 and/or other components within the layers may invoke application programming interface (API) calls 2008 through the software stack and receive a response in the form of messages 2008. The layers illustrated are representative in nature, and not all software architectures have all layers. For example, some mobile or special-purpose operating systems may not provide a frameworks/middleware 2018, while others may provide such a layer. Other software architectures may include additional or different layers.

The operating system 2002 may manage hardware resources and provide common services. The operating system 2002 may include, for example, a kernel 2022, services 2024, and drivers 2026. The kernel 2022 may act as an abstraction layer between the hardware and the other software layers. For example, the kernel 2022 may be responsible for memory management, processor management (e.g., scheduling), component management, networking, security settings, and so on. The services 2024 may provide other common services for the other software layers. The drivers 2026 are responsible for controlling or interfacing with the underlying hardware. For instance, the drivers 2026 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 2020 provide a common infrastructure that is used by the applications 2016 and/or other components and/or layers. The libraries 2020 provide functionality that allows other software components to perform tasks in an easier fashion than by interfacing directly with the underlying operating system 2002 functionality (e.g., kernel 2022, services 2024, and/or drivers 2026). The libraries 2020 may include system libraries 2044 (e.g., C standard library) that may provide functions such as memory allocation functions, string manipulation functions, mathematical functions, and the like. In addition, the libraries 2020 may include API libraries 2046 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 2020 may also include a wide variety of other libraries 2048 to provide many other APIs to the applications 2016 and other software components/modules.

The frameworks/middleware 2018 provides a higher-level common infrastructure that may be used by the applications 2016 and/or other software components/modules. For example, the frameworks/middleware 2018 may provide various graphic user interface (GUI) functions, high-level resource management, high-level location services, and so forth. The frameworks/middleware 2018 may provide a broad spectrum of other APIs that may be utilized by the applications 2016 and/or other software components/modules, some of which may be specific to a particular operating system 2002 or platform.

The applications 2016 include built-in applications 2038 and/or third-party applications 2040. Examples of representative built-in applications 2038 may include, but are not limited to, a contacts application, a browser application, a book reader application, a location application, a media application, a messaging application, and/or a game application. The third-party applications 2040 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 2040 may invoke the API calls 2008 provided by the mobile operating system (such as the operating system 2002) to facilitate functionality described herein.

The applications 2016 may use built-in operating system 2002 functions (e.g., kernel 2022, services 2024, and/or drivers 2026), libraries 2020, and frameworks/middleware 2018 to create user interfaces to interact with users of the system. Alternatively, or additionally, in some systems interactions with a user may occur through a presentation layer, such as the presentation layer 2014. In these systems, the application/component “logic” can be separated from the aspects of the application/component that interact with a user.

### Hardware Architecture

FIG. 21 is a block diagram illustrating components of a machine 2100, according to some example embodiments, able to read instructions from a machine-readable medium (e.g., a machine-readable storage medium) and perform any one or more of the methodologies discussed herein. Specifically, FIG. 21 shows a diagrammatic representation of the machine 2100 in the example form of a computer system, within which instructions 2110 (e.g., software, a program, an application, an applet, an app, or other executable code) for causing the machine 2100 to perform any one or more of the methodologies discussed herein may be executed. As such, the instructions 2110 may be used to implement modules or components described herein. The instructions 2110 transform the general, non-programmed machine 2100 into a particular machine 2100 programmed to carry out the described and illustrated functions in the manner described. In alternative embodiments, the machine 2100 operates as a standalone device or may be coupled (e.g., networked) to other machines. In a networked deployment, the machine 2100 may operate in the capacity of a server machine or a client machine in a server-client network environment, or as a peer machine in a peer-to-peer (or distributed) network environment. The machine 2100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 2110, sequentially or otherwise, that specify actions to be taken by the machine 2100. Further, while only a single machine 2100 is illustrated, the term “machine” shall also be taken to include a collection of machines that individually or jointly execute the instructions 2110 to perform any one or more of the methodologies discussed herein.

The machine 2100 may include processors 2104, memory/storage 2106, and I/O components 2118, which may be configured to communicate with each other such as via a bus 2102. The memory/storage 2106 may include a memory 2114, such as a main memory, or other memory storage, and a storage unit 2116, both accessible to the processors 2104 such as via the bus 2102. The storage unit 2116 and memory 2114 store the instructions 2110 embodying any one or more of the methodologies or functions described herein. The instructions 2110 may also reside, completely or partially, within the memory 2114, within the storage unit 2116, within at least one of the processors 2104 (e.g., within the processor’s cache memory), or any suitable combination thereof, during execution thereof by the machine 2100. Accordingly, the memory 2114, the storage unit 2116, and the memory of the processors 2104 are examples of machine-readable media. In some embodiments, the processors 2104 comprise a number of distributed processors 2108-2112, each of which have access to associated memories storing instructions 2110.

The I/O components 2118 may include a wide variety of components to receive input, provide output, produce output, transmit information, exchange information, capture measurements, and so on. The specific I/O components 2118 that are included in a particular machine 2100 will depend on the type of machine. For example, portable machines such as mobile phones will likely include a touch input device or other such input mechanisms, while a headless server machine will likely not include such a touch input device. It will be appreciated that the I/O components 2118 may include many other components that are not shown in FIG. 21. The I/O components 2118 are grouped according to functionality merely for simplifying the following discussion, and the grouping is in no way limiting. In various example embodiments, the I/O components 2118 may include output components 2126 and input components 2128. The output components 2126 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2128 may include alphanumeric input components (e.g., a keyboard, a touchscreen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touchscreen that provides location and/or force of touches or touch gestures, or other tactile input components), audio input components (e.g., a microphone), and the like.

In further example embodiments, the I/O components 2118 may include biometric components 2130, motion components 2134, environment components 2136, or position components 2138 among a wide array of other components. For example, the biometric components 2130 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 2134 may include acceleration sensor components (e.g., accelerometer), gravitation sensor components, rotation sensor components (e.g., gyroscope), and so forth. The environment components 2136 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 2138 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2118 may include communication components 2140 operable to couple the machine 2100 to a network 2132 or devices 2120 via a coupling 2124 and a coupling 2122 respectively. For example, the communication components 2140 may include a network interface component or other suitable device to interface with the network 2132. In further examples, the communication components 2140 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2120 may be another machine or any of a wide variety of peripheral devices (e.g., a peripheral device coupled via a Universal Serial Bus (USB)).

Moreover, the communication components 2140 may detect identifiers or include components operable to detect identifiers. For example, the communication components 2140 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2140, such as location via Internet Protocol (IP) geolocation, location via Wi-Fi® signal triangulation, location via detecting an NFC beacon signal that may indicate a particular location, and so forth.

### GLOSSARY

“CARRIER SIGNAL” in this context refers to any intangible medium that is capable of storing, encoding, or carrying instructions for execution by the machine, and includes digital or analog communications signals or other intangible media to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistant (PDA), smart phone, tablet, ultra book, netbook, laptop, multi-processor system, microprocessor-based or programmable consumer electronic system, game console, set-top box, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

“EMPHEMERAL MESSAGE” in this context refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory. “Snaps” as referenced in the description are ephemeral messages. Ephemeral messages are not limited to communications having specified individual recipients, but include social media items uploaded to a gallery or a collection for viewing by multiple users. Thus, the term ephemeral message includes a photo or video clip (which may be augmented or unaugmented) made available for a time-limited duration for viewing public or by a “MACHINE-READABLE MEDIUM” in this context refers to a component, a device, or other tangible media able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, a physical entity, or logic having boundaries defined by function or subroutine calls, branch points, application programming interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application-Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application programming interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application-Specific Integrated Circuit (ASIC), a Radio-Frequency Integrated Circuit (RFIC), or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

### LANGUAGE

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated, unless that the context and/or logic clearly indicates otherwise. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the disclosed subject matter has been described with reference to specific example embodiments, various modifications and changes may be made to these embodiments without departing from the broader scope of embodiments of the present disclosure.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. The specification and drawings are, accordingly, to be regarded in an illustrative rather than a restrictive sense.

What is claimed is:

1. A method comprising:
causing display on a user device of a map-based graphical user interface (GUI) for a social media application, the map-based GUI including an interactive map of a geographic area, the map-based GUI providing one or more location-based access mechanisms, each of which enables user access to social media content based at least in part on location information associated with a set of social media items;
causing display on the interactive map of a plurality of friend icons representing respective geographic locations of a plurality of friend users of a user associated with the user device, each friend user being a member of a social network of the user;
providing via the map-based GUI a friend-level access mechanism that enables location-agnostic access to friend user content, such that accessibility of the friend user content via the friend-level access mechanism is agnostic to the identity of or variation in the geographic area displayed on the interactive map;
receiving, via the friend-level access mechanism, user input with respect to a target user selected from the plurality of friend users; and
responsive to the user input, causing display of a location-agnostic collection of social media items forming part of the friend user content of the target user, wherein composition of the location-agnostic collection is unaffected by any location information.

2. The method of claim 1, wherein causing display of the location-agnostic collection of social media items comprises automated sequential playback in full-screen mode on the user device, the full-screen mode temporarily replacing the interactive map on a display screen of the user device during the automated sequential playback.

3. The method of claim 2, wherein the friend-level access mechanism comprises a location-agnostic collection icon displayed in association with an indicator of the target user, the location-agnostic collection icon being user-selectable to trigger display of the location-agnostic collection of social media items without consideration of any location information of the collection relative to the geographic area displayed in the interactive map.

4. The method of claim 3, wherein the location-agnostic collection of social media items comprises a plurality of ephemeral social media items, each ephemeral social media item having a predefined limited ephemeral lifetime after expiry of which the respective social media item is no longer available for display.

5. The method of claim 4, wherein the location-agnostic collection of social media items is a personal story of the target user comprising social media items uploaded by the target user, the personal story being accessible exclusively to users who are members of the social network of the target user.

6. The method of claim 3, wherein the friend-level access mechanism comprises a friend search mechanism that enables the user to search for the target user by entry of a search query, the method further comprising:
receiving the search query via the friend search mechanism; and
displaying search results based on the search query, the search results including, for each of a subset of friend users located based on the search query, a respective friend user indicator and a corresponding location-agnostic collection icon, each such location-agnostic collection icon being user-selectable to trigger display of the location-agnostic collection of the respective friend user.

7. The method of claim 2, wherein the friend-level access mechanism comprises a friend selector mechanism that enables user selection, via the map-based GUI, of the target user, automated sequential playback of the location-agnostic collection being facilitated by user input selecting the target user.

8. The method of claim 7, wherein the friend selector mechanism comprises the plurality of friend icons displayed on the interactive map, each friend icon being an interactive user-selectable element configured to enable the user to initiate access to the location-agnostic collection of the respective friend user by direct interaction with the friend icon on the map.

9. The method of claim 7, wherein the friend selector mechanism comprises a list of friend users provided as part of the map-based GUI, each entry in the list including an indicator of a respective friend user and a corresponding location-agnostic collection icon that is user-selectable to trigger display of the location-agnostic collection of that friend user.

10. The method of claim 7, further comprising, upon selection of the target user via the friend selector mechanism, displaying a friend panel as part of the map-based GUI, the friend panel being an interactive GUI element that contains a location-agnostic collection icon associated with the target user, wherein selection of the location-agnostic collection icon in the friend panel directly launches automated sequential playback of the location-agnostic collection of social media items on the user device.

11. The method of claim 10, wherein the friend panel is displayed at a bottom portion of the display screen of the user device, the friend panel being displayed over the interactive map without replacing the interactive map on the display screen.

12. The method of claim 1, wherein the location-agnostic collection of social media items is compiled and displayed without regard to the geographic area currently displayed in the interactive map, such that the collection comprises social media items of the target user irrespective of whether geo-tag data of the respective items corresponds to the geographic area currently displayed in the interactive map.

13. The method of claim 1, wherein the location-agnostic collection of social media items is compiled and displayed without regard to:
geo-tag data associated with individual social media items in the collection;
a current or last known geographic location of the target user; or
the geographic area currently displayed in the interactive map.

14. The method of claim 1, wherein the one or more location-based access mechanisms comprise a plurality of gallery icons displayed at respective geographic locations on the interactive map, each gallery icon representing a collection of social media items whose geo-tag data is associated with the respective geographic location, each gallery icon being user-selectable to trigger display of the collection represented by that gallery icon.

15. The method of claim 14, wherein at least one of the plurality of gallery icons represents a location-based collection of social media items that were uploaded by a single user of the social media application and that have respective geo-tag data associated with the geographic location of that gallery icon.

16. A system comprising:
one or more computer processors; and
one or more memories storing instructions that configure the one or more computer processors, when executing the instructions, to perform operations comprising:
causing display on a user device of a map-based graphical user interface (GUI) for a social media application, the map-based GUI including an interactive map of a geographic area, the map-based GUI providing one or more location-based access mechanisms, each of which enables user access to social media content based at least in part on location information associated with a set of social media items;
causing display on the interactive map of a plurality of friend icons representing respective geographic locations of a plurality of friend users of a user associated with the user device, each friend user being a member of a social network of the user;
providing via the map-based GUI a friend-level access mechanism that enables location-agnostic access to friend user content, such that accessibility of the friend user content via the friend-level access mechanism is agnostic to the identity of or variation in the geographic area displayed on the interactive map;
receiving, via the friend-level access mechanism, user input with respect to a target user selected from the plurality of friend users; and
responsive to the user input, causing display of a location-agnostic collection of social media items forming part of the friend user content of the target user, wherein composition of the location-agnostic collection is unaffected by any location information.

17. The system of claim 16, wherein the operations comprise causing display of a location-agnostic collection icon in association with an indicator of the target user, the location-agnostic collection icon being user-selectable to trigger automated sequential playback of social media items of the location-agnostic collection in full-screen mode on the user device, the full-screen mode temporarily replacing the interactive map on a display screen of the user device during the automated sequential playback.

18. The system of claim 16, wherein:
the friend-level access mechanism comprises a friend selector mechanism that enables user-selection of the target user via direct interaction with a friend icon of the target user displayed on the interactive map, and
wherein the instructions configure the system to perform further operations comprising:
responsive to receiving user input selecting the target user via the friend icon, displaying a friend panel as part of the map-based GUI, the friend panel containing a location-agnostic collection icon associated with the target user;
receiving user input selecting the location-agnostic collection icon in the friend panel; and
directly responsive to selection of the location-agnostic collection icon, launching automated sequential playback of the location-agnostic collection of social media items on the user device.

19. The system of claim 16, wherein the location-agnostic collection of social media items is a personal story of the target user comprising social media items uploaded by the target user, the personal story being accessible exclusively to users who are members of the social network of the target user, such that users outside the social network of the target user cannot access the personal story via the map-based GUI.

20. A non-transitory computer-readable storage medium having stored thereon instructions for causing a machine, when executing the instructions, to perform operations comprising:
causing display on a user device of a map-based graphical user interface (GUI) for a social media application, the map-based GUI including an interactive map of a geographic area, the map-based GUI providing one or more location-based access mechanisms, each of which enables user access to social media content based at least in part on location information associated with a set of social media items;
causing display on the interactive map of a plurality of friend icons representing respective geographic locations of a plurality of friend users of a user associated with the user device, each friend user being a member of a social network of the user;
providing via the map-based GUI a friend-level access mechanism that enables location-agnostic access to friend user content, such that accessibility of the friend user content via the friend-level access mechanism is agnostic to the identity of or variation in the geographic area displayed on the interactive map;
receiving, via the friend-level access mechanism, user input with respect to a target user selected from the plurality of friend users; and
responsive to the user input, causing display of a location-agnostic collection of social media items forming part of the friend user content of the target user, wherein composition of the location-agnostic collection is unaffected by any location information.
